(19) United States
(12) Patent Application Publication
(10) Pub. No.: US 2026/0176553 A1
(43) Pub. Date: Jun. 25, 2026

(54) Detergents and Cleaning Compositions with Improved Degreasing Power

(71) Applicant: Symrise AG, Holzminden (DE)

(72) Inventors: Tony BARTOLINI, Herblay-sur-Seine (FR); Anne-Laure AZAIS, Poissy (FR)

(21) Appl. No.: 19/124,276

(22) PCT Filed: Oct. 25, 2023
(86) PCT No.: PCT/EP2023/079715

§ 371 Date: Apr. 24, 2025

(30) Foreign Application Priority Data
Oct. 25, 2022 (WO) PCT/EP2022/079760

(51) Int. Cl. C11D 1/29

(52) U.S. Cl. CPC C11D 1/29

(57) ABSTRACT

The present invention relates to detergents and cleaning compositions that comprise a degreasing agent and an effective amount of a specific type of degreasing boosting agent, such as alkanediols having a carbon chain from 5 to 14 carbon atoms, glyceryl caprylate, 4-hydroxyacetophenone, ethyl hexyl glycerin, tropolone, or a mixture of said degreasing boosting agents, and a surfactant, and the use of said detergents and cleaning compositions for the preparation of a detergent and cleaning product for household, institutional and industrial application. Furthermore, the present invention relates to a method of treating a stained and/or soiled substrate using the detergents and cleaning compositions according to the present invention. Additionally, the present invention relates to the use of specific boosting substances as defined herein for boosting the degreasing power of a degreasing detergent and cleaning composition and improving cleaning performance of a degreasing detergent and cleaning composition. Moreover, the present invention relates to a method of boosting the degreasing power of a degreasing detergent and cleaning composition and of improving the cleaning performance of a degreasing detergent and cleaning composition by adding an effective amount of a specific degreasing boosting agent, such as alkanediols having a carbon chain form 5 to 14 carbon atoms, glyceryl caprylate, 4-hydroxyacetophenone, ethyl hexyl glycerin, tropolone, or a mixture of said degreasing boosting agents, to said detergent and cleaning composition. Finally, the present invention relates to the use of at least one degreasing boosting agent, such as alkanediols, as defined herein, glyceryl caprylate, 4-hydroxyacetophenone, ethyl hexyl glycerin, tropolone, or a mixture of said degreasing boosting agents, as defined herein as degreaser and/or as replacement for a solubilizer.

### TECHNICAL FIELD

The present invention refers generally to the field of detergents and cleaning compositions. In particular, the present invention relates to degreasing detergents and cleaning compositions comprising specific hydroxyl compounds and having improved degreasing power and improved cleaning performance.

More specifically, the present invention relates to detergents and cleaning compositions that comprise a degreasing agent and an effective amount of a specific type of a degreasing boosting agent, such as alkanediols having a carbon chain of 5 to 14 carbon atoms, glyceryl caprylate, 4-hydroxyacetophenone, ethyl hexyl glycerin, tropolone, or a mixture of said degreasing boosting agents, and a surfactant, and the use of said detergents and cleaning compositions for the preparation of a detergent and cleaning product for household, institutional and industrial application. Furthermore, the present invention relates to a method of treating a stained and/or soiled substrate using the detergents and cleaning compositions according to the present invention. Additionally, the present invention relates to the use of specific substances as defined herein for boosting the degreasing power of a degreasing detergent and/or cleaning composition and improving cleaning performance of a degreasing detergent and cleaning composition. Moreover, the present invention relates to a method of boosting the degreasing power of a degreasing detergent and cleaning composition and/or of improving the cleaning performance of a degreasing detergent and cleaning composition by adding an effective amount of a specific degreasing boosting agent, such as alkanediols having a carbon chain of 5 to 14 carbon atoms, glyceryl caprylate, 4-hydroxyacetophenone, ethyl hexyl glycerin, tropolone, or a mixture of said degreasing boosting agents, to said detergent and cleaning composition. Finally, the present invention relates to the use of at least one degreasing boosting agent, such as alkanediols having a carbon chain of 5 to 14 carbon atoms, glyceryl caprylate, 4-hydroxyacetophenone, ethyl hexyl glycerin, tropolone, or a mixture of said degreasing agents, as degreaser and/or as replacement for a solubilizer.

### BACKGROUND ART

Detergents and cleaning compositions, in particular cleaning compositions for laundry and textile cleaning, dishwashing and the like are composed predominantly of surfactants or a mixture of surfactants, whose main task is to remove water-insoluble substances like dirt and grease from surfaces such as fabric, clothes, dishes, wares, etc., and hard surfaces such as metals, plastics, glass, ceramics, etc. Other than surfactant, modern detergent and cleaning formulations consist of builders, chelating agents, co-builders and other polymer additives used for specific washing or cleaning effects such as soil release and anti-redeposition, dye transfer inhibition and rheology modification. In addition to said ingredients, one or more enzymes as a further active substance with cleaning action and enzyme stabilizers are added to the detergents and cleaning compositions.

Degreasing detergents and cleaning compositions are solvent-based or solvent-containing detergents and cleaning compositions. They are chemical products mostly used for the removal of water-insoluble substances such as grease, paint, oil, lubricants, and the like. Degreasing detergents and cleaning compositions are especially made for the removal of grease or grease-type stain and/or soil such as greasy or oily stain, greasy or oily soil, mayonnaise, frying fat, beef fat, lard, dirty motor oil, lanoline, lipstick, mineral oil, and the like. One of the more severe applications is cleaning cooked-on grease and oil. Deep fryers accumulate a large amount of caked-on or cooked-on grease which must be periodically removed.

For this purpose, degreasing detergents and cleaning compositions contain a degreaser or degreasing agent.

There are many different degreasing detergents and cleaning compositions that can remove such depositions, but they have many negative side effects. Many such degreasing detergents and cleaning compositions are highly alkaline or acidic. Therefore, they corrode metal and are not desirable for an all-purpose cleaner.

Furthermore, degreasing detergents and cleaning compositions used to remove grease or oil also frequently employ very volatile solvents. These are undesirable because of their high VOC. It is preferable for a degreasing detergent and cleaning composition to have a low VOC and preferably a relatively high flash point to avoid any fire danger.

The detergent and cleaning industry is permanently searching for detergents and cleaning compositions which can resolve these negative aspects.

In addition, there is a need for degreasing detergents and cleaning compositions which are less complex, highly effective, which avoid the use of unfavourable ingredients under environmental and health aspects.

For some time, degreasing detergents and cleaning products have to meet the heightened consumer expectations in term of enhanced cleaning.

Thus, there is still an ongoing need for detergents and cleaning compositions which have an increased degreasing performance and for substances with the ability for enhancing the degreasing power of detergents and cleaning compositions and, thus, improving removal of grease or oil.

Accordingly, it is therefore an object of the present invention to provide for multi-use detergents and cleaning compositions, with a superior degreasing power and with an improved cleaning performance.

Moreover, it is an object of the present invention to provide for a method of treating a stained and/or soiled substrate that furnished an enhanced degreasing and an improved cleaning performance.

It is another object of the present invention to provide for substances, which are capable of boosting the degreasing power of a detergent and cleaning composition and of improving the cleaning performance of a cleaning performance of a detergent and cleaning composition.

It is still another object of the present invention, to provide a method of increasing the degreasing power of a detergent and cleaning composition and of improving the overall cleaning performance of a detergent and cleaning composition.

Finally, it is another object of the present invent, to provide for new degreasing substances.

Surprisingly, it has been found that the addition of an effective amount of a specific type of degreasing boosting agent, such as alkanediols having a carbon chain of 5 to 14 carbon atoms, glyceryl caprylate, 4-hydroxyacetophenone, ethyl hexyl glycerin, tropolone, or a mixture of said degreasing boosting agents, to a degreasing detergent and cleaning composition comprising a degreaser or a mixture of degreasers, has a positive impact in that they enhance the degreasing power of the degreasing detergent and cleaning composition. The detergents and cleaning composition comprising a combination of degreasing agent, degreasing boosting agent and surfactant show a superior degreasing power, compared to degreasing detergents and cleaning compositions without such a degreasing boosting agent.

Surprisingly, it has been found that the addition of an effective amount of a specific type of degreasing boosting agent, such as alkanediols having a carbon chain of 5 to 14 carbon atoms, glyceryl caprylate, 4-hydroxyacetophenone, ethyl hexyl glycerin, tropolone, or a mixture of said degreasing boosting agents, to a degreasing detergent and cleaning composition, improves removal of greasy or oily stain and/or soil in comparison to detergents and cleaning compositions without such a boosting agent.

Thus, the degreasing detergents and cleaning compositions which contain a degreaser and a surfactant in combination with a specific type of degreasing boosting agents, such as alkanediols having a carbon chain of 5 to 14 carbon atoms, glyceryl caprylate, 4-hydroxyacetophenone, ethyl hexyl glycerin, tropolone, or a mixture of said degreasing boosting agents, exhibit an improved overall cleaning performance over detergents and cleaning compositions without such a degreasing boosting agent.

Conversely, also because of the boosting effect, the amount of degreaser and other ingredients for increasing the cleaning effectiveness in these detergents and cleaning compositions can be reduced without loss of cleaning performance. The detergents and cleaning compositions show even at a low rate of addition of the degreasing boosting agent improved soil removal, and, thus, improved cleaning performance.

### SUMMARY OF THE INVENTION

The present invention was made in view of the aspects described above. To solve the above-mentioned demands, the present invention provides for a detergent and cleaning composition, especially a degreasing detergent and cleaning composition, having both improved degreasing power and improved cleaning performance in terms of improved removal of greasy or oily stain and/or soil.

In order to accomplish the above problem, the present invention provides in a first aspect a detergent and cleaning composition, comprising or consisting of
(a1) at least one degreasing agent, selected from the group consisting of solvents and solubilizers;
(b1) 1,2-heptanediol;
(c1) at least one surfactant; and
(d1) optionally at least one enzyme or an enzyme formulation, comprising at least one enzyme;
or
(a2) at least one degreasing agent, selected from the group consisting of solvents and solubilizers;
(b2) 2,3-heptanediol;
(c2) at least one surfactant; and
(d2) optionally at least one enzyme or an enzyme formulation, comprising at least one enzyme;
or
(a3) at least one degreasing agent, selected from the group consisting of solvents and solubilizers;
(b3) a mixture comprising 1,2-heptanediol and 2,3-heptanediol;
(c3) at least one surfactant; and
(d3) optionally at least one enzyme or an enzyme formulation, comprising at least one enzyme;
wherein the at least one degreasing agent is a solvent selected from the group consisting of n-propanol or iso-propanol, butanol, glycol, propanediol or butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol methyl ether or dipropylene glycol ethyl ether, methoxytriglycol, ethoxytriglycol, butoxytriglycol, 1-butoxyethoxy-2-propanol, 3-methyl-3-methoxy-butanol, propylene-glycol-t-butylether, and any mixture thereof; and/or
wherein the at least one degreasing agent is a solubilizer selected from the group consisting of non-ionic surfactants with a HLB value of 13 to 20, selected from the group consisting of polyethylene glycol 400 monolaurate, polyoxyethylene sorbitan monooleate (Tween 80), polyoxyethylene sorbitan monolaurate (Tween 20), polyoxyethylene lauryl ether (Brij 35), potassium oleate, sodium lauryl sulfate, and any mixture thereof.

Alternatively, in another aspect, the present invention provides for a detergent and cleaning composition, comprising or consisting of
(a) at least one degreasing agent, selected from the group consisting of solvents and solubilizers;
(b) at least one degreasing boosting agent selected from the group consisting of:
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof;
(c) at least one surfactant; and
(d) optionally at least one enzyme or an enzyme formulation, comprising at least one enzyme;
wherein the at least one degreasing agent is a solvent selected from the group consisting of n-propanol or iso-propanol, butanol, glycol, propanediol or butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol methyl ether or dipropylene glycol ethyl ether, methoxytriglycol, ethoxytriglycol, butoxytriglycol, 1-butoxyethoxy-2-propanol, 3-methyl-3-methoxy-butanol, propylene-glycol-t-butylether, and any mixture thereof; and/or
wherein the at least one degreasing agent is a solubilizer selected from the group consisting of non-ionic surfactants with a HLB value of 13 to 20, selected from the group consisting of polyethylene glycol 400 monolaurate, polyoxyethylene sorbitan monooleate (Tween 80), polyoxyethylene sorbitan monolaurate (Tween 20), polyoxyethylene lauryl ether (Brij 35), potassium oleate, sodium lauryl sulfate, and any mixture thereof.

In a further aspect, the present invention provides for the use of the detergent and cleaning composition as, or for the preparation of a detergent and cleaning product.

In a further aspect, the present invention provides for a detergent and cleaning product.

In a still further aspect, the present invention provides for a method of treating a stained and/or soiled substrate, comprising the steps of
treating the substrate with the detergent and cleaning composition or product according to the present invention; and
rinsing said substrate in water to remove said composition or product.

In another aspect, the present invention provides for the use of 1,2-heptanediol or 2,3-heptanediol or a mixture comprising 1,2-heptanediol and 2,3-heptanediol or at least one degreasing boosting agent selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
for boosting the degreasing power of a degreasing detergent and cleaning composition and/or for improving the cleaning performance of a degreasing detergent and cleaning composition comprising a degreasing agent and a surfactant.

In another aspect, the present invention provides for a method of boosting the degreasing power of a degreasing detergent and cleaning composition and/or of improving the cleaning performance of a degreasing detergent and cleaning composition, comprising the steps of
(i) providing a detergent and cleaning composition comprising a degreasing agent and a surfactant; and
(ii) adding thereto an effective amount of 1,2-heptanediol or 2,3-heptanediol or a mixture comprising 1,2-heptanediol and 2,3-heptanediol or at least one degreasing boosting agent selected from the group consisting of:
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof.

In a final aspect, the present invention provides for the use of 1,2-heptanediol or 2,3-heptanediol or a mixture comprising 1,2-heptanediol and 2,3-heptanediol or at least one degreasing boosting agent selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof,
as a degreaser and/or as replacement for a solubilizer.

The present invention is specified in the appended claims. The invention itself, and its preferred variants, other objects and advantages, are however also apparent from the following detailed description in conjunction with the accompanying examples and figures.

All percentages are by weight unless otherwise indicated.

Numeric ranges recited within the specification and given in the form “x to y” include the values defining the range and include each integer within the defined range. When multiple preferred numeric ranges are specified in this format, all ranges created by combining the various endpoints are also included.

In the context of the present invention, the term “comprising” means that the named components are essential, but other components may be added and is still embraced by the present invention.

The term “consisting of” as used according to the present invention means that the total amount of components (a) to (d) adds up to 100% by weight in a composition, based on the total weight of the detergent and cleaning composition, and signifies that the subject matter is closed-ended and can only include the limitations that are expressly recited.

Whenever reference is made to “comprising” it is intended to cover both meanings as alternatives, that is the meaning can be either “comprising” or “consisting of”, unless the context dictates otherwise.

In the context of the present invention, the term “at least one . . . ” means that the detergent and cleaning composition according to the present invention can comprise either one or a mixture of two, three, four, five, six or even more different of the respective components following said term.

The term “and/or” expresses that a linkage exists, or an alternative is provided.

The term “optionally” means that the subsequently described component may but need not to be present in the detergent and cleaning composition, and that the description includes variants, where the compound is included or variants, where the compound is absent.

The term “boosting” in the context of the present invention means “improving”, “enhancing”, “increasing”. Correspondingly, a “boosting agent” is a either a single agent or a mixture of substances capable of “improving”, “enhancing”, “increasing” certain features or properties as defined herein. In particular the boosting agent according to the present invention improves, enhances or increases the degreasing performance of a degreasing detergent and cleaning composition, thus resulting in an improved cleaning performance of the detergent and cleaning composition.

The term “substrates” in the context of the present invention means fabrics, textiles, laundry, dishes, wares, carpets, medical or dental instruments, hard surfaces, etc, which can be treated by a washing or cleaning process.

As used herein, the term “alkyl” refers to saturated hydrocarbons having one or more carbon atoms, including straight-chain alkyl groups (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, etc.), cyclic alkyl groups (or cycloalkyl or alicyclic or carbocyclic groups) (such as cyclopropyl, cyclopentyl, cyclohexyl, cycloheptyl, cyclooctyl, etc.), branched-chain alkyl groups (such as isopropyl, tert-butyl, sec-butyl, isobutyl, etc.) and alkyl substituted alkyl groups (such as cycloalkyl-substituted alkyl groups).

Unless otherwise specified, the term “alkyl” includes both unsubstituted alkyls and substituted alkyls. As used herein, the term “substituted alkyls” refers to alkyl groups having substituents, replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylamino carbonyl, alkylthiocarbonyl, alkoxyl, phosphate, phosphonate, cyano, amino, imino, sulfhydryl, alkylthio, arylthiol, thiocarboxylate, sulfates, alkylsulfinyl, sulfonates, nitro, etc.

### DESCRIPTION OF FIGURES

FIG. 1 is a diagram showing the degreasing power of a degreasing cleaner different degreasing boosting agents according to the present invention.

FIG. 2 is a photograph showing the uncleaned soiled sample carrier.

FIG. 3 is a photograph showing the cleaning performance of a degreasing cleaner without the use of a degreasing boosting agent (Comparative Example) on a soiled sample carrier after the cleaning process.

FIG. 4 is a photograph showing the cleaning performance of a degreasing cleaner with 1,2-pentanediol on a soiled sample carrier after the cleaning process.

FIG. 5 is a photograph showing the cleaning performance of a degreasing cleaner with 1,2-hexanediol on a soiled sample carrier after the cleaning process.

FIG. 6 is a photograph showing the cleaning performance of a degreasing cleaner with 1,2-heptanediol on a soiled sample carrier after the cleaning process.

FIG. 7 is a photograph showing the cleaning performance of a degreasing cleaner with 1,2-octanediol on a soiled sample carrier after the cleaning process.

FIG. 8 is a diagram, showing the degreasing power of a degreasing cleaner comprising a degreasing boosting agent according to the present invention.

### DETAILED DESCRIPTION OF THE INVENTION

In a first aspect, the present invention relates to a detergent and cleaning composition, especially a degreasing detergent and cleaning composition, comprising or consisting of
(a1) at least one degreasing agent, selected from the group consisting of solvents and solubilizers;
(b1) 1,2-heptanediol;
(c1) at least one surfactant; and
(d1) optionally at least one enzyme or an enzyme formulation, comprising at least one enzyme; wherein the degreasing agent is selected from the group of solvents and solubilizers as defined herein.

Alternatively, the present invention relates in a first aspect to a detergent and cleaning composition, especially a degreasing detergent and cleaning composition, comprising or consisting of
(a2) at least one degreasing agent, selected from the group consisting of solvents and solubilizers;
(b2) 2,3-heptanediol;
(c2) at least one surfactant; and
(d2) optionally at least one enzyme or an enzyme formulation, comprising at least one enzyme; wherein the degreasing agent is selected from the group of solvents and solubilizers as defined herein.

In a further alternative, the present invention relates in a first aspect to a detergent and cleaning composition, especially a degreasing detergent and cleaning composition comprising or consisting of
(a3) at least one degreasing agent, selected from the group consisting of solvents and solubilizers;
(b3) a mixture comprising 1,2-heptanediol and 2,3-heptanediol;
(c3) at least one surfactant; and
(d3) optionally at least one enzyme or an enzyme formulation, comprising at least one enzyme; wherein the degreasing agent is selected from the group of solvents and solubilizers as defined herein.

In another aspect, the present invention relates to a detergent and cleaning composition, especially a degreasing detergent and cleaning composition, comprising or consisting of
(a) at least one degreasing agent, selected from the group consisting of solvents and solubilizers;
(b) at least one degreasing boosting agent selected from the group consisting of:
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof;
(c) at least one surfactant; and
(d) optionally at least one enzyme or an enzyme formulation, comprising at least one enzyme;
wherein the at least one degreasing agent is a solvent selected from the group consisting of n-propanol or iso-propanol, butanol, glycol, propanediol or butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol methyl ether or dipropylene glycol ethyl ether, methoxytriglycol, ethoxytriglycol, butoxytriglycol, 1-butoxyethoxy-2-propanol, 3-methyl-3-methoxybutanol, propylene-glycol-t-butylether, and any mixture thereof; and/or
wherein the at least one degreasing agent is a solubilizer selected from the group consisting of non-ionic surfactants with a HLB value of 13 to 20, selected from the group consisting of polyethylene glycol 400 monolaurate, polyoxyethylene sorbitan monooleate (Tween 80), polyoxyethylene sorbitan monolaurate (Tween 20), polyoxyethylene lauryl ether (Brij 35), potassium oleate, sodium lauryl sulfate, and any mixture thereof.

In a more preferred variant, the present invention relates to a detergent and cleaning composition, wherein the at least one linear alkanediol has a carbon chain length from 5 to 10 carbon atoms, more preferred wherein the at least one linear alkanediol has a carbon chain length from 5 to 9.

The term “detergent and cleaning composition” as contemplated herein, is understood to mean all products that are suitable and commonly used for washing or cleaning. Detergents and cleaning compositions are composed predominantly of surfactants or a mixture of surfactants. Other than surfactant, the detergents and cleaning compositions normally consists of builders and chelating agents, co-builders and other polymer additives used for specific effects such as anti-redeposition, dye transfer inhibition, rheology modification. Detergents and cleaning compositions refer to compositions that find use in the removal of undesired compounds from items to be cleaned, such as textiles (such as fabrics, clothes), dishes, floors, hard surfaces (such as metals, plastics and ceramics). These deposits might be caused by soils or stains, germs and other contaminants. Detergents are the most commonly used cleaning compositions for textiles. The detergents and cleaning compositions may be used for both household cleaning, institutional cleaning and industrial cleaning. The detergents and cleaning compositions also includes disinfectants that kills all vegetative cells including recognized pathogenic microorganism. The detergents and cleaning compositions can be used by the detergent composition itself or by a detergent product or by a use solution thereof.

The detergents and cleaning compositions according to the present invention are preferably used for removing stain and/or soil deposits from textile, fabrics, laundry, dishes, ware, medical and dental instruments, hard surfaces, etc.

These deposits might be formed by stains caused by tea, chocolate, coffee, grass, red wine, grass/mud, fruit juice, blood, tomato puree, unused motor oil, salad dressing balsamic, cooked beef fat, French squeezy mustard, make-up, and the like or by soils caused by grease, starch based soils such as rice, pasta, protein based soils such as egg yolk, chocolate, mayonnaise, lipstick starch based soil, and the like and other remaining on the surfaces. Deposits are thus any form of unwanted residues of impureness, of dirt, food, grease etc.

Especially, the detergents and cleaning compositions according to the present invention are degreasing detergents and cleaning compositions mostly used for the removal of water-insoluble substances such as grease, paint, oil, lubricants, and the like.

Degreasing detergents and cleaning compositions are especially made for the removal of grease or grease-type stain and/or soil such as greasy or oily stain, greasy or oily soil, mayonnaise, frying fat, beef fat, lard, dirty motor oil, lanoline, lipstick, mineral oil, and the like.

The terms “detergent and cleaning composition” and “degreasing detergent and cleaning composition” are used equivalent in the present description; the term “detergent and cleaning composition” when used as such also embraces a degreasing detergent and cleaning composition.

Within the scope of the present invention the terms “cleaning” and “washing” are used synonymously and refer to the reduction and/or removal of deposits, i.e. the removal of undesired compounds from items to be cleaned, on tableware/dishes and other kitchen utensils such as cutlery/silverware, pots, pans, bakeware and the like.

The term “substrate” in the context of the present invention includes fabrics, textiles, laundry, dishes, ware, carpets, any hard surfaces, medical and dental instruments, and the like which can be contaminated with stain and/or soil and can be treated by a washing or cleaning process.

As used herein, the term “fabric cleaning” includes detergents and cleaning compositions or products designed for cleaning stained and/or soiled material. Such compositions or products include but are not limited to, laundry detergent compositions, fabric softening compositions, fabric enhancing compositions, fabric freshening compositions, laundry prewash, laundry pre-treat, laundry additives, spray products, dry cleaning agents or compositions, laundry rinse additive, wash additive, post-rinse fabric treatment, ironing aids, unit dose formulations, delayed delivery formulations, detergent contained on or in a porous substrate or nonwoven sheet, substrate having fibres preferably said fibres including active agents, and other suitable forms that may be apparent to one skilled in the art.

As used herein, the term “fabric care” relates to various fabric benefits including smoothness, shape maintenance, resilience, colour preservation, pilling control and others.

The term “dish” or “ware” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a took, a machine, equipment, a structure, or the like, that is employed as part of a food processing, preparation or storage activity. The term “ware” in the context of the present invention refers to items such as eating and cooking utensils, dishes, and other hard surfaces such as showers, sinks, toilets bathtubs, countertops, windows, mirrors, and floors.

The term “surface” as used herein, refers to a solid surface, such as a counter top, tile, floor, wall, panel, window, plumbing fixture, kitchen and bathroom furniture, appliance, engine, circuit board, and dish. Hard surfaces may include for example, health care surfaces, such as surfaces of medical or dental instruments, medical or dental devices, electronic apparatus employed for monitoring patient health, and floors, walls or fixtures of structures in which health care occurs, and food processing surfaces, such as a surface of a tool, a machine, equipment, a structure, or the like, that is employed as part of a food processing, preparation or storage activity.

Surprisingly, it was found that the addition of a degreasing boosting agent as specified herein or a mixture of said degreasing boosting agents to a detergent and cleaning composition boost, i.e. improve or enhance, the degreasing performance of such an detergent and cleaning composition.

Based on these advantageous effects, the detergents and cleaning compositions according to the present invention provides for both, enhanced degreasing activity, improved removal of greasy or oily stain and/or soil, and, thus improved overall cleaning performance.

### Degreasing Agent/Component (a1, a2, a3, a)

The detergent and cleaning composition according to the present invention includes at least one degreaser or degreasing agent as component (a1, a2, a3, b).

Degreasers or degreasing agents are chemical substances that dissolve water-insoluble substances from textiles (such as fabrics, clothes), dishes, ware, floors, medical and dental instruments, hard surfaces (such as metals, plastics and ceramics), and the like. They are used to remove grease, grime, oil and other oil-based contaminants from a variety of substrates including automotive or miscellaneous metallic parts.

The at least one degreasing agent according to the present invention is either a solvent and/or a solubilizer.

In order to improve the degreasing efficacy and removal of greasy or oily stain and/or soil, one or more solvent(s) is/are used in combination with one or more solubilizer in the detergent and cleaning composition according to the present invention.

According to the present invention, the at least one solvent is selected from the group consisting of n-propanol, iso-propanol, butanol, glycol, propanediol, butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol methyl ether, dipropylene glycol ethyl ether, methoxytriglycol, ethoxytriglycol, butoxytriglycol, 1-butoxyethoxy-2-propanol, 3-methyl-3-methoxybutanol, propylene-glycol-t-butylether, and any mixture thereof.

According to the present invention, the at least one solubilizer is selected from the group consisting of non-ionic surfactants with a HLB value of 13 to 20, selected from the group consisting of polyethylene glycol 400 monolaurate, polyoxyethylene sorbitan monooleate (Tween 80), polyoxyethylene sorbitan monolaurate (Tween 20), polyoxyethylene lauryl ether (Brij 35), potassium oleate, sodium lauryl sulfate, and any mixture thereof.

The non-ionic surfactants with a HLB value of 13 to 20 are different to the non-ionic surfactants of component (c1, c2, c3, c) of the detergent and cleaning composition according to the present invention.

In a more preferred variant, the solvent is selected from the group consisting of iso-propanol, propanediol, dipropylene glycol methyl ether, propylene-glycol-t-butylether, and any mixture thereof.

In a more preferred variant, the solubilizer is selected from the group consisting of polyethylene glycol 400 monolaurate, polyoxyethylene sorbitan monooleate (Tween 80), polyoxyethylene lauryl ether (Brij 35), potassium oleate, and any mixture thereof.

The aforementioned degreasing agents are commonly used in degreasing detergents and cleaning compositions and are known in the art.

The above specified degreasing agents can be used in the detergent and cleaning composition according to the present invention either singular or in the form of mixtures of two, three, or even more degreasing agents.

### Degreasing Boosting Agent/Component (b1, b2, b3, b)

The detergent and cleaning composition according to present invention further includes at least one degreasing boosting agent as component (b1, b2, b3, b).

In a preferred variant, the detergent and cleaning composition according to the present invention includes a mixture of degreasing boosting agents.

Degreasing boosting agents within the meaning of the present invention are (b1) 1,2-heptanediol; (b2) 2,3-heptanediol; (b3) a mixture of 1,2-heptanediol and 2,3-heptanediol; (b1) at least one linear alkanediol having a carbon chain of 5 to 14 carbon atoms or a mixture comprising at least one first linear alkanediol having a carbon chain of 5 to 14 carbon atoms and one or more second linear alkanediols having a carbon chain of 5 to 14 carbon atoms which is different from the first linear alkanediol; (b^{II}) glyceryl caprylate; (b^{III}) 4-hydroxyacetophenone; (b^{IV}) ethyl hexyl glycerin; (b^{V}) tropolone; and any mixtureof said degreasing boosting agents.

The components (b1, b2, b3, b) as specified above were found to efficiently enhance the performance of a degreasing agent or a mixture of degreasing agents in a detergent and cleaning composition. In addition, the components (b1, b2, b3, b) as specified above were found to considerably boost the degreasing performance of the detergent and cleaning composition by improving removal of greasy or oily stain and/or soil from substrates such as laundry, fabrics, textiles, dishes, ware, surfaces, medical and dental instruments, and the like. Due to these effects, the components (b1, b2, b3, b) as specified above were found to efficiently improve overall cleaning performance of the detergent and cleaning composition according to the present invention.

Alkanediols (b1, b2, b3, b′)

The component (b) in the detergent and cleaning composition according to the first aspect of the present invention is either (b1) 1,2-heptanediol or (b2) 2,3-heptanediol, or (b3) a mixture comprising both heptanediols, i.e. 1,2-heptanediol plus 2,3-heptanediol.

1,2-Heptanediol belongs to the category of alkanediols and is a straight chain alkanediol with the general formula:

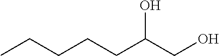

It has a carbon chain with 7 carbon atoms and the two functional OH groups of the alkanediol are in alpha, beta position and chemically bonded to the C1 and C2 carbon atoms in the alkanediol chain.

2,3-Heptanediol belongs to the category of alkanediols and is a straight chain alkanediol with the general formula:

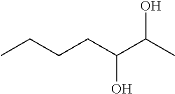

It has a carbon chain with 7 carbon atoms and the two functional OH groups of the alkanediol are in beta, gamma position and chemically bonded to the C2 and C3 carbon atoms in the alkanediol chain.

Alternatively, the degreasing boosting agent (b) in the detergent and cleaning composition according to the present invention is selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol.

Alkanediols are glycols, i.e. any of a class of organic compounds belonging to the alcohol family; in the molecule of a glycol, two hydroxyl (—OH) groups are attached to different carbon atoms of a carbon chain.

Straight chain 1,2-alkanediols have been used for more than 15 years as multifunctional actives. Short chain 1,2-alkanediols are amphiphilic compounds and thus, like 1,2-pentanediol, 1,2-hexanediol and 1,2-heptanediol, are soluble both in water and oils. In contrast, 1,2-octanediol is a solid and tends to precipitate or recrystallize in oily solutions as well as in water at ≥0.5%. On the other hand, 1,2-decanediol is a solid and soluble only in oils. Apart from moisturizing, some 1,2-alkanediols are used as viscosity modifiers.

The degreasing boosting agent (b^{I}) of the detergent and cleaning composition according to the present invention is in a first alternative at least one linear alkanediol having a carbon chain of 5 to 14 carbon atoms.

Moreover, in a second alternative of this another aspect, the degreasing boosting component (b^{I}) may include a first linear alkanediol in combination with a second linear alkanediol, preferably at least one first linear alkanediol having a carbon chain of 5 to 14 carbon atoms (preferably a carbon chain of 5 to 10 carbon atoms) and at least one second linear alkanediol having a carbon chain of 5 to 14 carbon atoms (preferably a carbon chain of 5 to 10 carbon atoms). Therefore, the invention also entails a mixture comprising a first and a second alkanediol as described herein.

Since the first linear alkanediol of the invention can be selected from the same lists and types of compounds as the linear alkanediol according to the first alternative of the other aspect, in the following, reference is made to the linear alkanediol in general, which can also be the first linear alkanediol. In mixtures of first and second linear alkanediols, where these are specifically different, the specific terms “first” and “second” will be used to distinguish the two alkanediol components.

As used in this document, the phrase “at least one linear alkanediol” or “at least one first linear alkanediol” means that the composition can comprise one linear alkanediol having a carbon chain of 5 to 14 carbon atoms or can comprise one first linear alkanediol having a carbon chain of 5 to 14 carbon atoms or can comprise more than one linear alkanediol or can comprise more than one linear alkanediol or more than one first linear alkanediol having a carbon chain of 5 to 14 carbon atoms, i.e. two, three, four or more different linear alkanediols or first linear alkanediols having a carbon chain of 5 to 14 carbon atoms.

The at least one linear alkanediol or the at least one first linear alkanediol according to the present invention consists of a chain of 5 to 14 carbon atoms (preferably a carbon chain of 5 to 10 carbon atoms) joined to each other by single covalent bonds with two OH functional groups attached to two different carbon atoms in the chain.

The at least one linear alkanediol or the at least one first linear alkanediol having a carbon chain of 5 to 14 carbon atoms in the detergent and cleaning composition according to the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one linear alkanediol or the at least one first linear alkanediol has a carbon chain of 5 to 13 carbon atoms and is selected from the group consisting of pentanediol, hexanediol, heptanediol, octanediol, nonanediol, decanediol, undecanediol, dodecanediol, and tridecanediol.

In a more preferred variant, the at least one linear alkanediol or the at least one first linear alkanediol has a carbon chain of 5 to 12 carbon atoms and is selected from the group consisting of pentanediol, hexanediol, heptanediol, octanediol, nonanediol, decanediol, undecanediol, and dodecanediol.

In a more preferred variant, the at least one linear alkanediol or the at least one first linear alkanediol has a carbon chain of 5 to 10 carbon atoms and is selected from the group consisting of pentanediol, hexanediol, heptanediol, octanediol, nonanediol, and decanediol.

In a preferred variant, the at least one linear or the at least one first linear alkanediol has a carbon chain of 5 to 9 carbon atoms in the detergent and cleaning composition according to the present invention and is selected from the group consisting of pentanediol, hexanediol, octanediol, and nonanediol.

In a more preferred variant, the at least one linear alkanediol or the at least one first linear alkanediol is selected from the group consisting of alkanediols having a lower number of carbon atoms of 5 to 8, i.e. pentanediol, hexanediol, heptanediol, octanediol, and any mixture thereof, or is selected from the group consisting of alkanediols having a number of carbon atoms of 6 to 8, i.e. hexanediol, heptanediol, octanediol, and any mixture thereof, or is selected from the group consisting of alkanediols having a number of carbon atoms of 7 and 8, i.e. heptanediol, octanediol, and any mixture thereof.

In a still more preferred variant, the at least one linear alkanediol or the at least one first linear alkanediol is selected from the group consisting of alkanediols having a higher number of carbon atoms of 9 to 14, i.e. nonanediol, decanediol, undecanediol, dodecanediol, tridecanediol, tetradecanediol, and any mixture thereof, or is selected from the group consisting of alkanediols having a number of carbon atoms of 9 to 13, i.e. nonanediol, decanediol, undecanediol, dodecanediol, tridecanediol, and any mixture thereof or is selected from the group consisting of alkanediols having a number of carbon atoms of 9 to 12, i.e. nonanediol, decanediol, undecanediol, dodecanediol, and any mixture thereof, or is selected from the group consisting of alkanediols having a number of carbon atoms of 9 to 11, i.e. nonanediol, decanediol, undecanediol, and any mixture thereof, or is selected from the group consisting of alkanediols having a number of carbon atoms of 9 and 10, i.e. nonanediol, decanediol, and any mixture thereof.

In a still more preferred variant, the at least one linear alkanediol or the at least one first linear alkanediol is either pentanediol, hexanediol, heptanediol or octanediol, or any mixture thereof.

In a still more preferred variant, the at least one linear alkanediol or the at least one first linear alkanediol is either pentanediol, hexanediol, heptanediol, octanediol, nonanediol, or any mixture thereof.

In a still more preferred variant, the at least one linear alkanediol or the at least one first linear alkanediol is either nonanediol, decanediol, undecanediol or dodecanediol, or any mixture thereof.

In a most preferred variant, the at least one linear alkanediol or the at least first linear alkanediol is heptanediol.

In a second alternative, the detergent and cleaning composition according to the other aspect of the present invention comprises as degreasing boosting agent (b) a mixture comprising at least one first linear alkanediol having a carbon chain of 5 to 14 carbon atoms (preferably 5 to 10 carbon atoms) and one or more second linear alkanediol having a carbon chain of 5 to 14 carbon atoms (preferably 5 to 10 carbon atoms) which is/are different from the first linear alkanediol.

This means that the degreasing boosting agent (b) is an alkanediol mixture comprising at least one first linear alkanediol having a carbon chain of 5 to 14 carbon atoms and one or more, i.e. two, three, four or more, second linear alkanediols having a carbon chain of 5 to 14 carbon atoms. In this alternative, the first linear alkanediol can be any of the alkanediols as described herein for the linear alkanediol in general and in particular for the first alternative of the other aspect.

For example, the mixture can include one first linear alkanediol and one, two, three or more second linear alkanediols; or the mixture can include two first linear alkanediols and one, two, three or more second linear alkanediols, etc. with the proviso, that in each mixture, the first linear alkanediols and the second linear alkanediols are different from each other.

The second linear alkanediol preferably consists of a chain of 5 to 14 carbon atoms joined to each other by single covalent bonds with two OH functional groups attached to two different carbon atoms in the chain.

The at least one second linear alkanediol having a carbon chain of 5 to 14 carbon atoms in the detergent and cleaning composition according to the other aspect of the present invention is selected from the group consisting of pentanediol, hexanediol, heptanediol, octanediol, nonanediol, decanediol, undecanediol, dodecanediol, tridecanediol, and tetradecanediol.

In a preferred variant, the at least one second linear alkanediol has a carbon chain of 5 to 13 carbon atoms and is selected from the group consisting of pentanediol, hexanediol, heptanediol, octanediol, nonanediol, decanediol, undecanediol, dodecanediol, and tridecanediol.

In a more preferred variant, the at least one second linear alkanediol has a carbon chain of 5 to 10 carbon atoms and is selected from the group consisting of pentanediol, hexanediol, heptanediol, octanediol, nonanediol, and decanediol.

In a more preferred variant, the at least one second linear alkanediol has a carbon chain of 5 to 10 carbon atoms and is selected from the group consisting of pentanediol, hexanediol, heptanediol, octanediol, nonanediol, and decanediol, most preferably heptanediol, octanediol, and nonanediol.

The phrase “different from each other means” that the first linear alkanediols and the second linear alkanediols in the mixture are either different with regard to the length of their carbon chain, i.e. number of the carbon atoms, or with regard to their constitutional isomerism.

Likewise, the number of the carbon atoms of the first linear alkanediols and the second linear alkanediols in the mixture can also be same. For example, the first linear alkanediol and the second linear alkanediol have a carbon chain of 7 carbon atoms, but the first linear alkanediol and the second linear alkanediol are different with regard to their constitutional isomerism or with regard to their stereoisomerism.

If both the first and the second alkanediol is for example heptanediol, then the second linear alkanediol heptanediol is a different constitutional isomer or stereoisomer from the first linear alkanediol, according to the second alternative of the other aspect.

In a preferred variant, the detergent and cleaning composition according to the present invention comprises a mixture comprising at least one first linear alkanediol having a carbon chain of 5 to 14 carbon atoms and one or more second linear alkanediol having a carbon chain of 5 to 14 carbon atoms wherein the number of the carbon atoms of the first and the second alkanediol is either same or different.

If both, the first and the second alkanediol have the same number of carbon atoms, such an alkanediol combination is herein also referred to as “homo alkanediol mixture” or “homo combination”. For example, the first linear alkanediol and the second linear alkanediol have a carbon chain of 7 carbon atoms, but the first linear alkanediol and the second linear alkanediol are different with regard to their constitutional isomerism or in regard to their stereoisomerism.

If the first and the second alkanediol have a different number of carbon atoms, such an alkanediol combination is herein also referred to as “hetero alkanediol mixture” or “hetero combination”. For example, the first linear alkanediol has a carbon chain of 7 carbon atoms and the second linear alkanediol has a carbon chain of 8 carbon atoms. However, beyond that, the first linear alkanediol and the second linear alkanediol can be different in regard to their constitutional isomerism or with regard to their stereoisomerism.

In a preferred variant the present invention relates to a detergent and cleaning composition, wherein the at least one linear alkanediol or the first linear alkanediol is selected from the group consisting of pentanediol, hexanediol, heptanediol, octanediol, nonanediol, decanediol, undecanediol, dodecanediol, tridecanediol, and tetradecanediol; and/or the one or more second linear alkanediol is selected from the group consisting of pentanediol, hexanediol, heptanediol, octanediol, nonanediol, decanediol, undecanediol, dodecanediol, tridecanediol, and tetradecanediol.

Particular preferred is a degreasing boosting agent mixture, wherein the at least first linear alkanediol is selected from an alkanediol having a lower number of carbon atoms from 5 to 8 and wherein the one or more second alkanediol is selected from an alkanediol having a higher number of carbon atoms from 9 to 14.

Most preferred is a degreasing boosting agent mixture, wherein the at least first linear alkanediol is selected from the group consisting of pentanediol, hexanediol, heptanediol, octanediol, and any mixture thereof, and the one or more second alkanediol is selected from the group consisting of nonanediol, decanediol, undecanediol, dodecanediol, tridecanediol, and any mixture thereof.

The term “alkanediol” within the context of the present invention also includes its constitutional isomers or position isomers. Constitutional isomers are compounds that have the same molecular formula and different connectivity. Position isomers, a particular form of constitutional isomerism, are structural isomers that can be viewed as differing only on the position of a functional group on a parent structure, which in this case, in particular, is the position of the two alcohol functions.

Depending on the number of the carbon atoms of the carbon chain of the alkanediol, there are various position isomers of the alkanediol: (x,x+1) constitutional isomers; (x,x+2) constitutional isomers; (x,x+3) constitutional isomers; etc, and alpha, omega constitutional isomers when the alcohol functions are at the terminal ends of the carbon chain, wherein x stands for the number of the carbon atom in the alkanediol chain, to which the OH groups of the alkanediol are chemically bonded. For example: if x is 1, the two OH groups of the alkanediol are chemically bonded to the C1 and C2 carbon atoms in the alkanediol chain; if x is 2, the two OH groups of the alkanediol are chemically bonded to the C2 and C3 carbon atoms in the alkanediol chain, etc.

In the (x,x+1) constitutional isomers, the two OH functional groups are vicinal attached to two different adjacent carbon atoms in the chain. In the (x,x+2) constitutional isomers, the two OH functional groups are attached to two different carbon atoms in the chain where the two carbon atoms are separated by one C atom. In the (x,x+3) constitutional isomers, the two OH functional groups are attached to two different carbon atoms in the chain where the two carbon atoms are separated by two C atoms. In the alpha, omega constitutional isomers, the two functional groups are attached to the first C atom and to the terminal C atom.

In a preferred variant of the detergent and cleaning composition according to the other aspect of the present invention, the linear alkanediol having a carbon chain of 5 to 14 carbon atoms, is preferably a vicinal (x,x+1) diol, selected from the group consisting of a 1,2-diol, 2,3-diol, 3,4-diol, 4,5-diol, further (x,x+1) diols, and mixtures thereof, preferably an alpha, beta-1,2-constitutional isomer.

In a more preferred variant of the detergent and cleaning composition according to the other aspect of the present invention, the first linear alkanediol and/or the second linear alkanediol having a carbon chain of 5 to 14 carbon atoms is a vicinal (x,x+1) diol, selected from the group consisting of a 1,2-diol, 2,3-diol, 3,4-diol, 4,5-diol, further (x,x+1) diols, and mixtures thereof, preferably an alpha, beta-1,2-constitutional isomer.

Preferably, the linear alkanediol or the first linear alkanediol and/or the second linear alkanediol having a carbon chain of 5 to 14 carbon atoms are selected from 1,2-diols and/or 2,3-diols.

Thus, according to a preferred variant of the detergent and cleaning composition according to the other aspect of the present invention, the at least one linear alkanediol, the first linear alkanediol and/or the second linear alkanediol is an (x,x+1) constitutional isomer, wherein x stands for the number of the carbon atom in the alkanediol chain, to which the OH groups of the alkanediol are chemically bonded, in particular a 1,2-alkanediol, a 2,3-alkanediol, a 3,4-alkanediol, or mixtures thereof, preferably a 1,2-alkanediol or a 2,3-alkanediol.

In a further preferred variant of the detergent and cleaning composition according to the other aspect of the present invention, the linear alkanediol having a carbon chain of 5 to 14 carbon atoms, is preferably a non-vicinal (x,x+2) diol, selected from the group consisting of a 1,3-diol, 2,4-diol, 3,5-diol, further (x,x+2) diols, and mixtures thereof, preferably an alpha, gamma-1,3-constitutional isomer.

According to the present invention, vicinal (x,x+1) diols are most preferred, such as alpha, beta or beta, gamma or gamma, delta etc.

In a still preferred variant of the detergent and cleaning composition according to the present invention, the linear alkanediol and in particular the first linear alkanediol and/or the second linear alkanediol, is a 1,2-alkanediol, a 2,3-alkanediol, a 3,4-alkanediol, or mixtures thereof, more preferred 2,3-alkanediol.

The 1,2-alkanediols of the linear alkanediol, in particular the first linear alkanediol having a carbon chain of 5 to 14 carbon atoms and/or the second linear alkanediol having a carbon chain of 5 to 14 carbon atoms, can preferably be those as represented by the following formulae:

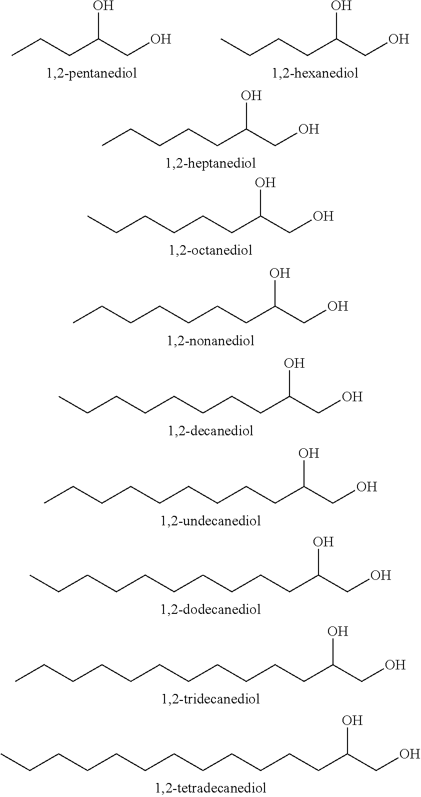

The 2,3-alkanediols of the linear alkanediol of the invention, in particular the first linear alkanediol having a carbon chain of 5 to 14 carbon atoms and/or the second linear alkanediol having a carbon chain of 5 to 14 carbon atoms, can preferably be those as represented by the following formulae:

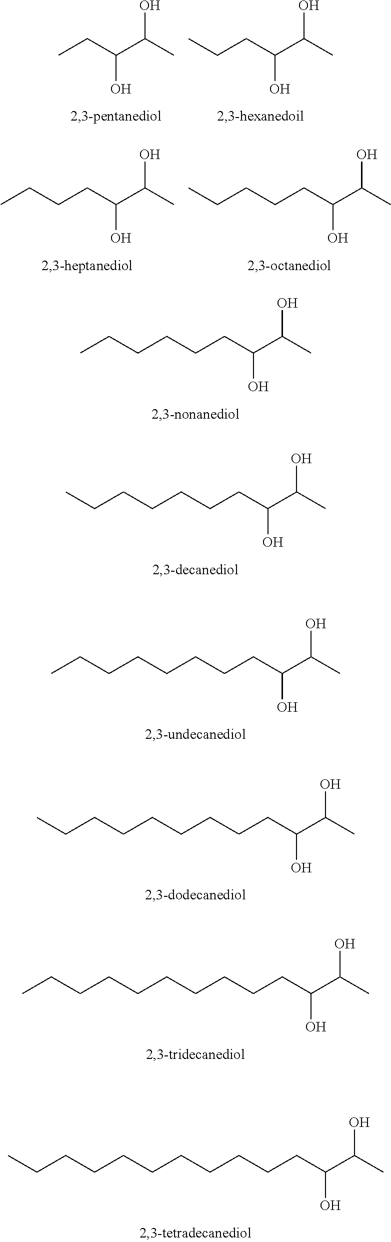

The 3,4-alkanediols of the linear alkanediol, preferably the first linear alkanediol having a carbon chain of 5 to 14 carbon atoms and/or the second linear alkanediol having a carbon chain of 5 to 14 carbon atoms, can preferably be those as represented by the following formulae:

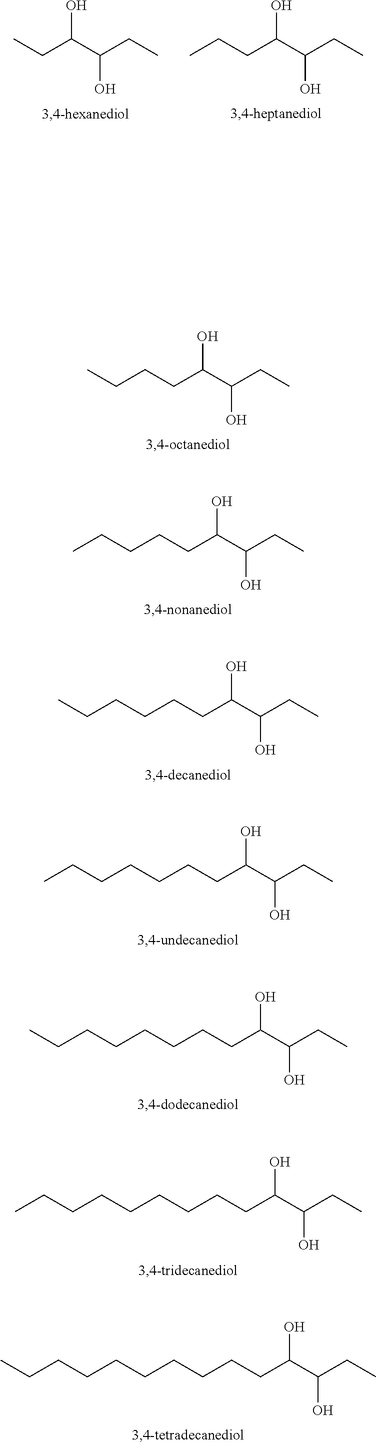

In a preferred variant of the detergent and cleaning composition according to the present invention, the linear alkanediol or the first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol,
   and any mixture thereof.

In a further preferred variant of the detergent and cleaning composition according to the present invention, the linear alkanediol or the first linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octanediol,
1,2-nonanediol, 2,3-nonanediol, 3,4-nonanediol,
1,2-decanediol, 2,3-decanediol, 3,4-decanediol,
   and any mixture thereof.

According to a preferred variant, in the detergent and cleaning composition according to the present invention the linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a more preferred variant, in the detergent and cleaning composition according to the present invention the linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

Of the aforesaid linear alkanediols or the first linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, 2,3-tridecanediol or mixtures thereof. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol, or mixtures of said liquid alkanediols are particularly preferred.

In a further preferred variant of the detergent and cleaning composition according to the present invention, the linear alkanediol or the first linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol,
   and any mixture thereof.

More preferred, in the detergent and cleaning composition according to the present invention, the linear alkanediol or the first linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the linear alkanediol or the first linear alkanediol can also preferably be selected from the group consisting of 1,2-octanediol, 2,3-octanediol, and mixtures thereof.

Even more preferred, in the detergent and cleaning composition according to the present invention, the linear alkanediol or the first linear alkanediol is an alpha, beta or a beta, gamma diol as either 1,2-heptanediol or 2,3-heptandediol or a mixture thereof. However, the linear alkanediol or the first linear alkanediol can also preferably be an alpha, beta or a beta, gamma diol as either 1,2-octanediol or 2,3-octanediol or a mixture thereof. A mixture comprising 1,2-heptanediol and 2,3-octanediol or a mixture comprising 1,2-octanediol and 2,3-heptanediol is also possible.

Most preferred, the linear alkanediol or the first linear alkanediol is 1,2-pentanediol or 2,3-pentanediol or 1,2-hexanediol or 2,3-hexanediol or 1,2-heptanediol or 2,3-heptanediol or 1,2-octanediol or 2,3-octanediol or 1,2-nonanediol or 2,3-nonanediol.

Likewise, in a further preferred variant of the detergent and cleaning composition according to the present invention, the linear alkanediol or the first linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent and cleaning composition according to the present invention, the linear alkanediol or the first linear alkanediol is selected from the group consisting of 1,2-nonanediol, 2,3-nonanediol, and mixtures thereof, or can also be preferably selected from the group consisting of 1,2-decanediol, 2,3-decanediol, and mixtures thereof, or can also be preferably selected from the group consisting of 1,2-undecanediol, 2,3-undecanediol, and mixtures thereof.

In a more preferred variant, the at least one linear alkanediol or the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 1,2-pentanediol or 1,2-hexanediol or 1,2-heptanediol or 1,2-octanediol, or any mixture thereof.

In a most preferred variant, the at least one linear alkanediol or the at least first linear alkanediol is 1,2-heptanediol.

It was found that these alkanediols show particular pronounced degreasing power improving properties. In addition, it was found that these alkanediols remarkably improve removal of greasy or oily stain and/or soil. 1,2-Alkanediols having a lower number of carbon atoms are thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a more preferred variant, the at least one linear alkanediol or the at least one first linear alkanediol is selected from the group consisting of 1,2-alkanediols having a number of carbon atoms of 5 to 10, i.e. 1,2-pentanediol, 1,2-hexanediol, 1,2-heptanediol, 1,2-octanediol, 1,2-nonediol, 1,2-decanediol, and any mixture thereof.

It was found that said alkanediols show particular pronounced degreasing boosting properties. Said alkanediols remarkably improve removal of greasy or oily stain and/or soil and thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a still more preferred variant, the at least one linear alkanediol or the at least one first linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the at least one linear alkanediol or the at least one first linear alkanediol is either 1,2-nonanediol or 1,2-decanediol or 1,2-undecanediol or 1,2-dodecanediol, or any mixture thereof.

According to a preferred variant, the at least one linear alkanediol or the at least one first linear alkanediol is selected from the group consisting of 1,2-alkanediols having a higher number of carbon atoms, and more specifically more than 10 carbon atoms, i.e. 1,2-undecanediol, 1,2-dodecanediol, 1,2-tridecanediol, or 1,2-tetradecanediol.

It was found that these alkanediols show pronounced degreasing power improving properties. In addition, it was found that these alkanediols remarkably improve removal of greasy or oily stain and/or soil. 1,2-Alkanediols having a higher number of carbon atoms, and more specifically more than 10 carbon atoms, are thus efficient for use as degreasing boosting agents and greasy or oily stain and/or soil removal enhancers in degreasing detergents and cleaning compositions. Both, the improved degreasing power and improved greasy or oily stain and soil removal result in a better cleaning performance in a washing or cleaning process.

In a still more preferred variant, the linear alkanediol or the first linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the at least one linear alkanediol or the at least one first linear alkanediol is either 2,3-pentanediol or 2,3-hexanediol or 2,3-heptanediol or 2,3-octanediol, or any mixture thereof.

In a most preferred variant, the at least one linear alkanediol or the at least first linear alkanediol is 2,3-heptanediol.

It was found that these alkanediols show particular pronounced degreasing power improving properties. In addition, it was found that these alkanediol remarkably improve removal of greasy or oily stain and/or soil. 2,3-Alkanediols having a lower number of carbon atoms are thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a more preferred variant, the at least one linear alkanediol or the at least one first linear alkanediol is selected from the group consisting of 2,3-alkanediols having a number of carbon atoms of 5 to 10, i.e. 2,3-pentanediol, 2,3-hexanediol, 2,3-heptanediol, 2,3-octanediol, 2,3-nonediol, 2,3-decanediol, and any mixture thereof.

It was found that said alkanediols show particular pronounced degreasing boosting properties. Said alkanediols remarkably improve removal of greasy or oily stain and/or soil and thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a still more preferred variant, the at least one linear alkanediol or the at least one first linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2,3-nonanediol, 2,3-decanediol, 2,3-undecanediol, 2,3-dodecanediol, 2,3-tetradecanediol, and any mixture thereof, or is selected from the group consisting of 2,3-alkanediols having a number of carbon atoms of 9 to 12, i.e. 2,3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the at least one linear alkanediol or the at least one first linear alkanediol is either 2,3-nonanediol, 2,3-decanediol, 2,3-undecanediol or 2,3-dodecanediol, or any mixture thereof.

According to a preferred variant, the at least one linear alkanediol or the at least one first linear alkanediol is selected from the group consisting of 2,3-alkanediols having a higher number of carbon atoms, and more specifically more than 10 carbon atoms, i.e. 2,3-undecanediol, 2,3-dodecanediol, 2,3-tridecanediol, or 2,3-tetradecanediol.

It was found that these alkanediols show pronounced degreasing power improving properties. In addition, it was found that these alkanediols remarkably improve removal of greasy or oily stain and/or soil. 2,3-Alkanediols having a higher number of carbon atoms, and more specifically more than 10 carbon atoms, are thus efficient for use as degreasing boosting agents and greasy or oily stain and/or soil removal enhancers in degreasing detergents and cleaning compositions. Both, the improved degreasing power and improved greasy or oily stain and soil removal result in a better cleaning performance in a washing or cleaning process.

In a preferred variant of the detergent and cleaning composition according to the present invention, the second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octancediol,
1,2-nonanediol, 2,3-nonanediol, 3,4-nonanediol,
1,2-decanediol, 2,3-decanediol, 3,4-decanediol,
1,2-undecanediol, 2,3-undecanediol, 3,4-undecanediol,
1,2-dodecanediol, 2,3-dodecanediol, 3,4-dodecanediol,
1,2-tridecanediol, 2,3-tridecanediol, 3,4-tridecanediol,
1,2-tetradecanediol, 2,3-tetradecanedioll, 3,4-tetradecanediol,
   and any mixture thereof.

In a preferred variant of the detergent and cleaning composition according to the present invention, the second linear alkanediol is selected from the group consisting of:
1,2-pentanediol, 2,3-pentanediol, 3,4-pentanediol,
1,2-hexanediol, 2,3-hexanediol, 3,4-hexanediol,
1,2-heptanediol, 2,3-heptanediol, 3,4-heptanediol,
1,2-octanediol, 2,3-octanediol, 3,4-octancediol,
1,2-nonanediol, 2,3-nonanediol, 3,4-nonanediol,
1,2-decanediol, 2,3-decanediol, 3,4-decanediol,
   and any mixture thereof.

According to a preferred variant, in the detergent and cleaning composition according to the present invention the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

According to a preferred variant, in the detergent and cleaning composition according to the present invention the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, and any mixture thereof.

Of the aforesaid second linear alkanediols, the following (x,x+1) constitutional isomers are preferred: 1,2-pentanediol, 2,3-pentanediol, 1,2-hexanediol, 2,3-hexanediol, 1,2-heptanediol, 2,3-heptanediol, 2,3-octanediol, 2,3-nonanediol, 2,3-decanediol, 2,3-undecanediol, 2,3-dodecanediol, or 2,3-tridecanediol. Said alkanediols are liquid at a purity of 90 to 99%.

Of the aforesaid liquid alkanediols 1,2-pentanediol, 2,3-pentanediol, 1,2-hexanediol, 2,3-hexanediol, 1,2-heptanediol, 2,3-heptanediol, 2,3-octanediol, 2,3-nonanediol, or mixtures of said liquid alkanediols are particularly preferred.

In a further preferred variant of the detergent and cleaning composition according to the present invention, the second linear alkanediol is selected from the group consisting of:
1,2-pentanediol, 2,3-pentanediol,
1,2-hexanediol, 2,3-hexanediol,
1,2-heptanediol, 2,3-heptanediol,
1,2-octanediol, 2,3-octanediol, and any mixture thereof.

More preferred, in the detergent and cleaning composition according to the present invention, the second linear alkanediol is selected from the group consisting of 1,2-pentanediol, 2,3-pentanediol, and mixtures thereof, or is selected from the group consisting of 1,2-heptanediol, 2,3-heptanediol, and mixtures thereof. However, the second linear alkanediol can also preferably be selected from the group consisting of 1,2-octanediol, 2,3-octanediol, and mixtures thereof.

Even more preferred, in the detergent and cleaning composition according to the present invention, the second linear alkanediol is an alpha, beta or a beta, gamma diol as either 1,2-pentanediol or 2,3-pentanediol or a mixture thereof. However, the second linear alkanediol can also preferably be an alpha,beta or a beta, gamma diol as either 1,2-hexanediol or 2,3-hexanediol or a mixture thereof. A mixture comprising 1,2-pentanediol and 2,3-hexanediol or a mixture comprising 2,3-pentanediol and 1,2-hexanediol is also possible.

Most preferred, the second linear alkanediol is 1,2-pentanediol or 2,3-pentanediol or 1,2-hexanediol or 2,3-hexanediol or 1,2-heptanediol or 2,3-heptanediol, or 2,3-octanediol or 2,3-nonanediol.

Likewise, in a further preferred variant of the detergent and cleaning composition according to the present invention, the second linear alkanediol is selected from the group consisting of 1,2-nonanediol, 2,3-nonanediol, 1,2-decanediol, 2,3-decanediol, 1,2-undecanediol, 2,3-undecanediol, 1,2-dodecanediol, 2,3-dodecanediol, and any mixture thereof.

More preferred, in the detergent and cleaning composition according to the present invention, the second linear alkanediol is selected from the group consisting of 1,2-nonanediol, 2,3-nonanediol, and mixtures thereof, or can also be preferably selected form the group consisting of 1,2-decanediol, 2,3-decanediol, and mixtures thereof, or can also be preferably selected from the group consisting of 1,2-undecanediol, 2,3-undecanediol, and any mixtures thereof.

In a more preferred variant, the second linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, or is selected from the group consisting of 1,2-alkanediols having a number of carbon atoms of 6 to 8, i.e. 1,2-hexanediol, 1,2-heptanediol, 1,2-octanediol, and any mixture thereof, or is selected from the group consisting of 1,2-alkanediols having a number of carbon atoms of 7 and 8, i.e. 1,2-heptanediol, 1,2-octanediol, and any mixture thereof.

In a still more preferred variant, the second linear alkanediol is either 1,2-pentanediol or 1,2-hexanediol or 1,2-heptanediol or 1,2-octanediol, or any mixture thereof. In a still more preferred variant, the second linear alkanediol is either 1,2-heptanediol or 1,2-octanediol or any mixture thereof.

In a most preferred variant, the second linear alkanediol is 1,2-heptanediol.

It was found that these alkanediols show particular pronounced degreasing power improving properties. In addition, it was found that these alkanediols remarkably improve removal of greasy or oily stain and/or soil. 1,2-Alkanediols having a lower number of carbon atoms are thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a more preferred variant, the second linear alkanediol is selected from the group consisting of 1,2-alkanediols having carbon atoms of 5 to 10, i.e. 1,2-pentanediol, 1,2-hexanediol, 1,2-heptanediol, 1,2-octanediol, 1,2-nonanediol, 1,2-decanediol, and any mixture thereof.

It was found that said alkanediols show particular pronounced degreasing boosting properties. Said alkanediols remarkably improve removal of greasy or oily stain and/or soil and thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a still more preferred variant, the second linear alkanediol is selected from the group consisting of 1,2-alkanediols having a higher number of carbon atoms of 9 to 14, i.e. 1,2-nonanediol, 1,2-decanediol, 1,2-undecanediol, 1,2-dodecanediol, 1,2-tridecanediol, 1,2-tetradecanediol, and any mixture thereof, or is selected from the group consisting of 1,2-alkanediols having a number of carbon atoms of 9 to 13, i.e. 1,2-nonanediol, 1,2-decanediol, 1,2-undecanediol, 1,2-dodecanediol, 1,2-tridecanediol, and any mixture thereof, or is selected from the group consisting of 1,2-alkanediols having a number of carbon atoms of 9 to 12, i.e. 1,2-nonanediol, 1,2-decanediol, 1,2-undecanediol, 1,2-dodecanediol, and any mixture thereof, or is selected from the group consisting of 1,2-alkanediols having a number of carbon atoms of 9 to 11, i.e. 1,2-nonanediol, 1,2-decanediol, 1,2-undecanediol, and any mixture thereof, or is selected from the group consisting of 1,2-alkanediols having a number of carbon atoms of 9 and 10, i.e. 1,2-nonanediol, 1,2-decanediol, and any mixture thereof.

In a still more preferred variant, the second linear alkanediol is either 1,2-nonanediol or 1,2-decanediol or 1,2-undecanediol or 1,2-dodecanediol, or any mixture thereof.

According to a preferred variant, the second linear alkanediol is selected from the group consisting of 1,2-alkanediols having a higher number of carbon atoms, and more specifically more than 10 carbon atoms, i.e. 1,2-undecanediol, 1,2-dodecanediol, 1,2-tridecanediol, or 1,2-tetradecanediol.

It was found that these alkanediols show pronounced degreasing power improving properties. In addition, it was found that these alkanediols remarkably improve removal of greasy or oily stain and/or soil. 1,2-Alkanediols having a higher number of carbon atoms, and more specifically more than 10 carbon atoms, are thus efficient for use as degreasing boosting agents and greasy or oily stain and/or soil removal enhancers in degreasing detergents and cleaning compositions. Both, the improved degreasing power and improved greasy or oily stain and soil removal result in a better cleaning performance in a washing or cleaning process.

In a still more preferred variant, the second linear alkanediol is selected from the group consisting of 2,3-alkanediols having a lower number of carbon atoms of 5 to 8, i.e. 2,3-pentanediol, 2,3-hexanediol, 2,3-heptanediol, 2,3-octanediol, and any mixture thereof, or is selected from the group consisting of 2,3-alkanediols having a number of carbon atoms of 6 to 8, i.e. 2,3-hexanediol, 2,3-heptanediol, 2,3-octanediol, and any mixture thereof, or is selected from the group consisting of 2,3-alkanediols having a number of carbon atoms of 7 and 8, i.e. 1,2-heptanediol, 1,2-octanediol, and any mixture thereof.

In a still more preferred variant, the second linear alkanediol is either 2,3-pentanediol or 2,3-hexanediol or 2,3-heptanediol or 2,3-octanediol, or any mixture thereof. In a still more preferred variant, the second linear alkanediol is either 2,3-heptanediol or 2,3-octanediol or any mixture thereof.

In a most preferred variant, the second linear alkanediol is 2,3-heptanediol.

It was found that these alkanediols show particular pronounced degreasing power improving properties. In addition, it was found that these alkanediols remarkably improve removal of greasy or oily stain and/or soil. 2,3-Alkanediols having a lower number of carbon atoms are thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a more preferred variant, the second linear alkanediol is selected from the group consisting of 2,3-alkanediols having carbon atoms of 5 to 10, i.e. 2,3-pentanediol, 2,3-hexanediol, 2,3-heptanediol, 2,3-octanediol, 2,3-nonanediol, 2,3-decanediol, and any mixture thereof.

It was found that said alkanediols show particular pronounced degreasing boosting properties. Said alkanediols remarkably improve removal of greasy or oily stain and/or soil and thus efficient for use as degreasing boosting agents and greasy or oily stain and/or soil removal enhancers in degreasing detergents and cleaning compositions. Both, the improved degreasing power and improved greasy or oily stain and/or soil removal result in a better cleaning performance in a washing or cleaning process.

In a still more preferred variant, the second linear alkanediol is selected from the group consisting of 2,3-alkanediols having a higher number of carbon atoms of 9 to 14, i.e. 2,3-nonanediol, 2,3-decanediol, 2,3-undecanediol, 2,3-dodecanediol, 2,3-tridecanediol, 2,3-tetradecanediol, and any mixture thereof, or is selected from the group consisting of 2,3-alkanediols having a number of carbon atoms of 9 to 13, i.e. 2,3-nonanediol, 2,3-decanediol, 2,3-undecanediol, 2,3-dodecanediol, 2,3-tridecanediol, and any mixture thereof, or is selected from the group consisting of 2,3-alkanediols having a number of carbon atoms of 9 to 12, i.e. 2,3-nonanediol, 2,3-decanediol, 2,3-undecanediol, 2,3-dodecanediol, and any mixture thereof, or is selected from the group consisting of 2,3-alkanediols having a number of carbon atoms of 9 to 11, i.e. 2,3-nonanediol, 2,3-decanediol, 2,3-undecanediol, and any mixture thereof, or is selected from the group consisting of 2,3-alkanediols having a number of carbon atoms of 9 and 10, i.e. 2,3-nonanediol, 2,3-decanediol, and any mixture thereof.

In a still more preferred variant, the second linear alkanediol is either 2,3-nonanediol or 2,3-decanediol or 2,3-undecanediol or 2,3-dodecanediol, or any mixture thereof.

According to a preferred variant, the second linear alkanediol is selected from the group consisting of 2,3-alkanediols having a higher number of carbon atoms, and more specifically more than 10 carbon atoms, i.e. 11, 12, 13, or 14 carbon atoms, i.e. 2,3-undecanediol, 2,3-dodecanediol, 2,3-tridecanediol, or 2,3-tetradecanediol.

It was found that these alkanediols show pronounced degreasing power improving properties. In addition, it was found that these alkanediols remarkably improve removal of greasy or oily stain and/or soil. 2,3-Alkanediols having a higher number of carbon atoms, and more specifically more than 10 carbon atoms, are thus efficient for use as degreasing boosting agents and greasy or oily stain and/or soil removal enhancers in degreasing detergents and cleaning compositions. Both, the improved degreasing power and improved greasy or oily stain and soil removal result in a better cleaning performance in a washing or cleaning process.

In a further preferred variant, in the detergent and cleaning composition according to the present invention the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

In a more preferred variant, the detergent and cleaning composition according to the present invention which comprises a mixture or a combination comprising at least one first linear alkanediol and one or more second linear alkanediol thus includes any one of the following mixtures/combinations:
1,2-pentanediol in combination with one of 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
1,2-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
1,2-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
1,2-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
1,2-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
1,2-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
1,2-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol; or
1,2-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanediol; or
1,2-pentanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-hexanediol in combination with one of 2,3-pentanediol, 2,3-hexanediolm, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-heptanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-octanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-nonanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-decanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-undecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
1,2-tridecanediol in combination with one of 2,3-pentanediol, 2,3-hexanediol, 2,3-heptanediol, 2,3-octanediol, 2,3-nonanediol, 2,3-docanediol, 2,3-undecanediol, 2,3-dodecanediol, 2,3-tridecanediol, 2,3-tetradecanediol; or
1,2-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol; or
2,3-pentanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-hexanediol in combination with one of 1,2-pentanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-heptanediol in combination with one of 1,2-pentanediol, 1,2-hexanediol, 1,2-octanediol, 1,2-nonanediol, 1,2-decanediol, 1,2-undecanediol, 1,2-dodecanediol, 1,2-tridecanediol, or 1,2-tetradecanediol; or
2,3-octanediol in combination with one of 1,2-pentanediol, 1,2-hexanediol, 1,2-heptanediol, 1,2-nonanediol, 1,2-decanediol, 1,2-undecanediol, 1,2-dodecanediol, 1,2-tridecanediol, or 1,2-tetradecanediol; or
2,3-nonanediol in combination with one of 1,2-pentanediol, 1,2-hexanediol, 1,2-heptanediol, 1,2-octanediol, 1,2-decanediol, 1,2-undecanediol, 1,2-dodecanediol, 1,2-tridecanediol, or 1,2-tetradecanediol; or
2,3-decanediol in combination with one of 1,2-pentanediol, 1,2-hexanediol, 1,2-heptanediol, 1,2-octanediol, 1,2-nonanediol, 1,2-undecanediol, 1,2-dodecanediol, 1,2-tridecanediol, or 1,2-tetradecanediol; or
2,3-undecanediol in combination with one of 1,2-pentanediol, 1,2-hexanediol, 1,2-heptanediol, 1,2-octanediol, 1,2-nonanediol, 1,2-decanediol, 1,2-dodecanediol, 1,2-tridecanediol, or 1,2-tetradecanediol; or
2,3-dodecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-tridecanediol, or 1,2-tetradecanediol; or
2,3-tridecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tetradecanediol;
2,3-tetradecanediol in combination with one of 1,2-pentanediol, 1,2-hexanediol, 1,2-heptanediol, 1,2-octanediol, 1,2-nonanediol, 1,2-decanediol, 1,2-undecanediol, 1,2-dodecanediol, or 1,2-tridecanedio; or
2,3-pentanediol in combination with one of 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-hexanediol in combination with one of 2,3-pentanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-heptanediol in combination with one of 2,3-pentanediol, 2,3-hexanediol, 2,3-octanediol, 2,3-nonanediol, 2,3-decanediol, 2,3-undecanediol, 2,3-dodecanediol, 2,3-tridecanediol, or 2,3-tetradecanediol; or
2,3-octanediol in combination with one of 2,3-pentanediol, 2,3-hexanediol, 2,3-heptanediol, 2,3-nonanediol, 2,3-decanediol, 2,3-undecanediol, 2,3-dodecanediol, 2,3-tridecanediol, or 2,3-tetradecanediol; or
2,3-nonanediol in combination with one of 2,3-pentanediol, 2,3-hexanediol, 2,3-heptanediol, 2,3-octanediol, 2,3-decanediol, 2,3-undecanediol, 2,3-dodecanediol, 2,3-tridecanediol, or 2,3-tetradecanediol; or
2,3-decanediol in combination with one of 2,3-pentanediol, 2,3-hexanediol, 2,3-heptanediol, 2,3-octanediol, 2,3-nonanediol, 2,3-undecanediol, 2,3-dodecanediol, 2,3-tridecanediol, or 2,3-tetradecanediol; or
2,3-undecanediol in combination with one of 2,3-pentanediol, 2,3-hexanediol, 2,3-heptanediol, 2,3-octanediol, 2,3-nonanediol, 2,3-decanediol, 2,3-dodecanediol, 2,3-tridecanediol, or 2,3-tetradecanediol; or
2,3-dodecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-tridecanediol, or 2,3-tetradecanediol; or
2,3-tridecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol, or 2,3-tetradecanediol; or
2,3-tetradecanediol in combination with one of 2,3-pentanediol, 2,3-hexanediol, 2,3-heptanediol, 2,3-octanediol, 2,3-nonanediol, 2,3-decanediol, 2,3-undecanediol, 2,3-dodecanediol or 2,3-tridecanediol.

In a particular preferred variant, in the detergent and cleaning composition according to the present invention, the linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof.

In a more particular preferred variant, the detergent and cleaning composition according to the present invention which comprises a mixture or a combination comprising at least one first linear alkanediol and one or more second linear alkanediol includes any one of the following mixtures/combinations:
a mixture comprising 1,2-pentanediol and 2,3-pentanediol; or
a mixture comprising 1,2-hexanediol and 2,3-hexanediol; or
a mixture comprising 1,2-heptanediol and 2,3-heptanediol; or
a mixture comprising 1,2-octanediol and 2,3-octanediol; or
a mixture comprising 1,2-nonanediol and 2,3-nonanediol; or
a mixture comprising 1,2-decanediol and 2,3-decanediol; or
a mixture comprising 1,2-undecanediol and 2,3-undecanediol; or
a mixture comprising 1,2-dodecanediol and 2,3-dodecanediol; or
a mixture comprising 1,2-tridecanediol and 2,3-tridecanediol; or
a mixture comprising 1,2-tetradecanediol and 2,3-tetradecanediol.

In said homo alkanediol mixtures the first linear alkanediol and the second linear alkanediol have the same number of carbon atoms.

Particularly favourable is a mixture including 1,2-pentanediol in combination with 2,3-pentanediol or a mixture including 1,2-heptanediol in combination with 2,3-heptanediol, or a mixture including 1,2-octanediol in combination with 2,3-octanediol and/or 3,4-octanediol.

Due to their outstanding degreasing boosting effect and improved greasy or oily stain and/or soil removal efficacy a homo alkanediol mixture comprising 1,2-nonanediol and 2,3-nonanediol or a homo alkanediol mixture comprising 1,2-decanediol and 2,3-decanediol or a homo alkanediol mixture comprising 1,2-undecanediol and 2,3-undecanediol are most preferred.

The above specified homo alkanediol mixtures according to the present invention, comprising a 1,2-alkanediol and a 2,3-alkanediol are characterized by a synergistically intensified action, i.e. the alkanediol mixtures boost the degreasing power of a detergent and cleaning composition in a synergistic way compared to their respective single 1,2-alkanediol or 2,3-alkanediol substances.

Said synergistic effect or action in boosting the degreasing power was found for the homo mixture including 1,2-pentanediol and 2,3-pentanediol.

Said synergistic effect in boosting the degreasing performance is also observed for the homo mixture including 1,2-hexanediol and 2,3-hexanediol.

The homo mixture including 1,2-heptanediol and 2,3-heptanediol is particularly beneficial since it has a particular pronounced synergistic boosting effect on the degreasing activity of a detergent and cleaning composition.

The alkanediol mixture comprising 1,2-octanediol and 2,3-octanediol or the alkanediol mixture comprising 1,2-nonanediol and 2,3-nonanediol are particularly advantageous, since the mixtures are effective in synergistically boosting the degreasing power of a detergent and cleaning composition.

Also, the alkanediol mixture comprising 1,2-decanediol and 2,3-decanediol or the alkanediol mixture comprising 1,2-undecanediol and 2,3-undecanediol synergistically enhance the degreasing performance of a detergent and cleaning composition.

A degreasing boosting effect is also true for an alkanediol mixture including 1,2-dodecanediol and 2,3-dodecanediol or an alkanediol mixture including 1,2-tridecanediol and 2,3-tridecanediol.

The afore-mentioned synergistically degreasing improving effect is particularly pronounced for the homo mixture including 1,2-heptanediol and 2,3-heptanediol or the homo mixture including 1,2-octanediol and 2,3-octanediol or the homo mixture including 1,2-nonanediol and 2,3-nonanediol.

The afore specified homo alkanediol mixtures including a 1,2-alkanediol and the corresponding 2,3-alkanediol display a remarkably synergistic degreasing boosting efficacy and are clearly superior to the individually corresponding 1,2-alkanediols or 2,3-alkanediols and having the same concentration.

In a particular preferred variant, the detergent and cleaning composition according to the present invention which comprises a mixture or a combination comprising at least one first linear alkanediol and one or more second linear alkanediol thus may include any of the following mixtures/combinations:
a mixture comprising 1,2-hexanediol and 1,2-octanediol; or
a mixture comprising 1,2-hexanediol and 2,3-octanediol; or
a mixture comprising 1,2-octanediol and 2,3-hexanediol; or
a mixture comprising 1,2-octanediol and 2,3-heptanediol; or
a mixture comprising 1,2-pentanediol and 2,3-hexanediol; or
a mixture comprising 1,2-pentanediol and 2,3-heptanediol; or
a mixture comprising 1,2-pentanediol and 2,3-octanediol; or
a mixture comprising 1,2-pentanediol and 1,2-nonanediol; or
a mixture comprising 1,2-pentanediol and 2,3-nonanediol; or
a mixture comprising 1,2-heptanediol and 1,2-pentanediol; or
a mixture comprising 1,2-heptanediol and 1,2-hexanediol; or
a mixture comprising 1,2-heptanediol and 1,2-octanediol; or
a mixture comprising 1,2-heptanediol and 2,3-octanediol; or
a mixture comprising 1,2-heptanediol and 1,2-nonanediol; or
a mixture comprising 1,2-heptanediol and 2,3-nonanediol; or
a mixture comprising 1,2-heptanediol and 1,2-decanediol; or
a mixture comprising 1,2-heptanediol and 1,2-undecanediol; or
a mixture comprising 1,2-heptanediol and 1,2-dodecanediol; or
a mixture comprising 1,2-heptanediol and 1,2-tridecanediol.

The afore specified alkanediol mixtures according to the present invention, comprising a first linear alkanediol and a second linear alkanediol, are characterized by synergistically intensified action, i.e. the alkanediol mixtures enhance the degreasing activity of a detergent and cleaning composition in a synergistic way compared to the corresponding individual 1,2-alkanediol and/or 2,3-alkanediol substances.

In a particular preferred variant, the detergent and cleaning composition according to the present invention which comprises a mixture or a combination comprising at least one first linear alkanediol and one or more second linear alkanediol thus may include the following mixture/combination:
a mixture comprising 1,2-hexanediol and 1,2-octanediol.

Surprisingly, said alkanediol mixture has a particularly pronounced degreasing performance boosting effect.

Beside the above-described degreasing boosting effect, the afore specified mixtures or combinations comprising at least one first linear alkanediol and one or more second linear alkanediol simultaneously have a synergistic greasy or oily stain and/or soil removal boosting efficacy, compared to the corresponding individual 1,2-alkanediol and/or 2,3-alkanediol substances.

Still more preferred is a degreasing boosting agent mixture, wherein the at least first linear alkanediol is selected from a 1,2-alkanediol having a lower number of carbon atoms from 5 to 8 and the one or more second alkanediol is selected from a 1,2-alkanediol having a higher number of carbon atoms from 9 to 14.

Most preferred is a degreasing boosting agent mixture, wherein the at least first linear alkanediol is selected from the group consisting of 1,2-pentanediol, 1,2-hexanediol, 1,2-heptanediol, 1,2-octanediol, and any mixture thereof, and the one or more second alkanediol is selected from the group consisting of 1,2-nonanediol, 1,2-decanediol, 1,2-undecanediol, 1,2-dodecanediol, 1,2-tridecanediol, 1,2-tetradecanediol, and any mixture thereof.

Most preferred is a degreasing boosting agent blend, wherein the at least one first linear alkanediol is selected from the group consisting of 1,2-alkanediols having a lower number of carbon atoms of 5 to 8, i.e. 1,2-pentanediol, 1,2-hexanediol, 1,2-heptanediol, 1,2-octanediol, and any mixture thereof, and the one or more second alkanediol is selected from the group consisting of 1,2-alkanediols having a higher number of carbon atoms of 9 to 13, i.e. 1,2-nonanediol, 1,2-decanediol, 1,2-undecanediol, 1,2-dodecanediol, 1,2-tridecanediol, and any mixture thereof.

Surprisingly, such alkanediol mixtures of short chain alkanediols and long chain alkanediols have a particularly pronounced degreasing boosting effect. In addition, such alkanediol mixtures are also characterized by a remarkable improved removal or greasy or oily stain and/or soil efficacy.

More preferred are such alkanediol mixtures, wherein the difference between the number of carbon atoms of the at least first linear alkanediol and the number of carbon atoms of the one or more second alkanediol is at least 2 carbon atoms. In those alkanediol mixtures, short-chained and long-chained alkanediols are combined with each other resulting in improved degreasing performance.

Still more preferred is a degreasing boosting agent mixture, wherein the difference between the number of carbon atoms of the at least first linear alkanediol and the number of carbon atoms of the one or more second alkanediol is at least 3 carbon atoms. With such alkanediol mixtures, the degreasing boosting effect is particularly pronounced.

Such combinations may include any of the following mixtures/combinations:
1,2-pentanediol in combination with one of 1,2-octanediol, 1,2-nonanediol, 1,2-decanediol, 1,2-undecanediol, 1,2-dodecanediol, 1,2-tridecanediol or 1,2-tetradecanediol; or
1,2-hexanediol in combination with one of 1,2-nonanediol, 1,2-decanediol, 1,2-undecanediol, 1,2-dodecanediol, 1,2-tridecanediol, 1,2-tetradecanediol; or
1,2-heptanediol in combination with one of 1,2-decanediol, 1,2-undecanediol, 1,2-dodecanediol, 1,2-tridecanediol, 1,2-tetradecanediol; and
1,2-octanediol in combination with one of 1,2-undecanediol, 1,2-dodecanediol, 1,2-tridecanediol or 1,2-tetradecanediol.

In a further preferred variant according to the present invention in the detergent and cleaning composition the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol and mixtures thereof.

In a more preferred variant of the detergent and cleaning composition according to the present invention, the linear alkanediol is selected from the group consisting of 2,3-pentanediol, 2,3-hexanediol, 2,3-heptanediol, 2,3-octanediol, 2,3-nonanediol, and mixtures thereof.

Surprisingly, the addition of 2,3-pentanediol, 2,3-hexanediol, 2,3-heptanediol as well as other 2,3-alkanediols such as 2,3-octanediol, 2,3-nonanediol, 2,3-decanediol, 2,3-undecanediol, 2,3-dodecanediol, 2,3-tridecanediol, and 2,3-tetradecanediol to a detergent and cleaning composition result in a remarkable degreasing power boosting, compared to a composition without the addition of an 2,3-alkanediol.

According to a particularly preferred variant, the detergent and cleaning composition according to the present invention comprises at least one degreasing boosting agent selected from the group consisting of at least one linear 1,2-alkanediol having a carbon chain of 5 to 8 atoms, or a mixture comprising at least one first linear 1,2-alkanediol having a carbon chain of 5 to 8 carbon atoms and one or more second linear 1,2-alkanediol having a carbon chain of 5 to 8 carbon atoms, which is different from the first linear 1,2-alkanediol.

In a still more preferred variant, the detergent and cleaning composition according to the present invention comprises at least one degreasing boosting agent selected from the group consisting of at least one linear 1,2-alkanediol having a carbon chain of 6 to 7 atoms, or a mixture comprising at least one first linear 1,2-alkanediol having a carbon chain of 6 to 7 carbon atoms and one or more second linear 1,2-alkanediol having a carbon chain of 6 to 7 carbon atoms, which is different from the first linear 1,2-alkanediol.

Surprisingly, it was found that these short-chained 1,2-alkanediols are particularly efficient degreasing boosting agents, which can also efficiently be incorporated into a broad range of detergents and cleaning compositions. In addition, it was found that these alkanediols show outstanding improved greasy or oily stain and/or soil removal properties in a detergent and cleaning composition. Thus, such detergents and cleaning compositions show improved cleaning properties compared to detergent and cleaning composition without the addition of such substances.

According to a particularly preferred variant, the detergent and cleaning composition according to the present invention comprises at least one degreasing boosting agent selected from the group consisting of at least one linear 1,2-alkanediol having a carbon chain of 5 to 10 atoms, or a mixture comprising at least one first linear 1,2-alkanediol having a carbon chain of 5 to 9 carbon atoms and one or more second linear 1,2-alkanediol having a carbon chain of 5 to 9 carbon atoms, which is different from the first linear 1,2-alkanediol.

Surprisingly, it was found that these 1,2-alkanediols having a carbon chain of 5 to 9 carbon atoms are particularly suitable degreasing boosting agents, which can also efficiently be incorporated into a broad range of detergents and cleaning compositions. In addition, it was found that these alkanediols show outstanding improved greasy or oily stain and/or soil removal properties in a detergent and cleaning composition. Thus, such detergents and cleaning compositions show improved cleaning properties compared to detergent and cleaning composition without the addition of such substances.

According to a particularly preferred variant, the detergent and cleaning composition according to the present invention comprises at least one degreasing boosting agent selected from the group consisting of at least one linear 1,2-alkanediol having a carbon chain of 9 to 14 atoms, or a mixture comprising at least one first linear 1,2-alkanediol having a carbon chain of 9 to 14 carbon atoms and one or more second linear 1,2-alkanediol having a carbon chain of 9 to 14 carbon atoms, which is different from the first linear 1,2-alkanediol.

In a more preferred variant, the detergent and cleaning composition according to the present invention comprises at least one degreasing boosting agent selected from the group consisting of at least one linear 1,2-alkanediol having a carbon chain of 10 to 13 atoms, or a mixture comprising at least one first linear 1,2-alkanediol having a carbon chain of 10 to 13 carbon atoms and one or more second linear 1,2-alkanediol having a carbon chain of 10 to 13 carbon atoms, which is different from the first linear alkanediol.

In a still more preferred variant, the detergent and cleaning composition according to the present invention comprises at least one degreasing boosting agent selected from the group consisting of at least one linear 1,2-alkanediol having a carbon chain of 11 to 12 atoms, or a mixture comprising at least one first linear 1,2-alkanediol having a carbon chain of 11 to 12 carbon atoms and one or more second linear 1,2-alkanediol having a carbon chain of 11 to 12 carbon atoms, which is different from the first linear alkanediol.

Surprisingly, it was found that these long-chained 1,2-alkanediols are particularly suitable degreasing boosting agents, which can also efficiently be incorporated into a broad range of detergents and cleaning compositions. In addition, it was found that these alkanediols show outstanding improved greasy or oily stain and/or soil removal properties in a detergent and cleaning composition. Thus, such detergents and cleaning compositions show improved cleaning properties compared to detergent and cleaning composition without the addition of such substances.

In a most preferred variant, the detergent and cleaning composition according to the present invention comprises at least one degreasing boosting agent selected from the group consisting of at least one linear 1,2-alkanediol having a log Pow value of ≤1, or a mixture comprising at least one first linear 1,2-alkanediol having a log Pow value of ≤1 and one or more second linear 1,2-alkanediol having a log Pow value of ≤1, which is different from the first linear 1,2-alkanediol.

The 1,2-alkanediols having a log Pow value of ≤1 are selected from the group consisting of 1,2-pentanediol (0.06), 1,2-hexanediol (0.58), 1,2-heptanediol (0.9), and any mixture thereof. Said 1,2-alkanediols are more soluble in water.

The Pow value is the partition coefficient of a chemical compound for the two-phase system consisting of the two immiscible solvents n-octanol and water at equilibrium. This value is therefore a comparison of the solubility of the solute in these two liquids. Hence the partition coefficient measures how hydrophilic or hydrophobic a chemical substance is.

The log Pow value is a constant defined in the following manner:
Log Pow=log 10 (Partition Coefficient)
Partition Coefficient, P=[n-octanol]/[water]
where [ ] indicates the concentration of solute in the organic and/or aqueous partition.
The log Pow value is determined at a standard temperature of 25° C.

The log Pow value ≤1 means the compound has a higher affinity for the aqueous phase (it is more hydrophilic) and, thus, more soluble in water; a log Pow value ≥1 denotes a higher concentration in the lipid phase (i.e., the compound is more lipophilic) and, thus, more soluble in fat-like solvents.

Surprisingly, it was found that 1,2-alkanediols having a log Pow value of ≤1 are suitable degreasing boosting agents, which can also efficiently be incorporated into a broad range of detergents and cleaning compositions. In addition, it was found that the aforesaid 1,2-alkanediols exhibit outstanding improved soil removal and stain removal properties in a detergent and cleaning composition. Thus, detergents and cleaning compositions comprising 1,2-alkanediols having a log Pow value of ≤1 show improved cleaning properties compared to detergent and cleaning composition without the addition of such 1,2-alkanediols.

In a still further preferred variant, the detergent and cleaning composition according to the present invention comprises at least one degreasing boosting agent selected from the group consisting of at least one linear 1,2-alkanediol having a log Pow value of ≥1, or a mixture comprising at least one first linear 1,2-alkanediol having a log Pow value of ≥1 and one or more second linear 1,2-alkanediol having a log Pow value of ≥1, which is different from the first linear 1,2-alkanediol.

The 1,2-alkanediols having a log Pow value of ≥1 are selected from the group consisting of 1,2-octanediol (log Pow=2.1), 1,2-nonanediol, 1,2-decanediol, 1,2-undecanediol, 1,2-dodecanediol, 1,2-tridecanediol, 1,2-tetradecanediol, and any mixture thereof. Said 1,2-alkanediols are more soluble in fat-like solvents, for example n-octanol.

Surprisingly, it was found that 1,2-alkanediols having a log Pow value of ≥1 are particularly suitable degreasing boosting agents, which can also efficiently be incorporated into a broad range of detergents and cleaning compositions. In addition, it was found that the aforesaid 1,2-alkanediols exhibit outstanding improved stain and/or soil removal properties in a detergent and cleaning composition. Thus, detergents and cleaning compositions comprising 1,2-alkanediols having a log Pow value of ≥1 show improved cleaning properties compared to detergent and cleaning composition without the addition of such 1,2-alkanediols.

The term “alkanediol” within the context of the present invention also includes its stereoisomers. Stereoisomers are molecules that have the same molecular formula and differ only in how their atoms are arranged in three-dimensional space. In accordance with said definition, the linear alkanediol of the invention or the first linear alkanediol having a carbon chain of 5 to 14 carbon atoms or the second linear alkanediol having a carbon chain of 5 to 14 carbon atoms as described above in detail encompass the following stereoisomers:

1,2-alkanediol stereoisomers:

| | |
|---|---|
| (2S)-pentane-1,2-diol, | (2R)-pentane-1,2-diol, |
| (2S)-hexane-1,2-diol, | (2R)-hexane-1,2-diol, |
| (2S)-heptane-1,2-diol, | (2R)-heptane-1,2-diol, |
| (2S)-octane-1,2-diol, | (2R)-octane-1,2-diol, |
| (2S)-nonane-1,2-diol, | (2R)-nonane-1,2-diol, |
| (2S)-decane-1,2-diol, | (2R)-decane-1,2-diol, |
| (2S)-undecane-1,2-diol, | (2R)-undecane-1,2-diol, |
| (2S)-dodecane-1,2-diol, | (2R)-dodecane-1,2-diol, |
| (2S)-tridecane-1,2-diol, | (2R)-tridecane-1,2-diol, |
| (2S)-tetradecane-1,2-diol, | (2R)-tetradecane-1,2-diol, |

2,3-alkanediol stereoisomers:

| | |
|---|---|
| (2S,3S)-pentane-2,3-diol, | (2R,3R)-pentane-2,3-diol, |
| (2S,3S)-hexane-2,3-diol, | (2R,3R)-hexane-2,3-diol, |
| (2S,3S)-heptane-2,3-diol, | (2R,3R)-heptane-2,3-diol, |
| (2S,3S)-octane-2,3-diol, | (2R,3R)-octane-2,3-diol, |
| (2S,3S)-nonane-2,3-diol, | (2R,3R)-nonane-2,3-diol, |
| (2S,3S)-decane-2,3-diol, | (2R,3R)-decane-2,3-diol, |
| (2S,3S)-undecane-2,3-diol, | (2R,3R)-undecane-2,3-diol, |
| (2S,3S)-dodecane-2,3-diol, | (2R,3R)-dodecane-2,3-diol, |
| (2S,3S)-tridecane-2,3-diol, | (2R,3R)-tridecane-2,3-diol, |
| (2S,3S)-tetradecane-2,3-diol, | (2R,3R)-tetradecane-2,3-diol, |
| (2S,3R)-pentane-2,3-diol, | (2R,3S)-pentane-2,3-diol, |
| (2S,3R)-hexane-2,3-diol, | (2R,3S)-hexane-2,3-diol, |
| (2S,3R)-heptane-2,3-diol, | (2R,3S)-heptane-2,3-diol, |
| (2S,3R)-octane-2,3-diol, | (2R,3S)-octane-2,3-diol, |
| (2S,3R)-nonane-2,3-diol, | (2R,3S)-nonane-2,3-diol, |
| (2S,3R)-decane-2,3-diol, | (2R,3S)-decane-2,3-diol, |
| (2S,3R)-undecane-2,3-diol, | (2R,3S)-undecane-2,3-diol, |
| (2S,3R)-dodecane-2,3-diol, | (2R,3S)-dodecane-2,3-diol, |
| (2S,3R)-tridecane-2,3-diol, | (2R,3S)-tridecane-2,3-diol, |
| (2S,3R)-tetradecane-2,3-diol, | (2R,3S)-tetradecane-2,3-diol. |

3,4-alkanediol stereoisomers:

| | |
|---|---|
| (3R,4R)-pentane-3,4-diol, | (3S,4S)-pentane-3,4-diol, |
| (3R,4R)-hexane-3,4-diol, | (3S,4S)-hexane-3,4-diol, |
| (3R,4R)-heptane-3,4-diol, | (3S,4S)-heptane-3,4-diol, |
| (3R,4R)-octane-3,4-diol, | (3S,4S)-octane-3,4-diol, |
| (3R,4R)-nonane-3,4-diol, | (3S,4S)-nonane-3,4-diol, |
| (3R,4R)-decane-3,4-diol, | (3S,4S)-decane-3,4-diol, |
| (3R,4R)-undecane-3,4-diol, | (3S,4S)-undecane-3,4-diol, |
| (3R,4R)-dodecane-3,4-diol, | (3S,4S)-dodecane-3,4-diol, |
| (3R,4R)-tridecane-3,4-diol, | (3S,4S)-tridecane-3,4-diol, |
| (3R,4R)-tetradecane-3,4-diol, | (3S,4S)-tetradecane-3,4-diol, |
| (3R,4S)-pentane-3,4-diol, | (3S,4R)-pentane-3,4-diol, |
| (3R,4S)-hexane-3,4-diol, | (3S,4R)-hexane-3,4-diol, |
| (3R,4S)-heptane-3,4-diol, | (3S,4R)-heptane-3,4-diol, |
| (3R,4S)-octane-3,4-diol, | (3S,4R)-octane-3,4-diol, |
| (3R,4S)-nonane-3,4-diol, | (3S,4R)-nonane-3,4-diol, |
| (3R,4S)-decane-3,4-diol, | (3S,4R)-decane-3,4-diol, |
| (3R,4S)-undecane-3,4-diol, | (3S,4R)-undecane-3,4-diol, |
| (3R,4S)-dodecane-3,4-diol, | (3S,4R)-dodecane-3,4-diol, |
| (3R,4S)-tridecane-3,4-diol, | (3S,4R)-tridecane-3,4-diol, |
| (3R,4S)-tetradecane-3,4-diol, | (3S,4R)-tetradecane-3,4-diol. |

In the context of the present text, the terms “1,2-diol”, “2,3-diol” or “3,4-diol” includes both the corresponding S-configured enantiomers and also the R-enantiomer as well as arbitrary mixtures of these S- and R-configured enantiomers, i.e. mixtures of racemates of the respective diols.

The alkanediol mixture of the detergent and cleaning composition according to the first aspect of the present invention comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

In the detergent and cleaning composition according to the first aspect of the present invention, 1,2-heptanediol and 2,3-heptanediol are comprised in the mixture preferably in a ratio in a range of 98:2 to 99.9:0.1.

In the detergents and cleaning compositions according to the first aspect of the present invention, 1,2-heptanediol and 2,3-heptanediol are comprised in the alkanediol mixture preferably in a ratio in a range of 95:5 to 99.9:0.1.

Preferably, 1,2-heptanediol and 2,3-heptanediol are comprised in the mixture of the detergent and cleaning composition according to the first aspect of the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and cleaning composition according to the first aspect of the present invention comprises 1,2-heptanediol and 2,3-heptanediol in a ratio of ≥95:≤5, including the ratios ≥95.5:≤4.5; ≥96:≤4; ≥96.5:≤3.5; ≥97:≤3; ≥97.5:2.5 and ≥98.0:≤2.0.

Even more preferred the alkanediol mixture of the detergent and cleaning composition according to the first aspect of the present invention comprises 1,2-heptanediol and 2,3-heptanediol in a ratio of ≥98:≤2, including the ratios of ≥98.1:≤1.9; ≥98.2:≤1.8; ≥98.3:≤1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

The first linear alkanediol and the second linear alkanediol as defined in detail above, are present in the alkanediol mixture according to the present invention in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In the detergent and cleaning composition according to the present invention, the first linear alkanediol and the second linear alkanediol are comprised in the mixture preferably in a ratio in a range of 98:2 to 99.9:0.1

In the detergent and cleaning composition according to the present invention, the first linear alkanediol and the second alkanediol are comprised in the alkanediol mixture preferably in a ratio in a range of 95:5 to 99.9:0.1.

Preferably, the first linear alkanediol and the second alkanediol are comprised in the mixture of the detergent and cleaning composition according to the present invention in a ratio of ≥95:≤5, more preferred in a ratio of ≥96:≤4; still more preferred in a ratio of ≥97:≤3, and most preferred in a ratio of ≥98:≤2.

Most of all the mixtures of the detergent and cleaning composition according to the present invention comprises the first linear alkanediol and the second linear alkanediol in a ratio of ≥95:≤5, including the ratios ≥95.5:≤4.5; ≥96:≤4; ≥96.5:≤3.5; ≥97:≤3; ≥97.5:2, 5 and ≥98.0:≤2.0.

Even more preferred the alkanediol mixture of the detergent and cleaning composition according to the present invention comprises the first linear alkanediol and the second alkanediol in a ratio of ≥98:≤2, including the ratios of ≥98.1:≤1.9; ≥98.2:≤1.8; ≥98.3:≤ 1.7; ≥98.4:≤1.6; ≥98.5:≤1.5; ≥98.6:≤1.4; ≥98.7:≤1.3; ≥98.8:≤1.2; ≥98.9:≤1.1; ≥99:≤1.0; ≥99.1:≤0.9; ≥99.2:≤0.8; ≥99.3:≤0.7; ≥99.4:≤0.6; ≥99.5:≤0.5; ≥99.6:≤0.4; ≥99.7:≤0.3; ≥99.8:≤0.2 and ≥99.9:≤0.1.

Alternatively, said ratio ranges for the first and second alkanediol are switched, such that the second alkanediol is the main component and the first alkanediol is the secondary component.

In an advantageous variant according to the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, and as second linear alkanediol the corresponding 2,3-alkanediols, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In a further advantageous variant according to the present invention, the alkanediol mixture comprises as first linear alkanediol an 1,2-alkanediol, such as 1,2-pentanediol, 1,2-hexanediol, 1,2-heptanediol, 1,2-octanediol, 1,2-nonanediol, or 1,2-decanediol, and as second linear alkanediol the corresponding 2,3-alkanediols, such as 2,3-pentanediol, 2,3-hexanediol, 2,3-heptanediol, 2,3-octanediol, 2,3-nonanediol, or 2,3-decanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol: second alkanediol or ranges of ratios as described above are also applicable.

In a still further variant, according to the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, or 2,3-tetradecanediol, and as second linear alkanediol the corresponding 1,2-alkanediols, such as 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, or 1,2-tetradecanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

In a still further variant, according to the present invention, the alkanediol mixture comprises as first linear alkanediol an 2,3-alkanediol, such as 2,3-pentanediol, 2,3-hexanediol, 2,3-heptanediol, 2,3-octanediol, 2,3-nonanediol, or 2,3-decanediol, and as second linear alkanediol the corresponding 1,2-alkanediols, such as 1,2-pentanediol, 1,2-hexanediol, 1,2-heptanediol, 1,2-octanediol, 1,2-nonanediol, or 1,2-decanediol, in a ratio in a range of 50:50 to 99.9:0.1, preferably in a ratio in a range of 75:25 to 99:1, more preferred in a ratio in a range of 80:20 to 98:2, still more preferred in a ratio in a range of 90:10 to 95:5.

Likewise, for said alkanediol mixtures the ratios of first linear alkanediol: second alkanediol or ranges of ratios as described above are also applicable.

In a more advantageous variant according to the present invention, in the alkanediol mixtures comprising a combination of a 1,2-alkanediol as first linear alkanediol and the corresponding 2,3-alkanediol as second linear alkanediol, such as
1,2-pentanediol and 2,3-pentanediol, or
1,2-hexanediol and 2,3-hexanediol, or
1,2-heptanediol and 2,3-heptanediol, or
1,2-octanediol and 2,3-octanediol, or
1,2-nonanediol and 2,3-nonanediol, or
1,2-decanediol and 2,3-decanediol, or
1,2-undecanediol and 2,3-undecenaediol, or
1,2-dodecanediol and 2,3-dodecanediol, or
1,2-tridecanediol and 2,3-tridecanediol, or
1,2-tetradecanediol and 2,3-tetradecanediol,
   the first linear alkanediol and the second linear alkanediol are present in a ratio in a range of 50:50 to 99.9:0.1, preferably in a ratio in a range of 75:25 to 99:1, more preferred in a ratio in a range of 80:20 to 98:2 or still more preferred in ratio in a range of 90:10 to 95:5.

Likewise, for said alkanediol mixtures the ratios of first linear alkanediol: second alkanediol or ranges of ratios as described above are also applicable.

A preferred variant according to the present invention also encompasses a mixture including as first linear alkanediol 1,2-hexanediol and as second linear alkanediol 1,2-octanediol either in a ratio in a range of 50:50 to 99.9:0.1, preferably in a ratio in a range of 75:25 to 99:1, more preferred in a ratio in a range of 80:20 to 98:2 or still more preferred in a ratio in a range of 90:10 to 95:5.

Thus, according to another preferred variant, the present invention relates to a detergent and cleaning composition,
(i) wherein the mixture comprising 1,2-heptanediol and 2,3-heptanediol comprises the 1,2-heptanediol and the 2,3-heptanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5; or
(ii) wherein the mixture comprising at least one first linear alkanediol and one or more second linear alkanediol comprises the first linear alkanediol and the second alkanediol in a ratio in a range of 50:50 to 99.9:0.1, preferably in a ratio in a range of 75:25 to 99:1, more preferred in a ratio in a range of 80:20 to 98:2, still more preferred in a ratio of 90:10 to 95:5.

By these mixing ratios the afore mentioned alkanediol mixtures show a synergistically intensified degreasing boosting and greasy or oily stain and/or soil removal effect in comparison with the corresponding individual alkanediols.

The alkanediols are obtained either by synthesis from petrochemical or other fossil fuel sources by known methods such as olefin bis-hydroxylation, hydrolysis from epoxide or various chemical transformations or from bioderived feedstock by fermentation or from biobased natural and renewable feedstock such as biomass by catalytic synthesis as it is described in US 2019/0241491 A1 and US 2020/0189995 A1. The alkanediols used according to the present invention comprise either petrochemically derived and biobased natural and renewable feedstock derived alkanediols. Preferably, the alkanediols are from bio-based sources and are thus bio-alkanediols.

Beyond the above specified alkanediols, the degreasing boosting agent of the detergent and cleaning composition according to the present invention is either (b^{II}) glyceryl caprylate, or (b^{III}) 4-hydroxyacetophenone, or (b^{IV}) ethyl hexyl glycerin or (b^{V}) tropolone, or any mixture of the aforementioned agents.

Glyceryl Caprylate (b^{II})

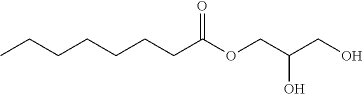

is a natural emollient derived from glycerine and plant fatty acids, usually appearing as a white waxy solid. This ingredient is used in many skincare products for its emollient and moisturising properties, to help maintain the balance of moisture in the skin. In additional, glyceryl caprylate (b^{II}) is used as antimicrobial active component in cosmetic preparations.

It was surprisingly found that the oily, surface-active co-emulsifier glyceryl caprylate is a further suitable degreasing boosting agent within the meaning of the present invention.

4-hydroxyacetophenone (4-HAP) (b^{II})

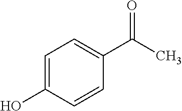

possesses oxidation-inhibiting, fungicidal and bacterial growth-inhibiting properties and is therefore used to stabilize cosmetic preparations.

It was surprisingly found that the 4-HAP is a further suitable degreasing boosting agent within the meaning of the present invention.

Ethyl Hexyl Glycerin (EHG) (b^{IV})

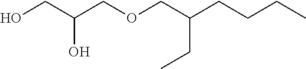

is a relatively new cosmetic ingredient that is used for its surfactant, dispersant, emollient, skin-conditioning and antimicrobial properties. Ethyl hexyl glycerin (EHG or octoxyglycerin) is a glyceryl ether and a vicinal diol.

It was surprisingly found that EHG is suitable to boost the degreasing power of a degreasing detergent and cleaning composition within the meaning of the present invention.

### Tropolone (b^{V})

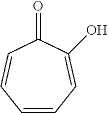

is known for its antibacterial, antifungal, anti-inflammatory, antioxidant, and chelating properties and is therefore used in cosmetic formulations.

It was surprisingly found that tropolone act as degreasing booster in a degreasing detergent and cleaning composition within the meaning of the present invention.

The above specified degreasing boosting agents (b^{II}) (b^{III}), (b^{IV}) and (b^{V}) can be used in the degreasing detergent and cleaning composition either individually or in the form of mixtures of two, or even more degreasing boosting agents.

In a particular preferred variant, the at least one degreasing boosting agent (b) in the detergent and cleaning composition according to the present invention includes any of the following mixtures/combinations:
a mixture comprising (b^{II}) glyceryl caprylate and (b^{III}) 4-hydroxyacetophenone;
a mixture comprising (b^{II}) glyceryl caprylate and (b^{IV}) ethyl hexyl glycerin;
a mixture comprising (b^{II}) glyceryl caprylate and (b^{V}) tropolone;
a mixture comprising (b^{III}) 4-hydroxyacetophenone and (b^{IV}) ethyl hexyl glycerin;
a mixture comprising (b^{III}) 4-hydroxyacetophenone and (b^{V}) tropolone; and
a mixture comprising (b^{IV}) ethyl hexyl glycerin and (b^{V}) tropolone.

For said boosting agent mixtures even a synergistic degreasing boosting effect can be observed.

Similarly, and still more preferred, the above specified single degreasing boosting agents (b^{II}) (b^{III}), (b^{IV}) and (b^{V}) or mixtures of two or three degreasing boosting agents (b^{II}) (b^{III}), (b^{IV}) and (b^{V}) can also be used in the degreasing detergent and cleaning composition in mixture with one or two alkanediol(s) degreasing boosting agents (b^{I}) as defined herein. Preferably, such mixtures contain two, or even more degreasing boosting agents as defined herein.

In a particular preferred variant, the detergent and cleaning composition according to the present invention the at least one degreasing boosting agent (b) includes any of the following mixtures/combinations:
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{II}) glyceryl caprylate;
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{III}) 4-hydroxyacetophenone;
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{IV}) ethyl hexyl glycerin;
a mixture comprising (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above, and (b^{V}) tropolone.

In a preferred variant, the detergent and cleaning composition according to the present invention includes any of the following boosting agent mixtures/combinations selected from the group consisting of:
a mixture comprising (b^{II}) glyceryl caprylate and 1,2-pentanediol;
a mixture comprising (b^{II}) glyceryl caprylate and 1,2-hexanediol;
a mixture comprising (b^{II}) glyceryl caprylate and 1,2-heptanediol;
a mixture comprising (b^{II}) glyceryl caprylate and 1,2-octanediol;
a mixture comprising (b^{II}) glyceryl caprylate and 1,2-nonanediol;
a mixture comprising (b^{II}) glyceryl caprylate and 1,2-decanediol;
a mixture comprising (b^{II}) glyceryl caprylate and 1,2-undecanediol;
a mixture comprising (b^{II}) glyceryl caprylate and 1,2-dodecanediol;
a mixture comprising (b^{II}) glyceryl caprylate and 1,2-tridecanediol;
a mixture comprising (b^{II}) glyceryl caprylate and 1,2-tetradecanediol;
a mixture comprising (b^{III}) 4-hydroxyacetophenone and 1,2-pentanediol;
a mixture comprising (b^{III}) 4-hydroxyacetophenone and 1,2-hexanediol;
a mixture comprising (b^{III}) 4-hydroxyacetophenone and 1,2-heptanediol;
a mixture comprising (b^{III}) 4-hydroxyacetophenone and 1,2-octanediol;
a mixture comprising (b^{III}) 4-hydroxyacetophenone and 1,2-nonanediol;
a mixture comprising (b^{III}) 4-hydroxyacetophenone and 1,2-decanediol;
a mixture comprising (b^{III}) 4-hydroxyacetophenone and 1,2-undecanediol;
a mixture comprising (b^{III}) 4-hydroxyacetophenone and 1,2-dodecanediol;
a mixture comprising (b^{III}) 4-hydroxyacetophenone and 1,2-tridecanediol;
a mixture comprising (b^{III}) 4-hydroxyacetophenone and 1,2-tetradecanediol;
a mixture comprising (b^{IV}) ethyl hexyl glycerin and 1,2-pentanediol;
a mixture comprising (b^{IV}) ethyl hexyl glycerin and 1,2-hexanediol;
a mixture comprising (b^{IV}) ethyl hexyl glycerin and 1,2-heptanediol;
a mixture comprising (b^{IV}) ethyl hexyl glycerin and 1,2-octanediol;
a mixture comprising (b^{IV}) ethyl hexyl glycerin and 1,2-nonanediol;
a mixture comprising (b^{IV}) ethyl hexyl glycerin and 1,2-decanediol;
a mixture comprising (b^{IV}) ethyl hexyl glycerin and 1,2-undecanediol;
a mixture comprising (b^{IV}) ethyl hexyl glycerin and 1,2-dodecanediol;
a mixture comprising (b^{IV}) ethyl hexyl glycerin and 1,2-tridecanediol;
a mixture comprising (b^{IV}) ethyl hexyl glycerin and 1,2-tetradecanediol;
a mixture comprising (b^{V}) tropolone and 1,2-pentanediol;
a mixture comprising (b^{V}) tropolone and 1,2-hexanediol;
a mixture comprising (b^{V}) tropolone and 1,2-heptanediol;
a mixture comprising (b^{V}) tropolone and 1,2-octanediol;
a mixture comprising (b^{V}) tropolone and 1,2-nonanediol;
a mixture comprising (b^{V}) tropolone and 1,2-decanediol;
a mixture comprising (b^{V}) tropolone and 1,2-undecanediol;
a mixture comprising (b^{V}) tropolone and 1,2-dodecanediol;
a mixture comprising (b^{V}) tropolone and 1,2-tridecanediol; and
a mixture comprising (b^{V}) tropolone and 1,2-tetradecanediol.

Surprisingly, it was found that the above specified combinations are particularly efficient degreasing boosting agent mixtures, which can also efficiently be incorporated into a broad range of detergents and cleaning compositions. In addition, it was found that these mixtures/combinations show outstanding stain and/or soil removal enhancing properties in a detergent and cleaning composition. Thus, such detergents and cleaning compositions show improved cleaning properties compared to detergent and cleaning composition without the addition of such degreasing boosting combinations.

Surprisingly, for said boosting agent mixtures even a synergistic degreasing boosting effect can be observed.

Most preferred, the deter detergent and cleaning composition according to the present invention includes a mixture of degreasing boosting agents comprising an 1,2-alkanediol combined with 4-hydroxyacetophenone selected from the group consisting of:
a mixture comprising (b^{III}) 4-hydroxyacetophenone and 1,2-pentanediol;
a mixture comprising (b^{III}) 4-hydroxyacetophenone and 1,2-hexanediol;
a mixture comprising (b^{III}) 4-hydroxyacetophenone and 1,2-heptanediol;
a mixture comprising (b^{III}) 4-hydroxyacetophenone and 1,2-octanediol;
a mixture comprising (b^{III}) 4-hydroxyacetophenone and 1,2-nonanediol;
a mixture comprising (b^{III}) 4-hydroxyacetophenone and 1,2-decanediol;
a mixture comprising (b^{III}) 4-hydroxyacetophenone and 1,2-undecanediol;
a mixture comprising (b^{III}) 4-hydroxyacetophenone and 1,2-dodecanediol;
a mixture comprising (b^{III}) 4-hydroxyacetophenone and 1,2-tridecanediol;
a mixture comprising (b^{III}) 4-hydroxyacetophenone and 1,2-tetradecanediol;

It was found that these degreasing boosting mixtures show an outstanding synergistic boosting effect in terms of stain and/or soil removal enhancing properties in a detergent and cleaning composition. Thus, such detergents and cleaning compositions show improved cleaning properties compared to detergent and cleaning composition without the addition of such degreasing boosting combinations.

However, a particular pronounced degreasing boosting effect can be observed for the following degreasing boosting agents:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tirdecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

For the degreasing detergent and cleaning composition according to the present invention, the list of degreasing boosting agents (b1, b2, b3, b) specified herein can be arbitrary combined with the list of degreasing agents specified herein.

In a particular advantageously variant, the degreasing detergent and cleaning composition according to the present invention comprises one of the following combinations of components (a) and (b):
iso-propanol plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or propanediol plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
dipropylene glycol methyl ether plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
propylene-glycol-t-butylether plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyethylene glycol 400 monolaurate plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyoxyethylene sorbitan monooleate (Tween 80) plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
polyoxyethylene lauryl ether (Brij 35) plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone; or
potassium oleate plus one or more of the following degreasing boosting agents: (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined above; (b^{II}) glyceryl caprylate; (b^{III}) 4-hydroxyacetophenone; (b^{IV}) ethyl hexyl glycerin; or (b^{V}) tropolone.

Surprisingly, the above specified combinations of a decreasing agent (a) with one degreasing boosting agent (b) or a mixture of degreasing boosting agents (b) result in a remarkable degreasing power boosting effect in a degreasing detergent and cleaning composition, compared to a degreasing detergent and cleaning composition which does not comprise a degreasing boosting agent.

Beside the improved degreasing performance, the combinations also exhibit a remarkable improvement in removal of greasy or oily stain and/or soil when used in a detergent and cleaning composition.

In a more preferred variant, the detergent and cleaning composition according to the present invention comprises one of the following combinations of components (a) and (b):
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-pentanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-hexanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-heptanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-octanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus glyceryl caprylate; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 4-hydroxyacetophenone; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus ethyl hexyl glycerin; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus tropolone; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus a mixture comprising 1,2-hexanediol and 1,2-octanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus a mixture comprising 1,2-hexanediol and 1,2-octanediol and tropolone; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus a mixture comprising 4-hydroxyacetophenone and 1,2-octanediol.

In a further preferred variant, the detergent and cleaning composition according to the present invention comprises one of the following combinations of components (a) and (b):
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-nonanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-decanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-undecanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-dodecanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-tridecanediol; or
iso-propanol and/or propanediol and/or dipropylene glycol methyl ether and/or propylene-glycol-t-butylether and/or polyethylene glycol 400 monolaurate and/or polyoxyethylene sorbitan monooleate (Tween 80) and/or polyoxyethylene lauryl ether (Brij 35) and/or potassium oleate plus 1,2-tetradecanediol.

It was found that the aforesaid combinations result in superior degreasing boosting performance in a detergent and cleaning composition.

Accordingly, said combinations comprising a degreasing agent and a degreasing boosting agent do not only have a remarkable degreasing boosting effect, but are simultaneously beneficial in laundry detergents, detergents for manual and automatic dishwash, hard surface cleaners, cleaners for medical and dental instruments, stain removers and the like, since they exhibit an enhanced greasy or oily stain and/or soil removal activity, resulting in an improved cleaning performance upon application, in comparison to a detergent and cleaning composition without the addition of said degreasing boosting agents.

### Surfactant/Component (c1, c2, c3, c)

The detergent and cleaning composition according to the present invention includes at least one surfactant. (c1, c2, c3, c).

Surfactants are added for a number of reasons, the main purposes being their washing and surface-active properties. They remove soils from the clothing and surfaces in the washing and cleaning process and keep it suspended in the washing solution. Some surfactants perform other functions such as foam inhibition.

The detergent and cleaning composition according to the present invention may comprise any kind of surfactant, namely anionic surfactants, cationic surfactants, non-ionic surfactants, amphoteric/zwitterionic surfactant, and any mixture thereof.

Suitable surfactants which can be incorporated into the detergents and cleaning compositions according to the present invention are:

### Anionic Surfactants

Suitable anionic surfactants for the detergent and cleaning composition according to the present invention may include any conventional anionic surfactants. Typical examples for anionic surfactants encompass:
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
   and any mixture thereof.

In a preferred variant of the detergent and cleaning composition according to the present invention, the anionic surfactant is selected from the group consisting of
C10 to C13 alkyl benzene sulfonates;
C12 to C15 alkyl sulfates;
C12 to C14 alkyl sulfates, ethoxylated with 1 to 3 moles ethylene oxide;
C12 to C₁₆ alpha-olefin sulfonates;
C8 to C18 alkyl carboxylates, ethoxylated with 3 to 10 moles ethylene oxide;
   and any mixture thereof.

In a more preferred variant of the detergent and cleaning composition according to the present invention, the anionic surfactant is selected from the group consisting of
dodecyl benzene sulfonate;
dodecyl sulfate;
dodecyl sulfate, ethoxylated with 2 moles ethylene oxide;
C12 to C14 alpha-olefin sulfonates;
C18 alkyl carboxylates, ethoxylated with 9 to 10 moles ethylene oxide;
   and any mixture thereof.

For laundry detergents, the anionic surfactant is most preferred selected from the group consisting of dodecyl benzene sulfonate, dodecyl sulfate, dodecyl sulfate, ethoxylated with 2 moles ethylene oxide, and any mixture thereof.

For hand dishwashing detergents, the anionic surfactant is most preferred selected from the group consisting of dodecyl sulfate, dodecyl sulfate, ethoxylated with 2 moles ethylene oxide, and any mixture thereof.

For hard surface cleaning detergents, the anionic surfactant is most preferred selected from the group consisting of dodecyl sulfate, dodecyl sulfate, ethoxylated with 2 moles ethylene oxide, and any mixture thereof.

### Cationic Surfactants

Suitable cationic surfactants for the detergent and cleaning composition according to the present invention may include any conventional cationic surfactants. Typical examples for cationic surfactants encompass:
quaternary C8 to C18 alkyl ethanolamines;
quaternary C8 to C18 alkyl ammonium compounds;
C8 to C18 alkyl ammonium methosulfates;
   and any mixture thereof.

In a preferred variant of the detergent and cleaning composition according to the present invention, the cationic surfactant is selected from the group consisting of
quaternary C12 to C18 alkyl ethanolamines;
quaternary C12 to C18 alkyl ammonium compounds;
C12 to C18 alkyl ammonium methosulfates;
   and any mixture thereof.

In a more preferred variant of the detergent and cleaning composition according to the present invention, the cationic surfactant is selected from the group consisting of
quaternary C16 to C18 alkyl ethanolamines;
quaternary C16 to C18 alkyl ammonium compounds;
C14 to C18 alkyl ammonium methosulfates;
   and any mixture thereof.

For hard surface cleaning detergents, the cationic surfactant is most preferred selected form the group consisting of quaternary C16 to C18 alkyl ammonium compounds, and any mixture thereof.

For fabric softener, the cationic surfactant is most preferred selected form the group consisting of C14 to C18 alkyl ammonium methosulfates, and any mixture thereof.

### Non-Ionic Surfactants

Suitable non-ionic surfactants for the detergent and cleaning composition according to the present invention may include any conventional non-ionic surfactants. Typical examples for non-ionic surfactants encompass:
C6 to C18 fatty alcohols, ethoxylated with 1 to 12 moles ethylene oxide;
alkoxylated C6 to C18 fatty alcohols such as
   C6 to C18 fatty alcohols, ethoxylated with 1 to 25 moles ethylene oxide,
   C6 to C18 fatty alcohols, propoxylated with 1 to 15 moles propylene oxide,
   C6 to C18 fatty alcohols, butoxylated with 1 to 10 moles butylene oxide,
   and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
   and any mixture thereof.

In a preferred variant of the detergent and cleaning composition according to the present invention, the non-ionic surfactant is selected from the group consisting of
C8 to C15 fatty alcohols, ethoxylated with 3 to 8 moles ethylene oxide;
alkoxylated C8 to C15 fatty alcohols such as
   C8 to C15 fatty alcohols, ethoxylated with 1 to 25 moles ethylene oxide;
   C8 to C15 fatty alcohols, propoxylated with 1 to 15 moles propylene oxide,
   C8 to C15 fatty alcohols, butoxylated with 1 to 10 moles butylene oxide,
   and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates;
   and any mixture thereof.

In a more preferred variant of the detergent and cleaning composition according to the present invention, the non-ionic surfactant is selected from the group consisting of.
C10 to C18 sophorolipids;
C10 to C18 rhamnolipids;
C8 to C14 alkyl polyglycosides;
Cocamide DEA/MEA;
C10 to C14 fatty acid ester alkoxylates;
   and any mixture thereof.

In a still more preferred variant of the detergent and cleaning composition according to the present invention, the non-ionic surfactant is selected from the group consisting of.
C10 to C18 sophorolipids;
C10 to C18 rhamnolipids;
C8 to C14 alkyl polyglycosides;
   and any mixture thereof.

The non-ionic surfactant in the detergent and cleaning composition according to the present invention is different to the degreasing agent as defined herein.

Said non-ionic detergents are particularly beneficial for preparing “green” detergents and cleaning compositions.

For laundry detergents, dishwashing detergents and hard surface cleaning detergents, the non-ionic surfactant is most preferred selected from the group consisting of C10 to C18 sophorolipids, C10 to C18 rhamnolipids, C8 to C14 alkyl polyglycosides, and any mixture thereof.

In a further preferred variant, for laundry detergents the non-ionic surfactant is selected from the group consisting of C12 to C14 fatty alcohols, ethoxylated with 7 moles ethylene oxide, C13 to C15 fatty alcohols, ethoxylated with 7 moles ethylene oxide, and any mixture thereof.

In a further preferred variant, for hard surface cleaning, such as degreaser, the non-ionic surfactant is selected from the group consisting of C9 to C11 fatty alcohols, ethoxylated with 3 to 8 moles ethylene oxide, C10 fatty alcohol, ethoxylated with 3 to 8 moles ethylene oxide, and any mixture thereof.

In a further preferred variant, for automatic dishwashing, the non-ionic surfactant is selected from the group consisting of C12 to C14 fatty alcohols, ethoxylated with 5 mol ethylene oxide and/or propoxylated with 4 mol propylene oxide.

### Amphoteric/Zwitterionic Surfactants

Suitable amphoteric/zwitterionic surfactants for the detergent and cleaning composition according to the present invention may include any conventional amphoteric/zwitterionic surfactants. Typical examples for amphoteric/zwitterionic surfactants encompass:
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
   and any mixture of the above surfactants.

In a preferred variant of the detergent and cleaning composition according to the present invention, the amphoteric/zwitterionic surfactant is selected from the group consisting of
C10 to C15 N-(alkyl)-N,N-dimethylamine oxide;
C10 to C15 N-(alkyl)-N, N-bis(2-hydroxyethyl)amine oxide;
C10 to C15 alkyl amido propyl dimethyl amine oxide;
C10 to C15 alkylbetaines;
C10 to C15 alkylamidobetaines;
C10 to C15 sulfobetaines;
   and any mixture of the above surfactants.

In a more preferred variant of the detergent and cleaning composition according to the present invention, the amphoteric/zwitterionic surfactant is selected from the group consisting of
C12 to C14 N-(alkyl)-N, N-dimethylamine oxides;
C12 to C14 N-(alkyl)-N,N-bis(2-hydroxyethyl)amine oxides;
C12 to C14 alkyl amido propyl dimethyl amine oxides;
C12 to C14 alkylbetaines;
C12 to C14 alkylamidobetaines;
C12 to C14 sulfobetaines;
   and any mixture of the above surfactants.

For hand dishwashing detergents, the amphoteric/zwitterionic surfactant is most preferred selected from the group consisting of C12 to C14 alkylbetaines, and any mixture thereof.

The above specified surfactants can be used either singular or in the form of mixtures of two, three, or even more surfactants, either from the same surfactant category (anionic, cationic, non-ionic, amphoteric/zwitterionic) or as mixture of surfactants of different surfactant categories.

In a preferred variant, the detergent and cleaning composition according to the present invention comprises an anionic surfactant or a mixture of two or even more anionic surfactants selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide; and
their preferred variants as specified before.

In a still more preferred variant, the detergent and cleaning composition according to the present invention comprises a non-ionic surfactant or a mixture of two or even more non-ionic surfactants selected from the group consisting of
C8 to C15 fatty alcohols, ethoxylated with 3 to 8 moles ethylene oxide;
alkoxylated C8 to C15 fatty alcohols such as
   C8 to C15 fatty alcohols, ethoxylated with 1 to 25 moles ethylene oxide,
   C8 to C15 fatty alcohols, propoxylated with 1 to 15 moles propylene oxide,
   C8 to C15 fatty alcohols, butoxylated with 1 to 10 moles butylene oxide,
      and combinations thereof;
C8 to C18 sophorolipids;
C8 to C18 rhamnolipids;
C7 to C15 alkyl polyglycosides;
C8 to C15 alkanolamides;
C8 to C15 fatty acid ester alkoxylates; and
their preferred variants as specified before.

In a most preferred variant, the detergent and cleaning composition according to the present invention comprises a combined mixture of one or even more of anionic and one or even more of non-ionic surfactants as specified herein, i.e. a combination of one or more anionic surfactant and one or more non-ionic surfactants.

The above numeric ranges recited with respect of the number of C atoms of the surfactants, given in the form “Cx to Cy” include the values defining the range and include each integer within the defined range, the range C10 to C18 includes C10, C11, C12, C13, C14, C15, C16, C17 and C18. For example, the term “C10 to C18 alkyl” includes decyl, undecyl, dodecyl, tridecyl, tetradecyl, pentadecyl, hexadecyl, heptadecyl and octadecyl. Analogously, the term “C12 to C14 alkyl” includes dodecyl, tridecyl and tetradecyl. For example, the term “C6 to C18 fatty alcohols” includes fatty alcohols having a carbon chain with 6, 7, 8, 9, 10, 11, 12, 13, 14, 15, 16, 17, or 18 carbon atoms. Analogously, the term “C6 to C18 rhamnolipids” includes structures comprising a rhamnolipid and a carbon chain having 6, 7, 8, 9, 10, 11, 12, 13, 14, 15, 16, 17 or 18 carbon atoms.

### Enzyme or Enzyme Formulation/Component (d1, d2, d3, d)

The detergent and cleaning composition according to the present invention optionally comprises at least one enzyme or an enzyme formulation, comprising at least one enzyme, as component (d1, d2, d3, d). The enzyme or enzyme mixture provide for cleaning performance, by removing stain and/or soil, and/or fabric care benefits.

Enzymes are known as effective chemicals for use with detergents and other cleaning agents to break down soils. Enzymes break down soils, make them more soluble, and enable surfactants to remove them from a surface to provide enhanced cleaning of a substrate. Specifically, enzymes can provide desirable activity for removal of, for example, protein-based, carbohydrate-based, or triglyceride-based stains from substrates. In addition, enzymes also help to improve wash results at lower temperatures. As a result, enzymes have been used for various cleaning applications in order to digest or degrade soils such as grease, oils (e.g. vegetable oils or animal fat), protein, carbohydrate, or the like. For example, enzymes may be added as a component of a composition for laundry, textiles, ware washing, cleaning-in-place, cleaning drains, floors, carpets, medical or dental instruments, meat cutting tools, hard surfaces, personal care, or the like.

Enzymes suitable for the detergents and cleaning compositions can act by degrading or altering one or more types of soil residues encountered on an instrument or device thus removing the soil or making the soil more removable by a surfactant or other component of the cleaning composition. Both degradation and alteration of soil residues can improve detergency by reducing the physicochemical forces that bind the soil to the instrument or device being cleaned, e.g., the soil becomes more water soluble. For example, one or more proteases can cleave complex, macro molecular protein structures present in soil residues into simpler short chain molecules which are, of themselves, more readily desorbed from surfaces, solubilized or otherwise more easily removed by detersive solutions containing said proteases.

Detersive enzymes according to the present invention have a cleaning, destaining, desoiling or otherwise beneficial effect as a component of a detergent and cleaning composition for instruments, devices, or equipment, such as medical or dental instruments, devices, or equipment; or for laundry, textiles, ware-washing, cleaning-in-place, drains, carpets, meat cutting tools, hard surfaces, personal care, or the like.

Enzymes that can be used in the detergent and cleaning composition according to the present invention include enzymes that provide desirable activity for removal of protein-based, carbohydrate-based, or lipid-based (fat or oil-based) stains and/or soils from substrates; for cleaning, destaining, and sanitizing presoaks, such as presoaks for medical and dental instruments, devices, and equipment; presoaks for flatware, cooking ware, and table ware; or presoaks for meat cutting equipment; for machine warewashing; for laundry and textile cleaning and destaining; for carpet cleaning and destaining; for cleaning-in-place (CIP) and destaining-in-place; for cleaning and destaining food processing surfaces and equipment; for drain cleaning; presoaks for cleaning; and the like.

Suitable enzymes used according to the present invention are selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases (including Dnase and/or Rnase), phenoloxidases, lipoxygenases, ligninases, pullulanases, tannases, pentosanases, malanases, β-glucanases, arabinosidases, hyaluronidases, chondroitinases, oxidoreductases, and any mixture thereof.

More preferred, the enzyme in the detergent and cleaning compositions according to the present invention is selected from the group consisting of proteases, amylases, lipases, cellulases, mannanases, pectate lyases, and any mixture thereof.

The enzymes used according to the present invention are of any suitable origin, such as vegetable, animal, bacterial, fungal or yeast origin.

Proteases: Any protease or mixture of proteases, from any source, can be used in the detergents and cleaning compositions, provided that the selected enzyme is stable in the desired pH range (between about 6 and about 9). For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant). Exemplary proteases are commercially available under the following trade names Alcalase®, Blaze®, Savinase®, Esperase®, Progress UNO™, Liquanase® and Pristine®, each available from Novozymes; and Preferenz® P and Excellenz® P, each available from DUPONT/IFF.

Amylases: Any amylase or mixture of amylases, from any source, can be used in the detergents and cleaning compositions, provided that the selected enzyme is stable in the desired pH range (between about 6 and about 9). For example, the amylase enzymes can be derived from a plant, an animal, or a microorganism such as a yeast, a mold, or a bacterium. Preferred amylase enzymes include, but are not limited to, those derived from a Bacillus, such as B. licheniformis, B. amyloliquefaciens, B. subtilis, or B. stearothermophilus. Amylase enzymes derived from B. subtilis are most preferred. The amylase can be purified or a component of a microbial extract, and either wild type or variant (either chemical or recombinant). Preferred amylases are commercially available under the trade names Stainzyme® and Amplify®, each available from Novozymes; and Preferenz® S, available from DUPONT/IFF.

Lipases: Any lipase or mixture of lipases, from any source, can be used in the detergents and cleaning compositions, provided that the selected enzyme is stable in the desired pH range (between about 6 and about 9). For example, the lipase enzymes can be derived from a plant, an animal, or a microorganism such as a fungus or a bacterium. Preferred protease enzymes include, but are not limited to, the enzymes derived from a Pseudomonas, such as Pseudomonas stutzeri ATCC 19.154, or from a Humicola, such as Humicola lanuginosa (typically produced recombinantly in Aspergillus oryzae). The lipase can be purified or a component of a microbial extract, and either wild type or variant (either chemical or recombinant). Preferred lipases are commercially available under the trade names Lipex®, available from Novozymes, and Preferenz® L, available from DUPONT/IFF.

Cellulases: Any cellulase or mixture of cellulases, from any source, can be used in the detergents and cleaning compositions, provided that the selected enzyme is stable in the desired pH range (between about 6 and about 9). For example, the cellulase enzymes can be derived from a plant, an animal, or a microorganism such as a fungus or a bacterium. Preferred cellulase enzymes include, but are not limited to, those derived from Humicola insolens, Humicola strain DSM1800, or a cellulase 212-producing fungus belonging to the genus Aeromonas and those extracted from the hepatopancreas of a marine mollusk, Dolabella Auricula Solander. The cellulase can be purified or a component of a microbial extract, and either wild type or variant (either chemical or recombinant). Preferred cellulases are commercially available under the trade names Celluclean® and Carezyme®, each available from Novozymes; and Revitalenz®, available from DUPONT/IFF.

Preferred enzyme selections depend upon the conditions of final utility, including the physical product form, use pH, use temperature, and soil types to be degraded or altered and are influenced by factors such as pH-activity and/or stability optima, thermostability, and stability to active detergents, builders and the like. The enzyme can be chosen to provide optimum activity and stability for any given set of utility conditions. In this respect, bacterial or fungal enzymes are preferred.

Protease enzymes, amylase enzymes and lipase enzymes are the most used enzymes in detergents and cleaning compositions. The protease enzymes are particularly advantageous for cleaning soils containing protein, e.g. egg, milk, meat residue, or the like. The amylase enzymes are particularly advantageous for removing starch-based soils, such as pasta and rice. The lipase enzymes are particularly advantageous for cleaning soils including fat/grease.

As one skilled in the art shall ascertain, enzymes are designed to work with specific types of soils. For example, according to an embodiment of the invention, ware wash applications may use a protease enzyme as it is effective at the high temperatures of the ware wash machines and is effective in reducing protein-based soils. Protease enzymes are particularly advantageous for cleaning soils containing protein, such as blood, cutaneous scales, mucus, grass, food (e.g. egg, milk, spinach, meat residue, tomato sauce), or the like.

According to the invention, the enzyme containing detergent and cleaning composition may be varied based on the particular cleaning application and the types of soils in need of cleaning. For example, the temperature of a particular cleaning application will impact the enzymes selected for an enzyme composition according to the invention. Ware wash applications, for example, clean substrates at temperatures in excess of approximately 60° C., or in excess of approximately 70° C., or between approximately 65° C. to 80° C., and enzymes such as proteases are desirable due to their ability to retain enzymatic performance at such elevated temperatures. Laundry applications, for example, clean laundry at temperatures in excess of approximately 40° C., or in excess of approximately 50° C., or between approximately 65° C. to 90° C., and enzymes such as proteases are desirable due to their ability to retain enzymatic performance at such elevated temperatures.

Preferably, the at least one enzyme is selected from the group consisting of a protease, an amylase, a lipase, a cellulase, a gluconase, a peroxidase, or a mixture thereof.

In some variants, the enzyme in the detergent and cleaning composition is a protease, an amylase, a lipase, a cellulase, a gluconase, a peroxidase, a mannanase, or any mixture thereof.

Preferably the enzyme in the detergent and cleaning composition is a mixture of protease, an amylase, a lipase, a cellulase and/or pectate lyase.

Preferred detersive enzymes in the detergent and cleaning composition include a hydrolase such as a protease, an amylase, a lipase, or a combination thereof.

Preferably, the enzyme in the detergent and cleaning composition is a protease, amylase, lipase, cellulose, peroxidase, gluconase, or any mixture thereof.

In a still preferred variant, the enzyme in the detergent and cleaning composition disclosed here is a protease, amylase, lipase, or any mixture thereof.

Still more preferred, the enzyme in the detergent and cleaning composition is a protease, an amylase, or a mixture thereof.

Still more preferred, the enzyme in the detergent and cleaning composition is a protease, a lipase, or a mixture thereof.

Still more preferred, the enzyme in the detergent and cleaning composition is selected from an amylase, a lipase, or a mixture thereof.

In some other embodiments, the enzyme in the detergent and cleaning composition is a protease.

In yet some other variant, the enzyme in the detergent and cleaning composition is an amylase.

In yet some other variant, the enzyme in the detergent and cleaning composition is a lipase.

In yet some other variant, the enzyme in the detergent and cleaning composition is a cellulase.

Preferred enzymes in detergents and cleaning compositions according to the present invention for cleaning medical or dental devices or instruments include a protease, an amylase, a cellulase, a lipase, or a combination thereof.

Preferred enzymes in detergents and cleaning compositions according to the present invention for food processing surfaces and equipment include a protease, a lipase, an amylase, a gluconase, or a combination thereof.

Preferred enzymes in detergent and compositions according to the present invention for laundry or textiles include a protease, a cellulase, a lipase, a peroxidase, or a combination thereof.

Preferred enzymes in detergent and compositions for carpets include a protease, an amylase, or a combination thereof.

Preferred enzymes in detergents and cleaning compositions according to the present invention for meat cutting tools include a protease, a lipase, or a combination thereof.

Preferred enzymes in detergents and cleaning compositions according to the present invention for hard surfaces include a protease, an amylase, a lipase, or a combination thereof.

Preferred enzymes in detergents and cleaning compositions according to the present invention for drains include a protease, an amylase, a lipase, or a combination thereof.

For a stain remover, the enzymes are preferably selected from the group consisting of protease, amylase, lipase, mannanase, pectate lyase, and any mixture thereof.

For a fabric softener, the enzymes are preferably selected from the group consisting of cellulase.

In order to increase the bleaching effect, oxidoreductases are optionally added to the detergent and cleaning composition according to the present invention.

The oxidoreductases are selected from the group consisting of oxidases, oxygenases, catalases, peroxidases, such as halo-, chloro-, bromo-, lignin-, glucose- or manganese-peroxidases, dioxygenases or laccases, such as phenoloxidases and polyphenoloxidases, and any mixture thereof.

Commercial enzymes are obtainable in liquid or dried form (i.e. puck, powder, etc.), are sold as raw aqueous solutions or in assorted purified, processed and compounded forms established in the prior art, and include about 0.1% to about 80% by weight active enzyme generally in combination with stabilizers, buffers, cofactors, impurities and inert vehicles. The actual active enzyme content depends upon the method of manufacture and is not critical; assuming the detergent and cleaning composition has the desired enzymatic performance.

This includes for example the solid enzyme preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers and are storage-stable on account of the coating. Furthermore, it is possible to package two or more enzymes together so that a single granulate exhibits multiple enzyme activities.

In a preferred variant according to the present invention, the enzyme added to the detergent and cleaning composition is a single enzyme.

In some other variants, the enzyme added to the detergent and cleaning composition is preferably an enzyme cocktail of two, three, four or even more different enzymes. Typically, for laundry detergents an enzyme cocktail contains from two (preferably protease and amylase) to six enzymes.

In a more preferred variant, the at least one enzyme is added to the detergent composition according to the present invention as enzyme formulation comprising an enzyme or a cocktail of different enzymes in mixture with one or more stabilizer(s), preferably with one or more enzyme stabilizers, and optionally buffers, additives, and the like.

Preferably, an enzyme stabilizer is added to the enzyme formulation for stabilizing the enzyme in the detergent and cleaning composition from loss of performance (i.e. retain enzymatic activity or enzymatic retention). The enzymes are stabilized by the enzyme stabilizer through a physical protection by means of a protective layer.

The enzyme formulation may vary based upon the particular enzymes employed.

The at least one enzyme (d) employed herein is stabilized by the presence of water-soluble sources of calcium and/or magnesium ions in the finished detergents which provide such ions to the enzymes. Calcium ions are generally somewhat more effective than magnesium ions and are preferred herein if only one type of cation is being used. Typical detergents, especially liquids, comprise from 1 to 30, preferably from 2 to 20, more preferably from 5 to 15, and most preferably from 8 to 12, millimoles of calcium ion per liter of finished composition.

It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from 0.01% to 2% by weight of a water-soluble source of calcium or magnesium ions, or both. The amount can vary, of course, with the amount and type of enzyme employed in the composition.

Additional enzyme stability can be provided by the presence of various other art-disclosed stabilizers, especially borate species.

One group of stabilizers are reversible protease inhibitors. Benzamidine hydrochloride, borax, boric acids, boronic acids or their salts or esters are frequently used for this purpose, including in particular derivatives having aromatic groups. Typically, such enzyme stabilizers are used at levels in the compositions from 0.05% to 5%, more preferably from 0.075% to 3% by weight of boric acid or other borate compound capable of forming boric acid in the composition (calculated on the basis of boric acid). Boric acid is preferred, although other compounds such as boric oxide, borax and other alkali metal borates (e.g., sodium ortho-, meta- and pyroborate, and sodium pentaborate) are suitable. Substituted boric acids (e.g., phenylboronic acid, butane boronic acid, and p-bromo phenylboronic acid) can also be used in place of boric acid.

Also, peptide aldehydes, i.e. oligopeptides having a reduced C-terminus, in particular those from 2 to 50 monomers, or hydrogen sulfite adducts thereof are used for this purpose. The peptidic reversible protease inhibitors include, but are not limited to, ovomucoid and leupeptin. Specific, reversible peptide inhibitors for the protease subtilisin and fusion proteins from proteases and specific peptide inhibitors are also suitable for this purpose.

Further enzyme stabilizers are amino alcohols such as mono-, di-, triethanol- and propanolamine and mixtures thereof, aliphatic carboxylic acids up to C12, such as succinic acid, other dicarboxylic acids or salts of the acids mentioned.

End-capped fatty acid amide alkoxylates are also suitable for this purpose.

Preferably, the enzyme stabilizer in the enzyme formulation is selected from the group consisting of polyols such as glycol, such as monopropylene glycol, glycerine, mannitol, isomaltol, lactic, sorbitol, xylitol, threitol, erythritol, arabitol; amino alcohols such as mono-, di-, triethanolamine and -propanolamine; aliphatic carboxylic acids up to C12, such as succinic acid and salts thereof; dicarboxylic acids and salts thereof; end-capped fatty acid amide alkoxylates; salts, preferably calcium and magnesium salts, such as calcium chloride, calcium formate, magnesium chloride, magnesium formate; reversible enzyme inhibitors such as borate-containing compositions, such as 4-FBPA, boron-free inhibitors, such as disubstituted alaninamide, sodium formate; and any mixture thereof.

The enzyme stabilizer or the enzyme formulation including the enzyme stabilizer is added to the degreasing detergent and cleaning composition in such amounts, that the enzyme stabilizer is present in the degreasing detergent and cleaning composition in an amount of 0.0001 to 5% by weight, based on the total weight of the detergent and cleaning composition. Preferably, the enzyme stabilizer is present in an amount of 0.001 to 4% by weight, based on the total weight of the degreasing detergent and cleaning composition. Most preferred, the degreasing detergent and cleaning composition includes the enzyme stabilizer in an amount of 0.01 to 3% by weight, based on the total weight of the composition.

Alternatively, and still more preferred, the at least one enzyme is added to the degreasing detergent and cleaning composition according to the present invention as enzyme formulation in mixture with 1,2-heptanediol and/or 2,3-heptanediol or a specific type of a degreasing boosting agent (b), such as alkanediols having a carbon chain from 5 to 14 carbon atoms as specified herein, glyceryl caprylate, 4-hydroxyacetophenone, ethyl hexyl glycerin, tropolone, or a mixture of said degreasing boosting agents, and optionally buffers, additives, and the like.

In a further preferred variant, the at least one enzyme is added to the degreasing detergent and cleaning composition according to the present invention as enzyme formulation in mixture with an enzyme stabilizer and with 1,2-heptanediol and/or 2,3-heptanediol or a specific type of a degreasing boosting agent (b), such as alkanediols having a carbon chain from 5 to 14 carbon atoms as specified herein, glyceryl caprylate, 4-hydroxyacetophenone, ethyl hexyl glycerin, tropolone, or a mixture of said degreasing boosting agents, and optionally buffers, and the like.

Surprisingly, it turned out that in such formulations the addition of 1,2-heptanediol and/or 2,3-heptanediol or a specific type of a degreasing boosting agent (b), such as alkanediols having a carbon chain from 5 to 14 carbon atoms, glyceryl caprylate, 4-hydroxyacetophenone, ethyl hexyl glycerin, tropolone, or a mixture of said degreasing boosting agents, enhances or boosts the enzyme stabilizing effect of the enzyme stabilizers as specified above in such mixtures.

Unexpectedly, the combination of 1,2-heptanediol and/or 2,3-heptanediol or a specific type of degreasing boosting agent (b), such as alkanediols having a carbon chain from 5 to 14 carbon atoms, glyceryl caprylate, 4-hydroxyacetophenone, ethyl hexyl glycerin, tropolone, or a mixture of said degreasing boosting agents, and an enzyme stabilizer results in an enhanced enzyme stabilizing effect in the detergent and cleaning composition comprising an enzyme, in comparison to the use of the single enzyme stabilizer without the use of such degreasing boosting agents.

For the detergent and cleaning composition according to the present invention, the list of the degreasing boosting agents (b1, b2, b3, b) specified herein can be arbitrary combined with the list of the enzyme stabilizers.

A remarkable enzyme stabilizing enhancing effect is observed, when one of the following degreasing boosting agents are used in combination with one or more of the above specified enzyme stabilizers:
1,2-pentanediol;
1,2-hexanediol;
1,2-heptanediol;
1,2-octanediol;
1,2-nonanediol;
1,2-decanediol;
1,2-undecanediol;
1,2-dodecanediol;
1,2-tridecanediol;
1,2-tetradecanediol;
glyceryl caprylate;
4-hydroxyacetophenone;
ethyl hexyl glycerin;
tropolone;
a mixture comprising 1,2-hexanediol and 1,2-octanediol;
a mixture comprising 1,2-hexanediol and 1,2-octanediol and tropolone; and
a mixture comprising 4-hydroxyacetophenone and 1,2-octanediol.

### Optional Further Components

Within the context of the present invention, it is also possible, and in some cases advantageous, to combine the detergents and cleaning compositions according to the present invention with other active substances and/or additives, depending on the purpose of the composition, in order to obtain a ready-for-use composition or formulation. The active ingredients provide desired properties and functionalities to the detergents and cleaning compositions according to the present invention. The term “functional ingredient” or “functional additive” includes an ingredient that provides a beneficial property in a particular use. Some particular examples of functional ingredients are discussed in more detail below. However, a broad variety of other functional ingredients may also be used.

The detergents and cleaning compositions according to the present invention may comprise any of the ingredients customarily found in such compositions, such as, for example organic solvents, builders, and additional auxiliaries such as soil repellents, thickeners, colorants and fragrances or the like.

Preferably, the detergent and cleaning composition according to the present invention can advantageously be combined or varied with at least one active substance and/or at least one (functional) additive, such as for example solvents, builders, bleaching agents, soil release agents, dispersing agents, foam inhibitors, sequestrant agents, chelating agents, anti-redeposition agents, dye transfer inhibition/colour protection agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

The detergents and cleaning compositions according to the present invention can further include one or more antimicrobial agents.

The term “antimicrobial component” in the context of the present invention refers to a group of substances, in particular to agents that kills microorganisms, such as bacteria, yeast and/or fungi, or stops or inhibits their growth, which prevents products from microbial contamination. Without the addition of such agents the products spoil, which may manifest changes in smell, discoloration, mould growth, gas formation, the separation of emulsions or changes in viscosity, rendering the product unacceptable to the consumer.

Suitable antimicrobial agents include, but are not limited to, the antimicrobial classes such as phenolics, quaternary ammonium compounds, metal derivatives, amines, alkanol amines, nitro derivatives, analides, organosulfur and sulfur-nitrogen compounds and miscellaneous compounds. Exemplary phenolic agents include pentachlorophenol, orthophenylphenol, phenoxyethanol. Exemplary quaternary antimicrobial agents include benzalkonium chloride, cetylpyridiniumchloride, amine and nitro containing antimicrobial compositions such as hexahydro-1,3,5-tris(2-hydroxyethyl)-s-triazine, dithiocarbamates such as sodium dimethyldithiocarbamate, and a variety of other materials known in the art for their antimicrobial properties. Other exemplary antimicrobial agents include glutaraldehyde, Bronopol (2-bromo-2-nitropropane-1,3-diol), silver, and isothiazolones such as methylisothiazolinone, ethyl lauroyl arginate HCl, sold under the tradename Neolone™, sodium benzoate, benzyl alcohol, or methylbenzyl alcohol.

In a preferred variant according to the present invention, the detergents and cleaning compositions are further combined with benzyl alcohol, methylbenzyl alcohol, phenoxyethanol, and any mixture thereof. Said substances have a broad-spectrum activity against microorganisms and are added to the detergent compositions to inhibit microbial spoilage, and, thus, for stabilizing purposes.

In particular, the antimicrobial agents are added to liquid detergents due to their higher water content, which makes such compositions susceptible against microbial infestation and growth.

If an antimicrobial agent is included in the inventive detergents and cleaning compositions, it is preferably in an amount between about 0.001% by weight and about 5% by weight.

Typically, the at least one degreasing agent is present in the detergent and cleaning composition, especially the degreasing detergent and cleaning composition, according to the present invention in an amount of 0.1 to 40.0% by weight, based on the total weight of the composition. In a preferred variant, the detergent and cleaning composition comprises the degreasing agent (a) in an amount of 0.25 to 30.0% by weight, more preferred in an amount of 0.5 to 20.0% by weight. Most preferred, the degreasing agent is included in the detergent and cleaning composition according to the present invention in an amount of 1.0 to 10.0% by weight, based on the total weight of the composition.

The 1,2-heptanediol (b1) or the 2,3-heptanediol (b2) or the mixture comprising 1,2-heptanediol and 2,3-heptanediol (b3) according to the first aspect of the present invention is present in the detergent and cleaning composition in an amount of 0.001 to 15.0% by weight, based on the total weight of the composition. In a preferred variant, the detergent and cleaning composition comprises the 1,2-heptanediol (b1) or the 2,3-heptanediol (b2) or the mixture comprising 1,2-heptanediol and 2,3-heptanediol (b3) in an amount of 0.01 to 10.0% by weight, based on the total weight of the composition. In a more preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.1 to 5.0% by weight, based on the total weight of the composition. In a still more preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.3 to 3.0% by weight, based on the total weight of the composition. In a most preferred variant, the 1,2-heptanediol (b1) or 2,3-heptanediol (b2) or the mixture comprising 1,2-heptanediol and 2,3-heptanediol (b3) is advantageously used in the detergent and cleaning composition in an amount of at 0.5 to 1.0% by weight, based on the total weight of the composition.

For the heptanediol mixture (b3), the above amounts relate to the total content of the 1,2-heptanediol and the 2,3-heptanediol in the mixture, i.e. the amount is the sum of the content of 1,2-heptanediol and 2,3-heptanediol in the mixture.

The at least one degreasing boosting agent (b) according to the present invention is present in the detergent and cleaning composition in an amount of 0.001 to 15.0% by weight, based on the total weight of the composition. In a preferred variant, the detergent and cleaning composition comprises the at least one degreasing boosting agent (b) in an amount of 0.01 to 10.0% by weight, based on the total weight of the composition. In a more preferred variant, the at least one degreasing boosting agent (b) is advantageously used in the detergent and cleaning composition in an amount of at 0.1 to 5.0% by weight, based on the total weight of the composition. In a still more preferred variant, the at least one degreasing boosting agent (b) is advantageously used in the detergent and cleaning composition in an amount of at 0.3 to 3.0% by weight, based on the total weight of the composition. In a most preferred variant, the at least one degreasing boosting agent (b) is advantageously used in the detergent and cleaning composition in an amount of at 0.5 to 1.0% by weight, based on the total weight of the composition.

For the alkane mixture comprising at least one first linear alkanediol and one or more second linear alkanediol, the above amounts relate to the total content of the first linear alkanediol and the second linear alkanediol(s) in the mixture, i.e. the amount is the sum of the content of the first linear alkanediol and the second linear alkanediol in the mixture.

In a particular preferred variant according to the first aspect of the present invention, the detergent and cleaning composition comprises the 2,3-heptanediol or the 2,3-heptanediol of the mixture comprising 1,2-heptanediol and 2,3-heptanediol (b3) in an amount of 0.001 to 15.0% by weight, preferred in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition.

Even more preferred, the detergent and cleaning composition comprises the 2,3-heptanediol or the 2,3-heptanediol of the mixture comprising 1,2-heptanediol and 2,3-heptanediol (b3) in an amount of 0.001 to 0.5% by weight, preferably in an amount of 0.005 to 0.1% by weight and most preferably in an amount of 0.01 to 0.075% by weight, based on the total weight of the composition or homecare product.

In a particular preferred variant according to the present invention, the detergent and cleaning composition comprises the 2,3-alkandediol as linear alkanediol or of the mixture comprising at least one first linear alkanediol and one or more second linear alkanediol in an amount of 0.001 to 15.0% by weight, preferably in an amount of 0.01 to 10.0% by weight, more preferred in an amount of 0.1 to 5.0% by weight, still more preferred in an amount of 0.3 to 3.0% by weight, and most preferred in an amount of 0.5 to 1.0% by weight, based on the total weight of the composition or homecare product.

Even more preferred, the detergent and cleaning composition comprises the 2,3-alkanediol as linear alkanediol or of the mixture comprising at least one first linear alkanediol and one or more second linear alkanediol in an amount of 0.001 to 0.5% by weight, preferably in an amount of 0.005 to 0.1% by weight and most preferably in an amount of 0.01 to 0.075% by weight, based on the total weight of the composition or homecare product.

Typically, the at least one surfactant is present in the detergent and cleaning composition according to the present invention in an amount of 0.001 to 90% by weight, based on the total weight of the composition. Preferably, the surfactant is present in an amount of 0.001 to 60% by weight, based on the total weight of the composition. More preferred, the detergent and cleaning composition according to the present invention comprises the surfactant in an amount of 0.01 to 50% by weight and most preferred in an amount of 0.1 to 40% by weight, based on the total weight of the composition.

By contrast, light-duty compositions according to the present invention comprise the at least one surfactant in an amount of 0.001 to 40% by weight, based on the total weight of the composition. Preferably, the surfactant is present in an amount of 0.005 to 30% by weight, based on the total weight of the composition. The dish cleaning and/or rinsing composition according to the present invention comprises the surfactant in an amount of 0.01 to 25% by weight and preferred in an amount of 0.1 to 20% by weight, based on the total weight of the composition.

The enzyme(s) is/are normally incorporated into the detergent and cleaning composition according to the disclosure in an amount sufficient to yield effective cleaning during a washing procedure. An amount effective for cleaning refers to an amount that produces a clean, sanitary, and, preferably, corrosion free appearance to the material cleaned, particularly for medical or dental devices or instruments. An amount effective for cleaning also can refer to an amount that produces a cleaning, stain removal, soil removal, whitening deodorizing, or freshness improving effect on substrates such as medical or dental devices or instruments and the like. Such a cleaning effect can be achieved with amounts of enzyme as low as about 0.02% by weight of the detergent and cleaning composition.

In the detergents and cleaning compositions of the present disclosure, suitable cleaning can typically be achieved when an enzyme is present at about 0.0001 to about 35% by weight; preferably about 2 to about 15% by weight; preferably about 3 to about 10% by weight; preferably about 4 to about 8% by weight; preferably about 4, about 5, about 6, about 7, or about 8% by weight. The higher enzyme levels are typically desirable in highly concentrated cleaning formulations.

The enzyme is present in the degreasing detergent and cleaning composition according to the present invention in an amount of 0.0001 to 5% by weight, based on the total weight of the composition. Preferably, the enzyme is present in an amount of 0.0001 to 4% by weight, based on the total weight of the composition. More preferred the degreasing detergent and cleaning composition according to the present invention comprises the enzyme in an amount of 0.001 to 3% by weight, based on the total weight of the composition. Most preferred the enzyme is present in the degreasing detergent and cleaning composition in an amount of 0.01 to 2% by weight, based on the total weight of the composition.

Typically, the enzyme is present in the degreasing detergent and cleaning composition according to the present invention in an amount of 0.05 to 2.0% by weight. Usually, proteases and amylase are used in higher concentrations in the detergents and cleaning compositions, namely proteases in an amount of 0.4 to 1.5% by weight, amylases in an amount of 0.05 to 0.6% by weight, based on the total weight of the composition.

For an enzyme cocktail the above amounts relate to the total content of the enzymes in the mixture, i.e. the amount is the sum of the content of all enzymes in the mixture.

The detergents and cleaning compositions of the current disclosure are found, surprisingly, to have a superior cleaning performance, compared to detergents and cleaning compositions without the addition of an inventive degreasing boosting agent.

Surprisingly, it has been found that the addition of an effective amount of 1,2-heptanediol or 2,3-heptanediol or a mixture comprising 1,2-heptanediol and 2,3-heptanediol or a specific type of degreasing boosting agents, such as alkanediols, as defined herein, glyceryl caprylate, 4-hydroxyacetophenone, ethyl hexyl glycerin or tropolone, as defined herein, to a detergent and cleaning composition comprising a degreasing agent in combination with a surfactant, has a positive impact in that they enhance the degreasing power of the detergent and cleaning composition. The detergents and cleaning compositions show a superior degreasing performance, compared to detergents and cleaning compositions without such a degreasing boosting agent.

Surprisingly, it has been found that the addition of an effective amount of 1,2-heptanediol or 2,3-heptanediol or a mixture comprising 1,2-heptanediol and 2,3-heptanediol or a specific type of degreasing boosting agent, such as alkanediols having a carbon chain from 5 to 14 carbon atoms, glyceryl caprylate, 4-hydroxyacetophenone, ethyl hexyl glycerin or tropolone, as defined herein, to a detergent and cleaning composition comprising a degreasing agent in combination with a surfactant, also improves greasy or oily stain and/or soil removal, compared to detergents and cleaning compositions without such a boosting agent.

In particular, 1,2-alkanediols having a carbon chain from 5 to 10 carbon atoms show a distinguished oily stain and/or soil removal performance. The longer the carbon chain of the 1,2-alkanediol, the better the degreasing power, as it is demonstrated in the following examples.

Without wishing to being bound by theory it is believed that alkanediols on the one hand decrease the surface tension, so that the degreasing detergent and cleaning formulation will be more effective. On the other hand, alkanediols can act as solvent/solubilizer for a better solubilization of greasy or oily dirt. Both effects result in an improved greasy or oily stain and/or soil removal.

Unexpectedly, it also has been found that the detergent and cleaning composition comprising a degreasing agent (a), degreasing boosting agent (b) and surfactant (c) is very effective against a broad range of greases or grease-type stains and/or soils such as greasy or oily stain, greasy or oily soil, mayonnaise, frying fat, beef fat, lard, dirty motor oil, lanoline, lipstick, mineral oil, and the like. In particular contaminations caused by of dirty motor oil, lipstick, frying fat, which are persistent to remove, can easily be removed when treated with the detergent and cleaning composition according to the present invention.

Surprisingly, it also has been found that the detergent and cleaning composition comprising a degreasing agent (a), degreasing boosting agent (b) and surfactant (c) is very effective against a broad range of substrates, preferably when used as laundry product for washing and cleaning fabrics or textiles. In particular, the detergent and cleaning composition according to the present invention is particularly beneficial in the degreasing of sensitive fibers such as wool, silk, and synthetic fibers such as polyester, polyacrylic, nylon, which can be treated only at low temperatures.

Thus, the detergents and cleaning compositions which contain a degreasing agent or a mixture of degreasing agents in combination with 1,2-heptanediol or 2,3-heptanediol or a mixture comprising 1,2-heptanediol and 2,3-heptanediol or a specific type of degreasing boosting agent, such as alkanediols as specified herein, glyceryl caprylate, 4-hydroxyacetophenone, ethyl hexyl glycerin, tropolone, or a mixture of said degreasing boosting agents, and a surfactant, exhibit improved overall cleaning performance over detergents and cleaning compositions without such a degreasing boosting agent.

Conversely, also because of the boosting effect, the amount of degreasing agent and other ingredients for increasing the degreasing and cleaning effectiveness in these detergents and cleaning compositions can be reduced, without loss of cleaning performance.

According to a further aspect of the present invention, the detergent and cleaning composition according to the present invention is used as such or for the preparation of a detergent and cleaning product.

The detergents and cleaning compositions or products as specified herein can be employed in a variety of cleaning methods. As used herein, the term “cleaning” refers to perform, facilitate, or aid in soil removal, bleaching, microbial population reduction, disinfection, etc. Preferably, the detergents and cleaning compositions or products are useful for textile cleaning, laundry, dishwashing, fabric care, for household, institutional and industrial hard surfaces cleaning, such as ware or other surfaces, cleaning medical and dental instruments, etc.

As used herein, the term “fabric cleaning” includes detergents and cleaning compositions or products designed for cleaning stained and/or soiled material. Such compositions include but are not limited to laundry detergent compositions, fabric softening compositions, fabric enhancing compositions, fabric freshening compositions, laundry prewash, laundry pre-treat, laundry additives, spray products, dry cleaning agents or compositions, laundry rinse additive, wash additive, post-rinse fabric treatment, ironing aids, unit dose formulations, delayed delivery formulations, detergent contained on or in a porous substrate or nonwoven sheet, substrate having fibres preferably said fibres including active agents, and other suitable forms that may be apparent to one skilled in the art.

Preferably, the detergents and cleaning compositions or products can be employed for cleaning, washing, or presoaking medical or dental devices, instruments, or equipment, including any of the various medical or dental instruments or devices that can benefit from cleaning with enzyme cleaning composition. Exemplary medical and dental instruments and devices include instruments, devices, tools, appliances, apparatus, and equipment used in medicine or dentistry including those than can be cold sterilized, soaked or washed and then heat sterilized. The medical and/or dental instruments can be soiled with blood, mammalian tissue, including but not limited to human tissue, or other foreign matter.

Suitable examples of detergents and cleaning compositions or products, in particular degreasing detergents and cleaning compositions or products, encompass degreasing cleaners, heavy-duty detergents, colour-care detergents, light-duty detergents, all-purpose washing agents, fabric softeners, fabric laundry scents, scent lotions, laundry wipes, stain removers (pre-spotter, Vanish-type), washing machine cleaner, all-purpose cleaners, hand dishwashing detergents, auto dishwashing detergents, hard surface cleaners, glass and mirror cleaners, wet cleaning wipes, kitchen cleaners, cleaners for cooking appliances, oven cleaners, floor cleaners, wood floor cleaners, carpet cleaners, bathroom and shower cleaners, toilet cleaners, grout cleaners, disinfectants, drain unblockers, toilet rim block gels, air fresheners, furniture polish, car shampoo, medical cleaning products, and the like.

In a preferred variant, the detergent and cleaning composition or product is a degreasing cleaner. The degreasing cleaner is usable either for manual or mechanized cleaning.

The afore-mentioned detergents and cleaning compositions or products refer to compositions or products in the form of a liquid, a solid, tablets, encapsulated, diluted or concentrated form and optionally in two-compartment or multi-compartment form.

As used herein, a liquid includes free-flowing liquids, as well as pastes, gels, foams and mousses. Non-limiting examples of liquids include light-duty and heavy-duty liquid detergents and cleaning compositions, fabric enhancers, detergent gels commonly used for laundry, bleach and laundry additives. Gases, e.g. suspended bubbles, or solids, e.g. particles, may be included within the liquids.

A solid as used herein, includes powders, flakes, granules, pellets, tablets, microcapsules, beads, noodles, pearlized balls, lozenges, pucks, briquettes, bricks, blocks, or another solid form known to those of skill in the art.

A solid detergent and cleaning composition or product can be provided as a pressed solid block, a cast solid block, an extruded pellet or block, or a tablet. Furthermore, a solid detergent composition or product may be provided in the form of a unit dose. A unit dose refers to a solid detergent and cleaning composition unit sized so that the entire unit is used during a single washing cycle.

A solid detergent and cleaning composition or product may also be provided in the form of a multiple use (e.g., multi-use) solid, such as, a block or a plurality of pellets, and can be repeatedly used to generate aqueous use solutions of the detergent composition for multiple cycles or a predetermined number of dispensing cycles. A multiple use solid detergent composition can be repeatedly used to generate an aqueous detergent composition, e.g., use solution, for multiple washing cycles. Pressed solid detergent blocks are made suitable to provide stability such that reactive components in the compositions do not react with each other until a point of dilution and/or use. In some aspects, the order of introducing the components to form the solid are non-limiting as there is minimal and/or no water introduced into the solid compositions. However, in some aspects, pressed solid detergent blocks are made by using a binding system to minimize any damage to the coated granules which may be employed. Beneficially, a pressing process to make the pressed solid detergent blocks generates a pressed solid detergent block and prevents the reaction or mix of the components. In an aspect of the disclosure, the solid detergent composition remains unreacted or unmixed until a point of use, e.g. dilution.

In a pressed solid process, a flowable solid, such as granular solids or other particle solids including binding agents are combined under pressure. In a pressed solid process, flowable solids of the compositions are placed into a form (e.g., a mold or container). The method can include gently pressing the flowable solid in the form to produce the solid cleaning composition.

The detergents and cleaning compositions or products can be provided in concentrated form and diluted to a use solution or provided in a use solution. Preferably, the use compositions are diluted to a concentration between about 500 ppm and about 5000 ppm, more preferably between about 750 ppm and about 4500 ppm, most preferably between about 1000 ppm and about 4000 ppm.

The detergents and cleaning compositions or products according to the present invention are used for household cleaning, medical cleaning, institutional cleaning, such as cleaning in schools, airports, hospitals, or industrial cleaning.

The detergents and cleaning compositions or products according to the present invention can be prepared by combining and mixing the various ingredients according to usual and known methods. Preferably, the enzyme is added last to prevent denaturation or inactivation of the enzyme. Mixing can be performed by any suitable automatic or manual method. For example, automatic or manual stirring can be performed. The detergent compositions can be prepared in batch or continuous process.

Based on its afore described advantageously effects, the detergent and cleaning composition or product according to the present invention, comprising a combination of a degreasing agent, a degreasing boosting agent such as alkanediols having a carbon chain of 5 to 14 carbon atoms, glyceryl caprylate, 4-hydroxyacetophenone, ethyl hexyl glycerin, tropolone, or a mixture of said degreasing boosting agents, and a surfactant is particularly beneficial in washing and cleaning processes for efficiently removing greasy or oily stain and/or soil from substrates.

Thus, the present invention relates in a further aspect to a method of treating a stained and/or soiled substrate, comprising the steps of
treating the substrate with the detergent and cleaning composition or product according to the present invention; and
rinsing said substrate in water to remove said composition or product.

Preferably, the method of treating a stained and/or soiled substrate takes place in a washing containing a wash liquor comprising water and the detergent and cleaning composition according to the present invention. The wash liquor may be applied to the substrate or the substrate may be immersed into the wash liquor.

The method may alternatively comprise direct application of the detergent and cleaning composition, i.e. undissolved without water on to part or whole of the substrate, so as to directly treat a stain and/or soil on the substrate. Such a process is preferably a pre-treatment and may be followed by treatment with or within a wash liquor.

The method according to the present invention is applied at both higher temperatures and well as lower temperatures. Ware wash applications, for example, clean substrates at temperatures in excess of approximately 60° C., or in excess of approximately 70° C., or between approximately 65° C. to 80° C. Laundry applications, for example, clean laundry at temperatures in excess of approximately 40° C., or in excess of approximately 50° C., or between approximately 65° C. to 90° C.

Preferably, the method is applied at low temperatures where removal of stain and/or soil is more problematic. Preferably, the treatment temperature is less than 50° C. and preferably less than 40° C. and more preferably less than 30° C.

Surprisingly it turned out, that the detergent and cleaning composition or product according to the present invention is particularly efficient in the removal of greasy or oily stain and/or soil at said low temperatures.

Thus, the method allows for degreasing and removal of greasy or oily stain and/or soil in a low temperature range.

This is particularly advantageous in the treatment of sensitive substrates such as wool, silk, and synthetic fibers such as polyester, polyacrylic, nylon, which can be washed or cleaned only at low temperatures.

Preferably, the substrate is cotton.

More preferably, the substrate is wool or silk.

Still more preferred, the substrates are blended fabrics such as cotton and polyester, or synthetic fibers, such as polyester, polyacrylic, or nylon.

Surprisingly it was found that contaminations caused by dirty motor oil, lipstick, frying fat, which are persistent to remove, can easily be removed when treated with the degreasing detergent and cleaning composition according to the present invention.

The use of the degreasing detergent and cleaning composition or product according to the present invention in the method according to the present invention provides for improved removal of greasy or oily stain and/or soil, and, hence, results in an improved overall cleaning performance.

Based on the advantageously degreasing boosting and improved greasy or oily stain and/or soil removal effects, as described above for the degreasing boosting agents, the present invention relates in a further aspect to the use of 1,2-heptanediol or 2,3-heptanediol or a mixture comprising 1,2-heptanediol and 2,3-heptanediol or at least one degreasing boosting agent selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined herein;
(b^{II}) glyceryl caprylate;
(b^{III}) 4-hydroxyacetophenone;
(b^{IV}) ethyl hexyl glycerin;
(b^{V}) tropolone; and
any mixture thereof;
for boosting the degreasing power of a degreasing detergent and cleaning composition and/or for improving the cleaning performance of a degreasing detergent and cleaning composition comprising a degreasing agent and a surfactant.

With respect to the degreasing agents and preferred variants thereof, reference is made to the previous description of the degreasing agents in connection with the detergents and cleaning compositions according to the present invention, which is equally valid in connection with the use of 1,2-heptanediol or 2,3-heptanediol or a mixture comprising 1,2-heptanediol and 2,3-heptanediol or at least one degreasing boosting agent (b) for boosting the degreasing power of a degreasing detergent and cleaning composition and for improving the cleaning performance of a degreasing detergent and cleaning composition, in order to avoid repetition.

It was surprisingly found that the use of 1,2-heptanediol or 2,3-heptanediol or a mixture comprising 1,2-heptanediol and 2,3-heptanediol or at least one degreasing boosting agent as specified herein improves the degreasing power of a degreasing detergent and cleaning composition and improves greasy or oily stain and/or soil removal in a degreasing detergent and cleaning composition, resulting in an improved overall cleaning performance, compared to a detergent and cleaning composition without said degreasing boosting substances. This superior effect is based on the combination of the degreasing agent, degreasing boosting agent and surfactant.

Hence, the use of the degreasing boosting agents according to the present invention is beneficial for boosting the degreasing power of a degreasing detergent and cleaning composition and/or for improving the cleaning performance of a degreasing detergent and cleaning composition in terms of greasy or oily stain and/or soil removal. The improvement also allows for the reduction of degreasing agents, such as solvents and/or solubilizers, in a degreasing detergent and cleaning composition.

Based on the advantageously degreasing boosting effects, as described above for the degreasing boosting agents, the present invention finally relates to a method of boosting the degreasing power of a degreasing detergent and cleaning composition and/or of improving the cleaning performance of a degreasing detergent and cleaning composition, comprising the steps of
(i) providing a detergent and cleaning composition comprising a degreasing agent and a surfactant; and
(ii) adding thereto an effective amount of 1,2-heptanediol or 2,3-heptanediol or a mixture comprising 1,2-heptanediol and 2,3-heptanediol or at least one degreasing boosting agent selected from the group consisting of
   (b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined herein;
   (b^{II}) glyceryl caprylate;
   (b^{III}) 4-hydroxyacetophenone;
   (b^{IV}) ethyl hexyl glycerin;
   (b^{V}) tropolone; and
   any mixture thereof.

With respect to the degreasing agents and preferred variants thereof, reference is made to the previous description of the degreasing agents in connection with the detergents and cleaning compositions according to the present invention, which is equally valid in connection with the method of boosting the degreasing power of a degreasing detergent and cleaning composition and of improving the cleaning performance of a degreasing detergent and cleaning composition, in order to avoid repetition.

Surprisingly, it has been found that the addition of an effective amount of 1,2-heptanediol or 2,3-heptanediol or a mixture comprising 1,2-heptanediol and 2,3-heptanediol or a specific type of degreasing boosting agent, such as alkanediols having a carbon chain of 5 to 14 carbon atoms as defined herein, glyceryl caprylate, 4-hydroxyacetophenone, ethyl hexyl glycerin, tropolone, or a mixture of said degreasing boosting agents, to a degreasing detergent and cleaning composition, comprising a degreasing agent and a surfactant, results in an boosting of the degreasing power of a degreasing detergent and cleaning composition and an improved greasy or oily stain and/or soil removal, thus leading to an improved cleaning performance of the detergent and cleaning composition, compared to a detergent and cleaning composition without said degreasing boosting agents.

Hence, the addition of the degreasing boosting agents according to the present invention to a degreasing detergent and cleaning composition, comprising a degreasing agent, is beneficial in a method of boosting the degreasing power of a degreasing detergent and cleaning composition and/or of improving the cleaning performance of a degreasing detergent and cleaning composition in terms of greasy or oily stain and/or soil removal. The improvement also allows for the reduction of degreasing agents, such as solvents and/or solubilizers, in a degreasing detergent and cleaning composition.

Additionally, based on the afore described advantageous effects, 1,2-heptanediol or 2,3-heptanediol or a mixture comprising 1,2-heptanediol and 2,3-heptanediol or at least one degreasing boosting agent as defined herein are suitable to act as degreaser/degreasing agent. Based on the afore described advantageous effects, 1,2-heptanediol or 2,3-heptanediol or a mixture comprising 1,2-heptanediol and 2,3-heptanediol or at least one degreasing boosting agent as defined herein are suitable to replace solvents and/or solubilizers in a degreasing detergent or cleaning product.

Thus, the present invention relates in a further aspect to the use of 1,2-heptanediol or 2,3-heptanediol or a mixture comprising 1,2-heptanediol and 2,3-heptanediol or at least one degreasing boosting agent selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol, as defined in any one of claims 2 and 4 to 10;
(b^{II}) glyceryl caprylate;
(b^{III}) 4-hydroxyacetophenone;
(b^{IV}) ethyl hexyl glycerin;
(b^{V}) tropolone; and
any mixture thereof, as degreaser/degreasing agent and/or as replacement for a solvent and/or solubilizer.

The present invention shall now be described in detail with reference to the following examples, which are merely illustrative of the present invention, such that the content of the present invention is not limited by or to the following examples.

### EXAMPLES

### Example 1: Cleaning Performance

The following tests are performed to show the influence of different degreasing boosting agents according to the present invention on the degreasing power and cleaning performance of different degreasing cleaners, comprising a degreasing agent and a surfactant.

In parallel, comparative tests under the same conditions are carried out for the degreasing cleaners with the same degreasing agent and a surfactant but without the degreasing boosting agent.

### Example 1.1: Test Method According to the IKW Recommendation for the Quality Assessment of the Product Performance of Degreasing Power Cleaners (2017)

The cleaning performance of the tested degreasing cleaners according to the present invention and the comparative degreasing cleaners is carried out according to the IKW Recommendation for the Quality Assessment of the Product Performance of Degreasing Power Cleaners (2017).

The test method covers the evaluation of the cleaning performance of hard surface cleaners on tough polymerized grease baked on stainless steel plates. The grease test method is to mimic the removal of cooked or baked-on grease. When cooking at home, hot and partly polymerised oils and fats are ejected onto kitchen surfaces, particularly on the cooker top. During the action of cooking, the cooker surface becomes hot. This additional heating makes the greasy or soil harder due to increased levels of polymerisation to eventually form a tough greasy or oily soil. A common cleaning habit is to clean this type of pure grease, when found on hard surfaces, upon direct application (i.e. scrubbing).

A greasy or oily soil is laid down onto stainless steel tile and then baked and aged prior to be used for the cleaning assessment. A scrubbing device is used to mimic the scrubbing process as done by the consumer in-home when using the product on tough soil. The number of strokes reached to fully clean up the grease baked soil highlights the performance of the cleaner. Statistical analysis (e.g. Tukey's test) is performed with 95% confidence level to determine the significant differences among the detergents.

### Example 1.2: Test Method According to the Recommendation for the Quality Assessment of the Product Performance of All-Purpose Cleaners

The cleaning performance of the tested degreasing cleaners according to the present invention and the comparative degreasing cleaners is carried out according to the Recommendation for the Quality Assessment of the Product Performance of All-Purpose Cleaners (published in SÖFW-Journal 130, 10-2004, pages 83 to 93).

The product performance is determined by way of measuring the cleaning performance.

### Example 1.3: Test Method According to the IKW Recommendations for the Quality Assessment of the Cleaning Performance of Dishwasher Detergents

The cleaning performance for the machine dishwashing detergent is analysed according to the IKW Recommendations for the Quality Assessment of the Cleaning Performance of Dishwasher Detergents (Part B, Update 2015).

The cleaning performance test consists of assessing the stain removal efficiency of the tested dishwasher detergents on 14 stains.
Test conditions: Washing machine, Miele dishwasher GSL or Miele GSL 2
Water hardness: for classic products: 1.8 mmol/l
   for multifunctional products: 3.5 mmol/l
Water temperature: in main wash cycle: 45° C.
Wash cycle: at least 3 cycles
Dosage: recommended dosage for normal soil/medium hardness
Stain sets: Black tea (bleachable),
   milk, milk skin (persistent/alkaline-sensitive),
   starch mix, pasta (starch-containing, amylase sensitive),
   egg yolk, crème brulee, minced meat (protein-containing, protease sensitive)
Number of soiled items: 6 of each type

The measurements/evaluation are taken on each stain as described in the IKW Recommendation either by visual evaluation with reference to a photographic catalogue or gravimetric.

The obtained results are statistically treated using Tukey's HSD test (HSD=honestly significant difference) with 95% confidence level. The HSD value highlights the significant differences between each pair of products.

As can be seen from the test results, the degreasing detergents and cleaning compositions according to the present invention show a superior cleaning performance in terms of stain removal and/or soil removal, compared to a cleaning performance without an inventive degreasing boosting agent. This means conversely, that the degreasing activity in the degreasing detergent and cleaning composition is improved by the addition of the inventive degreasing boosting agent, whereas in the detergent and cleaning composition without the addition of a degreasing boosting agent the degreasing effect, and, thus, the cleaning performance, is lower.

### Example 1.4: Cleaning Performance of a Degreasing Cleaner According to the Present Invention

The degreasing power of different degreasing cleaners according to the present invention was tested on ready to use CFT DM40 tiles (standard soil substrates), soiled with a mixture of oil and carbon black.

The degreasing cleaner is a standard degreasing cleaner, comprising fatty alcohol ethoxylated (C9 to C11 6 EO) and ethanol, to which 1% of a degreasing boosting agent was added.

The degreasing boosting agents are 1,2-pentanediol, 1,2-hexanediol, 1,2-heptanediol and 1,2-octanediol.

For comparison, the standard degreasing cleaner was used without the addition of a degreasing boosting agent.

The cleaning process was simulated in an Abrasimeter, with 70 scrubs and a load of 160 g.

The cleaning performance of the tested degreasing cleaners according to the present invention and the comparative degreasing cleaner is carried out as described in Example 1.2.

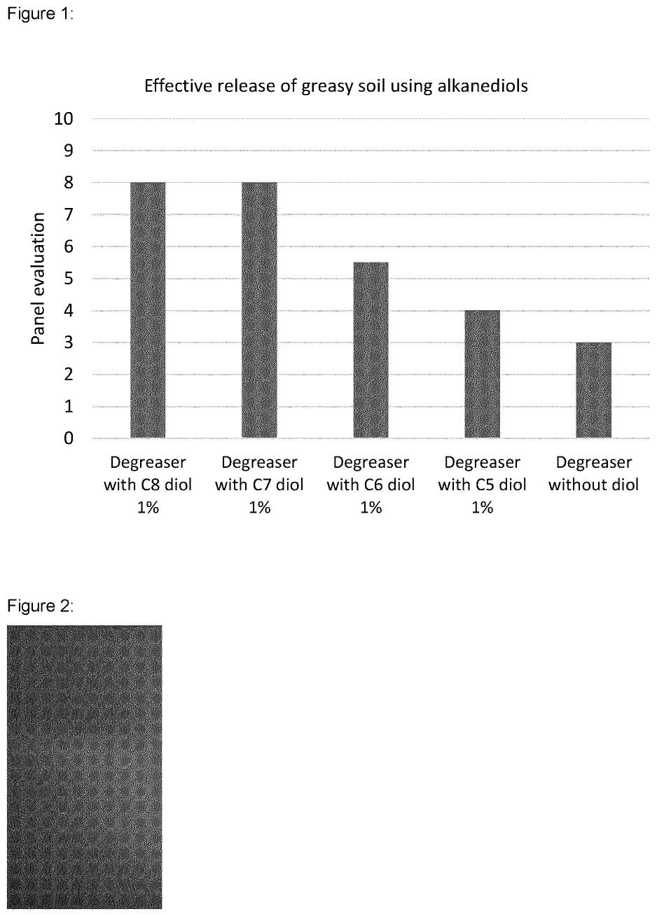

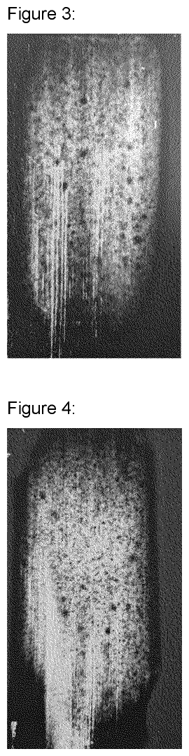

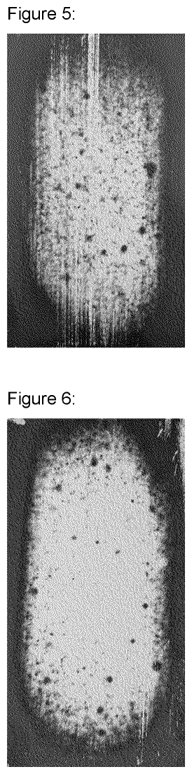

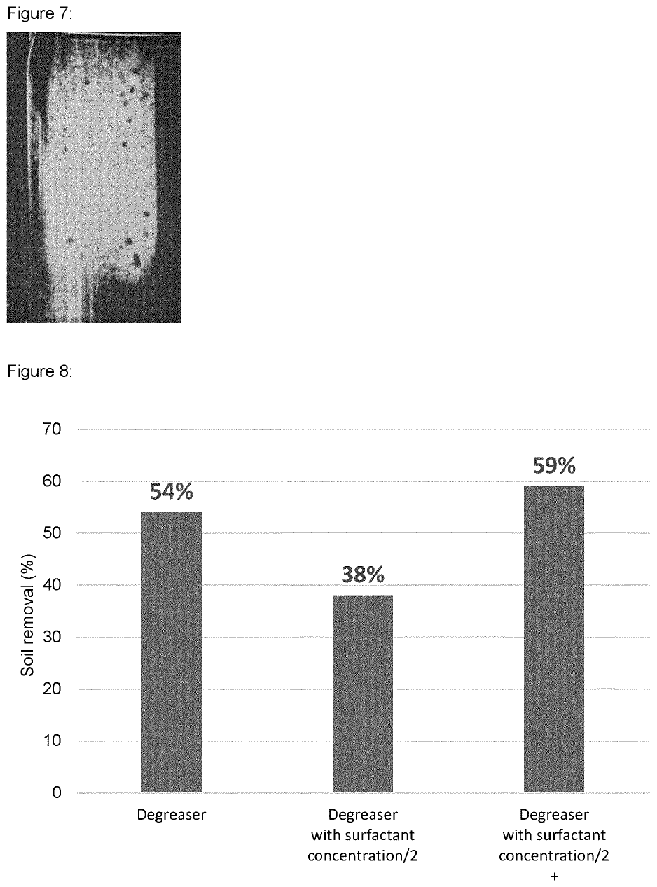

As can be seen from the results of a panel evaluation in FIG. 1, showing the effective release of greasy soil, 1,2-pentanediol enhances the degreasing power of the degreasing cleaner. 1,2-hexanediol has a better degreasing power boosting effect in comparison to 1,2-pentanediol. 1,2-heptanediol and 1,2-octancediol show the best release of greasy soil. Hence, 1,2-heptanediol and 1,2-octanediol are particularly beneficial degreasing boosting agents. In FIG. 1 the number 0=no removal; and the number 10=totally cleaned. Thus, the longer the 1,2-alkanediol chain the better the degreasing boosting effect.

The cleaning performance of the different degreasing cleaners is also shown by photographs of the cleaned tiles: As can be seen from the photographs, the degreaser with 1,2-octanediol and 1,2-heptanediol show the best cleaning performance with almost no residues of the soil remaining on the tile. 1,2-pentanediol also shows an improvement in the cleaning performance in comparison to the comparative sample, which does not include a degreasing boosting agent. The degreasing cleaner with the degreasing boosting agent 1,2-hexanediol performs better than the degreasing cleaner with the degreasing boosting agent 1,2-pentanediol.

### Example 1.5: Cleaning Performance of a Degreasing Cleaner According to the Present Invention

The degreasing power of a degreasing cleaner according to the present invention was further tested on steel plates soiled with a mixture of grease, protein, and starch (standard soil substrates).

The tested degreasing formulation had the following composition:

| Ingredient | % (active content) |
|---|---|
| Water | q.s 100 |
| C8 C10 APG (Capryl caprylyl Glucoside) | 0.3 |
| C8C10 5OE (fatty alcohol 5 ethoxylated) | 1.5 |
| Ethanol | 1.5 |
| Sodium citrate/citric acid | q.s pH = 7.5 to 8.0 |
| (complexing agent/builder/pH buffer) | |
| CIT (chlormethylisothiazolinon)/MIT | 0.00135 |
| (methylisothiazolinone) (preservatives) | |

To the degreaser formulation with surfactant concentration of 50%, 1,2-octanediol was added in a concentration of 0.5%.

For comparison, the test was carried out with a total of 1.8% surfactant in the degreaser formulation with a surfactant concentration of 100% and 0.9% surfactant in the degreaser formulation with a surfactant concentration of 50% (0.15% C8 C10 APG (capryl caprylyl glucoside) and 0.75% C8C10 5OE (fatty alcohol 5 ethoxylated) without addition of a degreasing boosting agent.

The cleaning performance of the tested degreasing cleaners was gravimetric determined by weighing the amount of soil on the steel plate before and after cleaning.

As can be seen from the results in FIG. 8, showing the cleaning performance of the tested degreasing formulations, the degreasing formulation with 1,2-octanediol leads to a soil removal of 59%, even at a surfactant concentration of only 50%. By contrast, the degreasing cleaner with a surfactant concentration of 50% without the addition of 1,2-octanediol result in a soil removal of only 38%. Thus, the cleaning performance is improved by more than 20%. By contrast, the degreasing formulation with a surfactant concentration of 100% result in a soil removal of 54%. Compared to the degreasing formulation with a surfactant concentration of 100%, the cleaning performance of the degreasing formulation in combination with the degreasing boosting agent 1,2-octanediol performs better, although its surfactant content is only 50%.

These results also demonstrates that with the addition of a degreasing boosting agent according to the present invention, the surfactant content in a degreasing cleaner or degreasing formulation can be considerably reduced without considerable deterioration of the cleaning performance. In particular, the results also show that alkanediols, with their co-surfactant property, are beneficial to substitute surfactants.

### Example 2: Formulation Examples

TABLE F1
Degreasing formulation (hard surface cleaning)

| No | Ingredients | Amount (%) |
|---|---|---|
| 1 | Fatty alcohol ethoxylated (C9-C11 6EO) | 2 |
| 2 | Sodium citrate | 1 |
| 3 | Sodium carbonate | 0.4 |
| 4 | Methylisothiazolinone | 0.01 |
| 5 | Fragrance | 0.3 |
| 6 | 1,2-heptanediol | 1 |
| 7 | Ethanol | 2 |
| 8 | Aqua | add to 100 |

TABLE F2
Degreasing formulation (hard surface cleaning)

| No | Ingredients | Amount (%) |
|---|---|---|
| 1 | Fatty alcohol ethoxylated (C9-C11 6EO) | 2 |
| 2 | Sodium citrate | 1 |
| 3 | Sodium carbonate | 0.4 |
| 4 | Methylisothiazolinone | 0.01 |
| 5 | Fragrance | 0.3 |
| 6 | 2,3-octanediol | 0.1 |
| 7 | 1,2-heptanediol | 0.9 |
| 8 | Ethanol | 2 |
| 9 | Aqua | add to 100 |

TABLE F3
Degreasing formulation (hard surface cleaning)

| No | Ingredients | Amount (%) |
|---|---|---|
| 1 | Fatty alcohol ethoxylated (C9-C11 6EO) | 2 |
| 2 | Sodium citrate | 1 |
| 3 | Sodium carbonate | 0.4 |
| 4 | Methylisothiazolinone | 0.01 |
| 5 | Fragrance | 0.3 |
| 6 | 1,2-hexanediol | 0.5 |
| 7 | 1,2-octanediol | 0.5 |
| 8 | Ethanol | 2 |
| 9 | Aqua | add to 100 |

TABLE F4
Degreasing formulation (highly alkaline) (Hard surface cleaning)

| No | Ingredients | Amount (%) |
|---|---|---|
| 1 | Fatty alcohol ethoxylated (C9-C11 6EO) | 3 |
| 2 | Methoxypropanol | 2 |
| 3 | Polycarboxylate | 1 |
| 4 | Monoethanolamine | 0.4 |
| 5 | 2,3-octanediol | 0.1 |
| 6 | 1,2-heptanediol | 0.9 |
| 7 | Aqua | add to 100 |

TABLE F5
Cleaner, liquid, citric acid

| No | Ingredient | Amount (%) |
|---|---|---|
| 1 | Sulfonic acid, C 13-17-sec-Alkyl-, Sodium salt | 1 |
| 2 | Citric Acid | 5 |
| 3 | Xanthan Gum | 0.5 |
| 4 | 1,2-heptanediol/2,3-heptanediol 90:10 | 0.5 |
| 5 | Fragrance | 0.3 |
| 6 | Protease (Subtilisin) | 0.3 |
| 7 | Ethanol | 1.5 |
| 8 | Aqua | add 100 |

TABLE F6
Dishwash liquid manual

| No | Ingredients | Amount (%) |
|---|---|---|
| 1 | Sodium Laureth Sulfate | add 100 |
| 2 | Ethanol | 2.9 |
| 3 | lauramine oxide | 7.7 |
| 4 | propylene glycol | 1.9 |
| 5 | Phenoxyethanol | 0.1 |
| 6 | Benzisothiazolinone, Methylisothiazolinone, | 0.1 |
| | Laurylamine Dipropylenediamine | |
| 7 | 1,2-heptanediol | 0.5 |
| 8 | sodium chloride | 3.85 |
| 9 | Fragrance | 0.3 |
| 10 | Amylase | 0.4 |

TABLE F7
ADW (Auto Dish Washing) gel

| No. | Raw material | Amount (%) |
|---|---|---|
| 1 | Water | add 100 |
| 2 | Glutamic acid, N,N-diacetic acid, tetrasodium salt | 17 |
| 3 | Glycerin | 15 |
| 4 | Citric acid | 3 |
| 5 | Acrylic copolymer | 2 |
| 6 | Fatty alcohol alkoxylated | 1 |
| 7 | Sodium cumene sulfonate | 1 |
| 8 | Xanthan Gum | 0.5 |
| 9 | 1,2-heptanediol | 1.2 |
| 10 | Protease (Subtilisin) | 1.5 |
| 11 | Amylase | 0.5 |

1. A detergent and cleaning composition, comprising
(a) at least one degreasing agent, selected from the group consisting of solvents and solubilizers;
(b) at least one degreasing boosting agent selected from the group consisting of:
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof;
(c) at least one surfactant; and
(d) optionally at least one enzyme or an enzyme formulation comprising at least one enzyme;
wherein the at least one degreasing agent is a solvent selected from the group consisting of n-propanol or iso-propanol, butanol, glycol, propanediol or butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol methyl ether or dipropylene glycol ethyl ether, methoxytriglycol, ethoxytriglycol, butoxytriglycol, 1-butoxyethoxy-2-propanol, 3-methyl-3-methoxybutanol, propylene-glycol-t-butylether, and any mixture thereof; and/or
wherein the at least one degreasing agent is a solubilizer selected from the group consisting of non-ionic surfactants with a HLB value of 13 to 20, selected from the group consisting of polyethylene glycol 400 monolaurate, polyoxyethylene sorbitan monooleate, polyoxyethylene sorbitan monolaurate, polyoxyethylene lauryl ether, potassium oleate, sodium lauryl sulfate, and any mixture thereof.

2. The detergent and cleaning composition according to claim 1, wherein the at least one linear alkanediol or the first linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof; and/or
the second linear alkanediol is selected from the group consisting of 1,2-pentanediol, 2,3-pentanediol, 1,2-hexanediol, 2,3-hexanediol, 1,2-heptanediol, 2,3-heptanediol, 1,2-octanediol, 2,3-octanediol, 1,2-nonanediol, 2,3-nonanediol, 1,2-decanediol, 2,3-decanediol, 1,2-undecanediol, 2,3-undecanediol, 1,2-dodecanediol, 2,3-dodecanediol, 1,2-tridecanediol, 2,3-tridecanediol, 1,2-tetradecanediol, 2,3-tetradecanediol, and any mixture thereof.

3. The detergent and cleaning composition according to claim 1, wherein the at least one linear alkanediol is selected from the group consisting of 1,2-pentanediol, 1,2-hexanediol, 1,2-heptanediol, 1,2-octanediol, 1,2-nonanediol, 1,2-decanediol, 1,2-undecanediol, 1,2-dodecanediol, 1,2-tridecanediol, 1,2-tetradecanediol, and any mixture thereof;
or
wherein the linear alkanediol is selected from the group consisting of 2,3-pentanediol, 2,3-hexanediol, 2,3-heptanediol, 2,3-octanediol, 2,3-nonanediol, 2,3-decanediol, 2,3-undecanediol, 2,3-dodecanediol, 2,3-tridecanediol, 2,3-tetradecanediol and any mixture thereof;
or
wherein the mixture comprising at least one first linear alkanediol and one or more second linear alkanediol is selected from the group consisting of
a mixture comprising 1,2-pentanediol and 2,3-pentanediol;
a mixture comprising 1,2-hexanediol and 2,3-hexanediol;
a mixture comprising 1,2-heptanediol and 2,3-heptanediol;
a mixture comprising 1,2-octanediol and 2,3-octanediol;
a mixture comprising 1,2-nonanediol and 2,3-nonanediol;
a mixture comprising 1,2-decanediol and 2,3-decanediol;
a mixture comprising 1,2-undecanediol and 2,3-undecanediol;
a mixture comprising 1,2-dodecanediol and 2,3-dodecanediol;
a mixture comprising 1,2-tridecanediol and 2,3-tridecanediol;
a mixture comprising 1,2-tetradecanediol and 2,3-tetradecanediol;
a mixture comprising 1,2-hexanediol and 1,2-octanediol;
a mixture comprising 1,2-hexanediol and 2,3-octanediol;
a mixture comprising 1,2-octanediol and 2,3-hexanediol;
a mixture comprising 1,2-octanediol and 2,3-heptanediol;
a mixture comprising 1,2-pentanediol and 2,3-hexanediol;
a mixture comprising 1,2-pentanediol and 2,3-heptanediol;
a mixture comprising 1,2-pentanediol and 2,3-octanediol;
a mixture comprising 1,2-pentanediol and 1,2-nonanediol;
a mixture comprising 1,2-pentanediol and 2,3-nonanediol;
a mixture comprising 1,2-heptanediol and 1,2-pentanediol;
a mixture comprising 1,2-heptanediol and 1,2-hexanediol;
a mixture comprising 1,2-heptanediol and 1,2-octanediol;
a mixture comprising 1,2-heptanediol and 2,3-octanediol;
a mixture comprising 1,2-heptanediol and 1,2-nonanediol;
a mixture comprising 1,2-heptanediol and 2,3-nonanediol;
a mixture comprising 1,2-heptanediol and 1,2-decanediol;
a mixture comprising 1,2-heptanediol and 1,2-undecanediol;
a mixture comprising 1,2-heptanediol and 1,2-dodecanediol; and
a mixture comprising 1,2-heptanediol and 1,2-tridecanediol.

4. The detergent and cleaning composition according to claim 1, wherein the mixture comprising at least one first linear alkanediol and one or more second linear alkanediol comprises the first linear alkanediol and the second alkanediol in in a ratio in a range of 50:50 to 99.9:0.1.

5. The detergent and cleaning composition according to claim 1, wherein the at least one surfactant is selected from the group consisting of anionic surfactants, cationic surfactants, non-ionic surfactants, amphoteric/zwitterionic surfactants, and any mixture thereof.

6. The detergent and cleaning composition according to claim 1, wherein the enzyme is selected from the group consisting of proteases, amylases, lipases, cellulases, cutinases, gluconases, peroxidases, pectinases, mannanases, esterases, hemicellulases, xylanases, phospholipases, pectate lyases, keratinases, reductases, nucleases, phenoloxidases, lipoxygenases, ligninases, pullulanases, tannases, pentosanases, malanases, β-glucanases, arabinosidases, hyaluronidases, chondroitinases, oxidoreductases, and any mixture thereof.

7. The detergent and cleaning composition according to claim 1, further comprising active substances and/or additives selected from the group consisting of solvents, builders, bleaching agents, soil release agents, dispersing agents, foam inhibitors, sequestrant agents, chelating agents, anti-redeposition agents, dye transfer inhibition/colour protection agents, dye scavengers, dyes, greying inhibitors, optical brighteners, ultraviolet light absorbers, thickeners or rheology modifiers, hydrotropes, solubility modifiers, pH-adjusting agents, buffers, solvents, anti-static agents, anti-wrinkling agents, antimicrobial agents, odor removal/odor capturing agents, ultraviolet light protection agents, fragrances, sanitizing agents, disinfecting agents, water repellency agents, insect repellency agents, anti-pilling agents, souring agents, mildew removing agents, allergicide agents, and any mixture thereof.

8. The detergent and cleaning composition according to claim 7, wherein the antimicrobial agent is selected from the group consisting of benzyl alcohol, methylbenzyl alcohol, phenoxyethanol, and any mixture thereof.

9. The detergent and cleaning composition according to claim 1, comprising the degreasing agent in an amount of 0.1 to 40.0% by weight, based on the total weight of the composition.

10. The detergent and cleaning composition according to claim 1, comprising the at least one degreasing boosting agent (b) in an amount of 0.001 to 15.0% by weight, based on the total weight of the composition; and/or
comprising the at least one surfactant in an amount of 0.001 to 90% by weight, based on the total weight of the composition; and/or
comprising the enzyme in an amount of 0.0001 to 5% by weight, based on the total weight of the composition.

11. A method of preparing a detergent and cleaning product comprising formulating the product with the detergent and cleaning composition of claim 1.

12. A detergent and cleaning product comprising the detergent and cleaning composition according to claim 1, wherein the detergent and cleaning composition or product is a degreasing cleaner, heavy-duty detergent, colour-care detergent, light duty detergent, all-purpose washing agent, fabric softener, fabric laundry scent, scent lotion, laundry wipe, stain remover (pre-spotter, Vanish type), washing machine cleaner, homecare products, all-purpose cleaner, hand dishwashing detergent, auto dishwashing detergent, hard surface cleaner, glass and mirror cleaner, wet cleaning wipe, kitchen cleaner, cleaner for cooking appliances, oven cleaner, floor cleaner, wood floor cleaner, carpet cleaner, bathroom and shower cleaner, toilet cleaner, grout cleaner, disinfectant, drain unblocker, toilet rim block gel, air fresheners, furniture polish, car shampoo; medical cleaning products,
wherein product is in liquid, solid, gelled, bar, paste, spray, tablet, encapsulated, diluted or concentrated form and optionally in two-compartment or multi-compartment form;
and wherein the product is for household, medical, institutional, or industrial applications.

13. A method of treating a stained and/or soiled substrate, comprising the steps of
treating the substrate with the detergent and cleaning composition according to claim 1; and
rinsing said substrate in water to remove said composition or product.

14. (canceled)

15. A method of boosting the degreasing power of a degreasing detergent and cleaning composition and/or of improving the cleaning performance of a degreasing detergent and cleaning composition, comprising the steps of
(i) providing a detergent and cleaning composition comprising a degreasing agent and a surfactant; and
(ii) adding thereto an effective amount of at least one degreasing boosting agent selected from the group consisting of
(b^{I}) at least one linear alkanediol having a carbon chain of 5 to 14 carbon atoms or a mixture comprising at least one first linear alkanediol having a carbon chain of 5 to 14 carbon atoms and one or more second linear alkanediol having a carbon chain of 5 to 14 carbon atoms which is different from the first linear alkanediol;
(b^{II}) glyceryl caprylate;
(b^{III}) 4-hydroxyacetophenone;
(b^{IV}) ethyl hexyl glycerin;
(b^{V}) tropolone; and
any mixture thereof.

16. (canceled)

17. The detergent and cleaning composition according to claim 4, wherein the mixture comprising at least one first linear alkanediol and one or more second linear alkanediol comprises the first linear alkanediol and the second alkanediol in a ratio in a range of 90:10 to 95:5.

18. The detergent and cleaning composition according to claim 5, wherein
the anionic surfactant is selected from the group consisting of
C10 to C18 alkyl benzene sulfonates;
C10 to C18 alkyl sulfates;
C10 to C18 alkyl sulfates, ethoxylated with 1 to 3 moles ethylene oxide;
C10 to C18 alpha-olefin sulfonates;
C8 to C18 alkyl carboxylates, ethoxylated with 1 to 10 moles ethylene oxide;
and any mixture thereof;
the cationic surfactant is selected from the group consisting of
quaternary C8 to C18 alkyl ethanolamines;
quaternary C8 to C18 alkyl ammonium compounds;
C8 to C18 alkyl ammonium methosulfates;
and any mixture thereof;
the non-ionic surfactant is selected from the group consisting of
C6 to C18 fatty alcohols, ethoxylated with 1 to 12 moles ethylene oxide;
alkoxylated C6 to C18 fatty alcohols such as
C6 to C18 fatty alcohols, ethoxylated with 1 to 25 moles ethylene oxide,
C6 to C18 fatty alcohols, propoxylated with 1 to 15 moles propylene oxide,
C6 to C18 fatty alcohols, butoxylated with 1 to 10 moles butylene oxide,
and combinations thereof;
C6 to C18 sophorolipids;
C6 to C18 rhamnolipids;
C5 to C18 alkyl polyglycosides;
C6 to C18 alkanolamides;
C6 to C18 fatty acid ester alkoxylates;
and any mixture thereof; and
the amphoteric/zwitterionic surfactant is selected from the group consisting of
C10 to C18 N-(alkyl)-N,N-dimethylamine oxide;
C10 to C18 N-(alkyl)-N,N-bis(2-hydroxyethyl)amine oxide;
C10 to C18 alkyl amido propyl dimethyl amine oxide;
C10 to C18 alkylbetaines;
C10 to C18 alkylamidobetaines;
C10 to C18 sulfobetaines;
and any mixture thereof;
and any mixture of the above specified cationic, anionic, non-ionic and amphoteric/zwitterionic surfactants.

19. The detergent and cleaning composition of claim 6 wherein the nucleases are DNases and/or RNases.

20. The detergent and cleaning composition according to claim 9, comprising the degreasing agent in an amount of 1.0 to 10.0% by weight, based on the total weight of the composition.

21. The detergent and cleaning composition according to claim 10, comprising the at least one degreasing boosting agent (b) in an amount of 0.5 to 1.0% by weight, based on the total weight of the composition; and/or
comprising the at least one surfactant in an amount of 0.1 to 40% by weight, based on the total weight of the composition; and/or
comprising the enzyme in an amount of 0.05 to 2% by weight, based on the total weight of the composition.
